(19) United States
(12) Patent Application Publication
(10) Pub. No.: US 2010/0217711 A1
(43) Pub. Date: Aug. 26, 2010

(54) SYSTEM AND METHOD FOR FACILITATING A PRIVATE COMMODITY RESOURCE TRANSACTION

(75) Inventors: Jon B. Olson, Barrington Hills, IL (US); Greg Radcliff, Downers Grove, IL (US); Michael Mackey, Westport, CT (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: Trumarx Data Partners, Inc., Chicago, IL (US)

(21) Appl. No.: 12/705,948

(22) Filed: Feb. 15, 2010

Related U.S. Application Data
(60) Provisional application No. 61/152,720, filed on Feb. 15, 2009.

(51) Int. Cl. G06Q 40/00; G06Q 10/00; G06F 21/00

(52) U.S. Cl. 705/80; 705/37; 705/30; 726/4

(57) ABSTRACT

The disclosure presents a system, method, and computer readable medium for facilitating a private commodity resource transaction, having logic for establishing a market for the private commodity resource transaction, communicating a plurality of market establishment prompts to the remote computer, establishing a market for the private commodity resource transaction, receiving market establishment offer information comprising a selected subset of potential respondents, offering to the selected subset of potential respondents the private commodity resource transaction, determining which potential respondents of the predetermined set of potential respondents to communicate the market establishment offer information to, privately communicating the market establishment offer information to the potential respondents, receiving an acceptance response from at least one the potential respondents, identifying which of the potential respondents is associated with a first complete acceptance, privately communicating to the identified respondent a execution communication, and closing the market.

### RELATED APPLICATION

This Application claims priority from U.S. Provisional Patent Application Ser. No. 61/152,720, filed Feb. 15, 2009, which is hereby incorporated by reference herein in its entirety.

### TECHNICAL FIELD

This invention relates generally to a system and method for facilitating a private commodity resource transaction. More particularly, the present invention relates to a system and method for allowing a market participant within a commodity resource to establish a private market for a finite set of commodity market participants for responding to the market for the commodity resource based on originator determined parameters and/or respondent determined parameters.

### BACKGROUND OF THE INVENTION

The growth in demand for commodities has resulted in the demand for liquidity in these markets. Currently there are three main sources of liquidity that market participants typically access: exchanges such as The Chicago Mercantile Exchange, Chicago Board of Trade, NYMEX and ICE, brokers such as ICAP, GFI and Prebon and bilateral trade utilizing the over-the-counter markets (OTC). Each of these pools enables market participants to transact with varying degrees of effectiveness depending on the needs of the particular participant and the complexities of the given transaction.

The complexity of the commodities markets presents challenges to each of the aforementioned liquidity pools. Exchanges tend to be very rigid in their contract specifications leaving many participants to force their transactions into less than optimal structures in order to take advantage of these liquidity pools. The contract specifications tend to be large and deliverable at one location, which doesn't typically reflect the actual demand or intent of the market participant. The exchanges also require the posting of margin which substantially increases the working capital requirements of firms utilizing these pools. These requirements are effective in reducing credit risk among participants and allow lower credit quality firms to access the market. However, these requirements unnecessarily raise the costs of accessing the markets for participants with higher credit ratings or who can routinely access credit from known counterparties. The margin required to hold positions on exchanges materially increase the cost of consummating these transactions on an exchange.

Brokers help to facilitate over the counter transactions for a fee. The brokerage service provides a level of transparency in the over the counter market for the market participants. The broker provides the traders with “color”, meaning the price action, tone, transaction sizes, and speed of the market. The potential misalignment of interest in this relationship between the broker and trader can result in a less than optimal transaction for the market participant. Traders transact in the market to secure resources, hedge financial exposure and speculate. Brokers earn their money through commissions on each transaction. This can result in excessive sales pressure and overstating the need to transact immediately. Brokers can direct trades to others participants in their network which may or may not result in the best price for the originator. While using a broker may result in increased visibility of a proposed transaction, the originator has no control over the selection of the counterparty until the counterparty is ultimately revealed by the broker to the originator. This may result in a potential transaction with a counterparty that is not acceptable to the originator due to credit quality or some other characteristic, requiring the process to start over or fail.

The bilateral over the counter (OTC) market takes place directly between the counterparties to a transaction. The originator will contact their authorized trading partners to begin negotiations or send out a request for pricing (RFP), utilizing mail, phone, fax, e-mail and/or instant messaging. This process allows the originator to structure the transaction to meet their needs and choose their potential counterparties. The ability to choose the counterparty allows a firm to monitor credit risk. The RFP process has traditionally been very slow; many potential customers have stated the RFP process can take several weeks and possibly months to close a transaction. This leaves both parties to a transaction exposed. The costs of business development associated with over the counter trading which relies on relationships can be very high both financially and due to the lapse of time. The audit trail associated with most OTC transactions is insufficient to comply with many of the new regulations associated with trading and risk management activities.

In addition, the flexibility of structuring OTC transactions is one of the characteristics that make the OTC market so attractive to traders at these firms. Many prior attempts at implementing an execution platform for commodities have failed due to attempts to further standardize and structure OTC transactions.

The revenue model has also proven to be a hindrance in many prior, attempts at implementing certain forms of an execution platform. Many companies have attempted to market the platform as a software license. This method of billing substantially hinders acceptance by the firms due to the fact that the service must go through the internal approval and adoption processes and may be charged to the firm's IT budget and must meet the approval of that department. Billing customers on a per transaction or volume based metric allows for the costs to be more easily associated with the specific transaction and department that benefits (i.e. “trading” or “procurement”) and allows for a much quicker implementation, eliminating a substantial up-front approval process and a long-term contractual commitment.

Despite the advances in the field, the industry is in need of more efficient systems and methods for facilitating a private commodity resource transaction.

### SUMMARY OF THE INVENTION

Entities which trade in the commodities markets, such as the energy market, can be categorized as market makers and price takers. A market maker is any entity or person who can perform in both the buy, and sell role, sometimes simultaneously, because they either produce the commodity, or trade the commodity in enough volume as to routinely have inventory or liquidity. In the energy market, British Petroleum (“BP”) is one example. A price taker is an entity that typically only performs the buy side, as the price taker neither produces nor stockpiles inventory. A municipal utility or a large industrial entity which has large commodity needs, such as energy needs, would be examples of price takers. Price takers usually always buy and rarely if ever sell, unless for example they have commodities to sell at some point. Thus, the present system and method will typically have two types of users: originators and respondents. Originators have a need to buy or sell something and wish to open a market to do so. Originators can be market makers or price takers. Originators simply need to buy or sell a commodity. As will be better understood from the following description, respondents are chosen by originators to participate in a market that the originator opens, and the respondent can choose to respond or not, in their sole discretion. Respondents can also be market makers or price takers. Thus, a price taker may be the originator, and a market maker could be the respondent, or vice verse.

The present invention provides a system and method for facilitating a private commodity resource transaction. The system may be implemented in a variety of ways, including as a computer readable medium for facilitating a private commodity resource transaction. The computer readable medium may store a set of instructions and logic for implementing an embodiment of the present invention within a centralized application service provider environment, such as on a central computer or server, available to originators and respondents over a network. The medium, such as a hard drive, random access memory, or other medium, has logic stored therein for (1) communicating to a remote computer, such as a client computer, from a central computer a plurality of market participant sign-in prompts; (2) receiving sign-in responses from the remote computer; (3) determining whether a market participant is associated with the sign-in responses; (4) verifying the level of access to which the market participant associated with the sign-in responses should be granted access, such as granting access to a plurality of market establishment prompts for establishing a market for the private commodity resource transaction. This logic is generally provided to act as a security threshold that limits unauthorized market participants from logging into another market participant's account and for limiting access to some or all market originating and/or responding interfaces and functions to respective authorized users.

The medium further has logic for communicating a plurality of market establishment prompts from the central computer to the remote computer for entering market establishment bid and/or offer information and other information which is then used to establish a private market for a commodity resource transaction. The originator then enters the market establishment offer and other information into the prompts, such as commodity type to offer or buy, physical trade type, financial trade type, offer volume, offer price, delivery location, delivery start date, delivery end date, period adjustment information when factors such as volume, price or other factors may vary over time, timer information for setting a time during which the market will remain open, comments and special terms for the offer, file attachments relative to the transaction, and/or linked trade information for offers which may be linked to another transaction on the platform for the purpose of ensuring only 1 of the 2 linked transactions is executed (one cancels the other). The medium has logic for establishing the market for the private commodity resource transaction as a result of the originator requesting that a market be established. The medium also has logic for receiving a selected subset of potential respondents selected from a predetermined set of potential respondents which is stored in a central database associated with the central computer, for offering to the selected subset of potential respondents the private commodity resource transaction within the market established by the originator for the private commodity resource transaction. The medium further has logic for determining which potential respondent of the predetermined set of potential respondents with which to communicate the market establishment offer information to based on the selected subset of potential respondents from the predetermined set of respondents within the central database. The medium also has logic for privately communicating the market establishment offer information to the potential respondents within the selected subset of potential respondents and for receiving an acceptance response from at least of one the potential respondents within the selected subset of potential respondents.

The medium further has logic for determining a first complete acceptance (not a counter-offer) received from one of the potential respondents within the selected subset of potential respondents. The logic further includes identifying which of the potential respondents of the subset of potential respondents is associated with the first complete acceptance. In other words, the first complete acceptance is the first response received by the central computer which accepts all terms of the market establishment offer. The medium also has logic for privately communicating to the identified respondent an execution confirmation communication informing the identified originator that the identified originator's acceptance response has been accepted, and closing the market for the private commodity resource transaction in response to receipt of the first complete acceptance by the central computer from the respondent (counter-party). Thus, in this embodiment, the commodity resource transaction has been consummated and the originator and respondent (or party and counter-party) to the transaction fulfill their obligations for the transaction exterior to the system, such as payment, delivery, etc. Fulfilling the obligations of the transaction is typically performed according to a Master Trade Agreement (MTA) which may already be in place between the party and counter-party (and possibly others).

The present system and method alleviates the concerns associated with OTC trading and many of the drawbacks of the other liquidity pools, especially as concerns complex, structured bilateral transactions. This platform will allow an originator to send out a transaction to their selected counterparties simultaneously setting up a confidential one-to-many virtual private market (VPM). The counterparty may respond with a counteroffer which establishes confidential one-to-one negotiation. In one embodiment, the responding party can change the parameters of the proposed transaction for price and volume, and provide free form comments, special terms, attachments, and set the expiration timer for their response. The system and method will highlight the alterations to price and volume in the proposed transaction when the originator receives the counteroffer. This allows for faster evaluation of counteroffers and response times therefore reducing the exposure of both firms to market fluctuations as negotiations are taking place.

The ability to open virtual private markets and conduct one to one negotiations can reduce the impact of large transactions on the market. Large energy producers and consumers can negotiate with each other more effectively as a result of the speed of the platform and without disclosing their needs in the open market. Speculators will not have the opportunity to get in front of large orders and trade against the order flow as they do on exchanges.

The present system and method provides an audit trail that helps firms to comply with recently enacted accounting rules and standards. Currently, many customers have stated that due to compliance issues, many transactions that have enormous profit potential are disallowed by the compliance officers sitting on the trading desks due to a lack of an audit trail revealing the negotiating process. The present system and method addresses this issue by logging each offer and counteroffer creating an auditable database.

The present system and method further alleviates the uncertainty associated with brokered trades due to the fact that potential counterparties are identified by the originator. The originator can be assured of attaining the best price through the negotiating process. Also, by using the VPM platform for the present system and method, a firm can expand its potential network of counterparties (vis-à-vis the other liquidity pools) which can also improve the chances of obtaining the best price for each transaction.

As the present system and method is accepted by market participants, business development costs can be greatly reduced. One further aspect of the present system and method includes allowing market participants to communicate with other market participants that are not currently in their trading networks. In one embodiment, this can be achieved by providing a filtering mechanism that allows market participants to refine the list of potential counterparties for a system defined marketplace by specifically identifying those counterparties based on criteria including, but not limited to, commodities actively traded, active regions, active hubs/market points, and/or buy or sell activity as set by the CP. This effectively reduces the time it takes to identify potential trading partners outside of current networks, allows immediate communication and provides the ability to include new trading partners in a network immediately upon adoption of what one of ordinary skill in the art knows as a Master Trading Agreement, along with credit approval.

The present system and method can also be structured to utilize a central software and data repository, and an application service provider (ASP) delivered web-enabled client application that interacts with the centralized servers via the internet. In one embodiment, no license fees will be charged to utilize the software; rather the parties to an executed transaction will pay a fee when the system is used based on the volume of any particular commodity that is bought or sold.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of a computer based private commodity resource transaction system.

FIG. 2 is a block diagram of one form of the private commodity resource transaction system of FIG. 1.

FIG. 3 is a block diagram of one form of a computer or server of FIG. 1 and/or FIG. 2, having a memory element with a computer readable medium for implementing the private commodity resource transaction system.

FIG. 4A is a flowchart showing an exemplar embodiment of the private commodity resource transaction facilitator of FIG. 3.

FIG. 4B is a continuation of the flowchart of FIG. 4A.

FIG. 4C is a continuation of the flowchart of FIG. 4B.

FIG. 5 is a main messages/inbox interface screen of a transaction client application of one preferred embodiment of the private commodity resource transaction system of the present invention.

FIG. 6 is a distribution list management interface screen of a transaction client application of one preferred embodiment of the private commodity resource transaction system of the present invention.

FIG. 7 is the distribution list management interface screen of FIG. 6 with particular selections made.

FIG. 8 is a deal detail/structure interface screen of a transaction client application of one preferred embodiment of the private commodity resource transaction system of the present invention.

FIG. 9 is a deal detail/parameters interface screen of a transaction client application of one preferred embodiment of the private commodity resource transaction system of the present invention.

FIG. 10 is a deal detail/grid interface screen of a transaction client application of one preferred embodiment of the private commodity resource transaction system of the present invention.

FIG. 11 is a counterparties interface screen of a transaction client application of one preferred embodiment of the private commodity resource transaction system of the present invention.

FIG. 12 is an expiration interface screen of a transaction client application of one preferred embodiment of the private commodity resource transaction system of the present invention.

FIG. 13 is a sent messages interface screen of a transaction client application of one preferred embodiment of the private commodity resource transaction system of the present invention.

FIG. 14 is a deal summary interface screen of a transaction client application of one preferred embodiment of the private commodity resource transaction system of the present invention.

FIG. 15 is a view comments interface screen of a transaction client application of one preferred embodiment of the private commodity resource transaction system of the present invention.

FIG. 16 is a view special terms interface screen of a transaction client application of one preferred embodiment of the private commodity resource transaction system of the present invention.

FIG. 17 is an internal notes/forwarding a message interface screen of a transaction client application of one preferred embodiment of the private commodity resource transaction system of the present invention.

FIG. 18 is the main messages/inbox interface screen of FIG. 5 showing forwarded messages.

FIG. 19 is a deal summary/replying to a message interface screen of a transaction client application of one preferred embodiment of the private commodity resource transaction system of the present invention.

FIG. 20 is a comments/replying to a message interface screen of a transaction client application of one preferred embodiment of the private commodity resource transaction system of the present invention.

FIG. 21 is a special terms/replying to a message interface screen of a transaction client application of one preferred embodiment of the private commodity resource transaction system of the present invention.

FIG. 22 is an expiration/replying to a message interface screen of a transaction client application of one preferred embodiment of the private commodity resource transaction system of the present invention.

FIG. 23 is a main messages/executed transactions interface screen of a transaction client application of one preferred embodiment of the private commodity resource transaction system of the present invention.

FIG. 23A is a break executed message request interface screen of a transaction client application of one preferred embodiment of the private commodity resource transaction system of the present invention.

FIG. 24 is a company profile/general information interface screen of a customer administration application of one preferred embodiment of the private commodity resource transaction system of the present invention.

FIG. 25 is a company profile/commodities interface screen of a customer administration application of one preferred embodiment of the private commodity resource transaction system of the present invention.

FIG. 26 is a company profile/trading entities interface screen of a customer administration application of one preferred embodiment of the private commodity resource transaction system of the present invention.

FIG. 27 is a counterparty management interface screen of a customer administration application of one preferred embodiment of the private commodity resource transaction system of the present invention.

FIG. 28 is a counterparty management/filter popup interface screen of-a customer administration application of one preferred embodiment of the private commodity resource transaction system of the present invention.

FIG. 29 is a main user management interface screen of a customer administration application of one preferred embodiment of the private commodity resource transaction system of the present invention.

FIG. 30 is a user management/add user/entitlements interface screen of a customer administration application of one preferred embodiment of the private commodity resource transaction system of the present invention.

FIG. 31 is a user management/add user/entitlements/authorized markets interface screen of a customer administration application of one preferred embodiment of the private commodity resource transaction system of the present invention.

FIG. 32 is a user management/add user/entitlements/authorized deal types interface screen of a customer administration application of one preferred embodiment of the private commodity resource transaction system of the present invention.

FIG. 33 is a user management/add user/entitlements/authorized counterparties interface screen of a customer administration application of one preferred embodiment of the private commodity resource transaction system of the present invention.

FIG. 34 is a user management/add user/entitlements/transaction limits interface screen of a customer administration application of one preferred embodiment of the private commodity resource transaction system of the present invention.

FIG. 35 is a user management/add user/entitlements/transaction limits/add financial limit popup interface screen of a customer administration application of one preferred embodiment of the private commodity resource transaction system of the present invention.

FIG. 36 is a user management/add user/entitlements/transaction limits/add volume limit popup interface screen of a customer administration application of one preferred embodiment of the private commodity resource transaction system of the present invention.

FIG. 37 is a user management/add user/entitlements/transaction limits/add tenor limit popup interface screen of a customer administration application of one preferred embodiment of the private commodity resource transaction system of the present invention.

FIG. 38 is a transaction management/confirmation notification interface screen of a customer administration application of one preferred embodiment of the private commodity resource transaction system of the present invention.

FIG. 39 is a transaction management/message management interface screen of a customer administration application of one preferred embodiment of the private commodity resource transaction system of the present invention.

FIG. 40 is a reports/data export interface screen of a customer administration application of one preferred embodiment of the private commodity resource transaction system of the present invention.

FIG. 41 is an account management interface screen of a host administration application of one preferred embodiment of the private commodity resource transaction system of the present invention.

FIG. 42 is an account management/add account interface screen of a host administration application of one preferred embodiment of the private commodity resource transaction system of the present invention.

FIG. 43 is an account management/manage account interface screen of a host administration application of one preferred embodiment of the private commodity resource transaction system of the present invention.

FIG. 44 is an executable transaction message flow diagram of one preferred embodiment of the private commodity resource transaction system of the present invention.

FIG. 45 is an indicative/RFP (request for proposal) transaction message flow diagram of one preferred embodiment of the private commodity resource transaction system of the present invention.

FIG. 45a is an alternative indicative/RFP (request for proposal) transaction message flow diagram of one more preferred alternative embodiment of the private commodity resource transaction system of the present invention.

FIG. 45b is a further transaction management/message management interface screen of the customer administration application of the private commodity resource transaction system of FIG. 45a.

FIG. 45c is a transaction management/message management interface screen of the customer administration application of the private commodity resource transaction system of FIG. 45a.

FIG. 46 is a break message flow diagram of one preferred embodiment of the private commodity resource transaction system of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention provides companies or other entities which want to enter into bilateral commodity resource transactions a platform to do so. Specifically, entities may wish to offer a commodity resource transaction to others to buy or sell a commodity, or a derivative thereof, and can use the present invention to open a market to do so. Entities wishing to open such a market can be considered as originators, and entities which the commodity resource transaction is directed to can be considered as potential respondents, as is described in greater detail herein. Some examples of originators and respondents can include commodity resource producing entities, such as gas or other energy producers, as well as non-producing entities, such as utilities and industrial companies with their own energy resource needs or transformation capabilities (i.e., electric generation plants), which do not have direct access to the commodity, such as an energy resource.

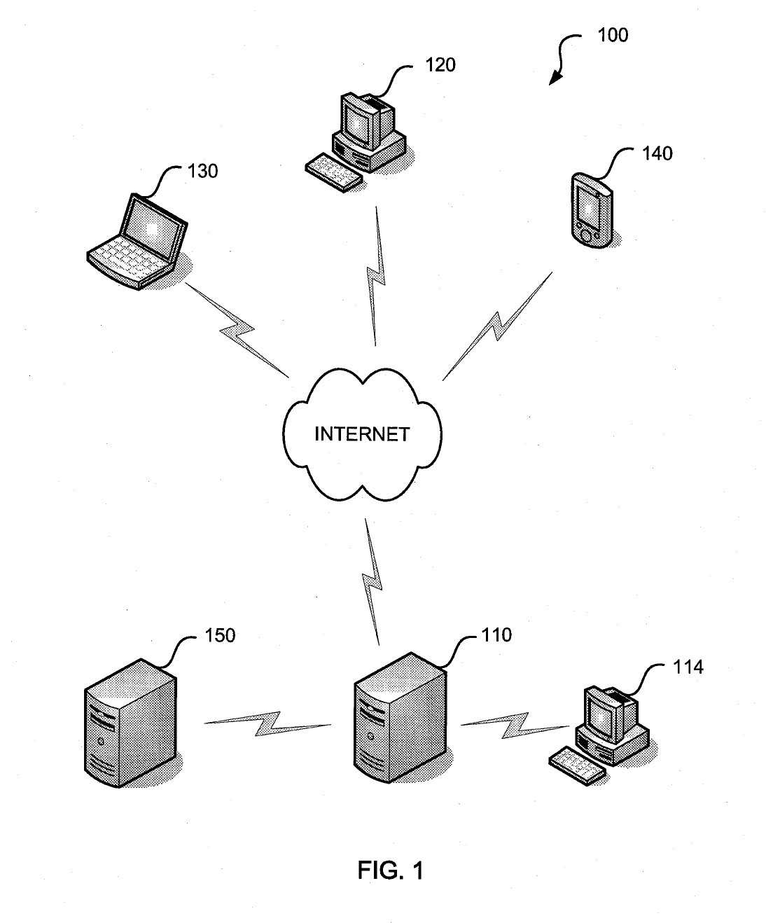

FIG. 1 is a graphical representation of a computer based commodity resource transaction system 100. The system includes a plurality of originator/respondent remote computers 120, 130, 140, such as client computers, which are connected to and in communication with a network, such as the Internet, a manner which is known in the art and which will be better understood from the below description. These remote computers 120, 130, 140 each can run an interface program, such as an Internet browser application, for connecting to the Internet, capable of communicating with a centralized commodity resource private trading market facilitator application or system, which can be server-based and running in an application service provider arrangement. Specifically, for communicating with the originator/respondent remote computers 120, 130, 140, a central commodity resource market facilitation computer 110 is connected to and in communication with a network, such as the Internet, in a manner which is known in the art. Firewall and other security systems and applications (not shown) may be used to prevent and deter unauthorized access to the market facilitation computer 110, as is known in the computer networking art.

For the central computer 110 and the commodity resource private trading market facilitator application or system therein, as will be described in more detail below, a marketplace administration client computer 114 may be connected to and may be placed in communication with the market facilitation computer 110 for interfacing with the market facilitation computer 110 to provide installation, set-up, and/or ongoing maintenance interface functions. The market facilitation computer 110 may also be connected to and be in communication with one or more third party computers or servers 150. One example of a third party computer 150 is a public market computer which can provide various real time market information about publicly traded securities, commodities, and other public market information. Another example of a third party computer 150 is an originator/respondent financial information verification information computer which can provide various real time financial and credit information about one or more of the originators and/or respondents for verifying that an originator and/or respondent qualifies for one or more markets established by or attempted to be established by an originator.

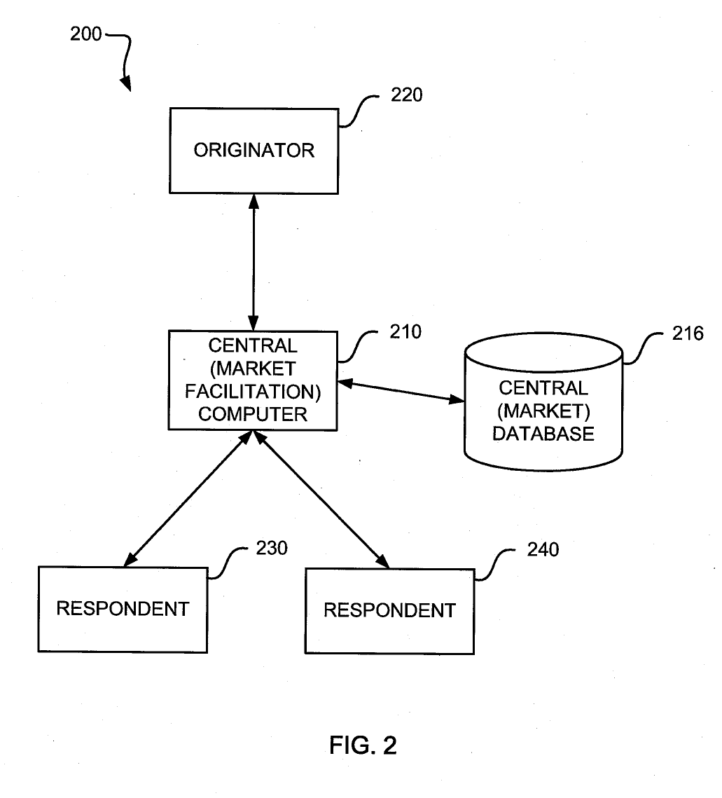

FIG. 2 is a block diagram of the computer based commodity resource transaction system 200 of FIG. 1. Specifically, each of the remote/client computers 120, 130, 140 of FIG. 1 can perform and function as either an originator remote/client computer 220, a respondent remote/client computer 230, 240, or both. The originator remote computer 220 block of FIG. 2 may also represent a set of interface screens and functionality for performing all of the origination functions provided by market facilitation computer 210, which is connected to and in communication with the originator remote computer 220. Likewise, the respondent remote/client computers 230, 240 blocks of FIG. 2 may also represent a set of interface screens and functionality for performing all of the respondent functions provided by market facilitation computer 210, which is connected to and in communication with the respondent remote/client computers 230, 240. Further, the market facilitation computer 210 block of FIG. 2 can also represent various sets of interface screens and functionality for performing all of the functions provided by the market facilitation computer 210, which is connected to and in communication with a central market database 216 residing within a memory.

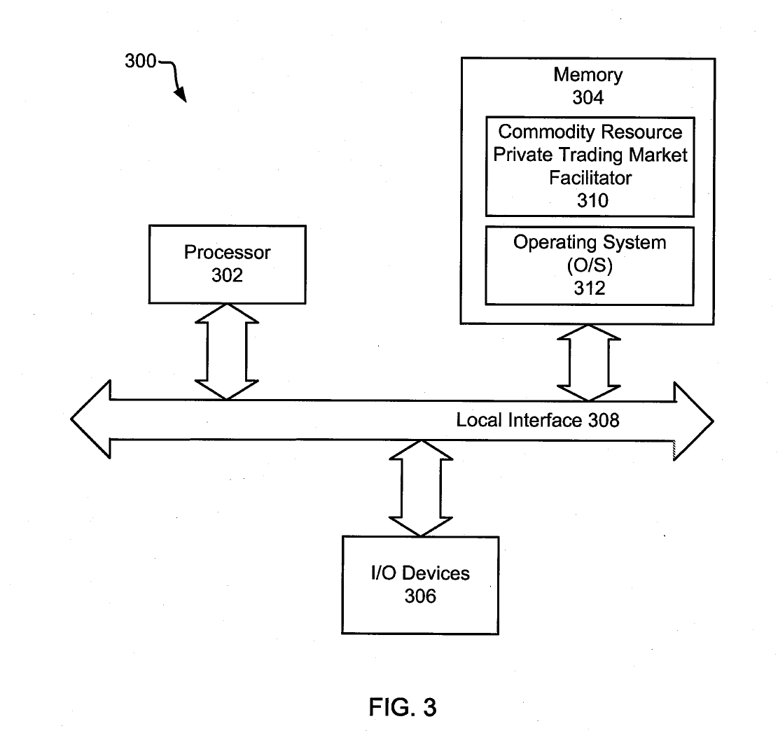

FIG. 3 is a block diagram of a computer 300. The computer 300 may be the market facilitation computer 110 of FIG. 1 and/or the market facilitation computer 210 of FIG. 2. The computer 300 may include a memory element 304. The memory element 304 may include a computer readable medium for implementing the system and method for facilitating a private commodity resource transaction.

The commodity resource private trading market facilitator system 310 may be implemented in software, firmware, hardware, or any combination thereof. For example, in one mode, the commodity resource private trading market facilitator system 310 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. Therefore, computer 300 may be representative of any computer in which the commodity resource private trading market facilitator system 310 resides or partially resides.

Generally, in terms of hardware architecture, as shown in FIG. 3, the computer 300 includes a processor 302, memory 304, and one or more input and/or output (I/O) devices 306 (or peripherals) that are communicatively coupled via a local interface 308. The local interface 308 may be, for example, but is not limited to, one or more buses or other wired or wireless connections, as is known in the art. The local interface 308 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with the computer 300, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a SPRAC microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 3, the software in memory 304 includes the commodity resource private trading market facilitator system 310 in accordance with the present invention, a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as the commodity resource private trading market facilitator system 310, and provides scheduling, input-output control, file and data management, memory management, and communication control and related services.

The commodity resource private trading market facilitator system 310 may be a source program, executable program (object code), script, or any other entity comprising a set of instructions to be performed. When a “source” program, the program needs to be translated via a compiler, assembler, interpreter, or the like, which may or may not be included within the memory 304, so as to operate properly in connection with the O/S 312. Furthermore, the commodity resource private trading market facilitator system 310 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the commodity resource private trading market facilitator system 310 is written in Java.

The I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 306 may also include output devices, for example but not limited to, output modules for PLCs, a printer, bar code printers, displays, etc. Finally, the I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computer 300 is a PC, workstation, PDA, or the like, the software in the memory 304 may further include a basic input output system (BIOS) (not shown in FIG. 3). The BIOS is a set of essential software routines that initialize and test hardware at startup, start the O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The commodity resource private trading market facilitator system 310, and the O/S 312, in whole or in part, but typically the latter, may be read by processor 302, buffered within the processor 302, and then executed.

When the commodity resource private trading market facilitator system 310 is implemented in software, as is shown in FIG. 3, it should be noted that the commodity resource private trading market facilitator system 310 can be stored on any computer readable medium for use by or in connection with any computer related system or method, although in one preferred embodiment, the commodity resource private trading market facilitator system 310 is implemented in a centralized application service provider arrangement. In the context of this document, a computer readable medium is an electronic, magnetic, optical, or other physical device or means that can contain or store a computer program for use by or in connection with a computer related system or method. The commodity resource private trading market facilitator system 310 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the commodity resource private trading market facilitator system 310 is implemented in hardware, the commodity resource private trading market facilitator system 310 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

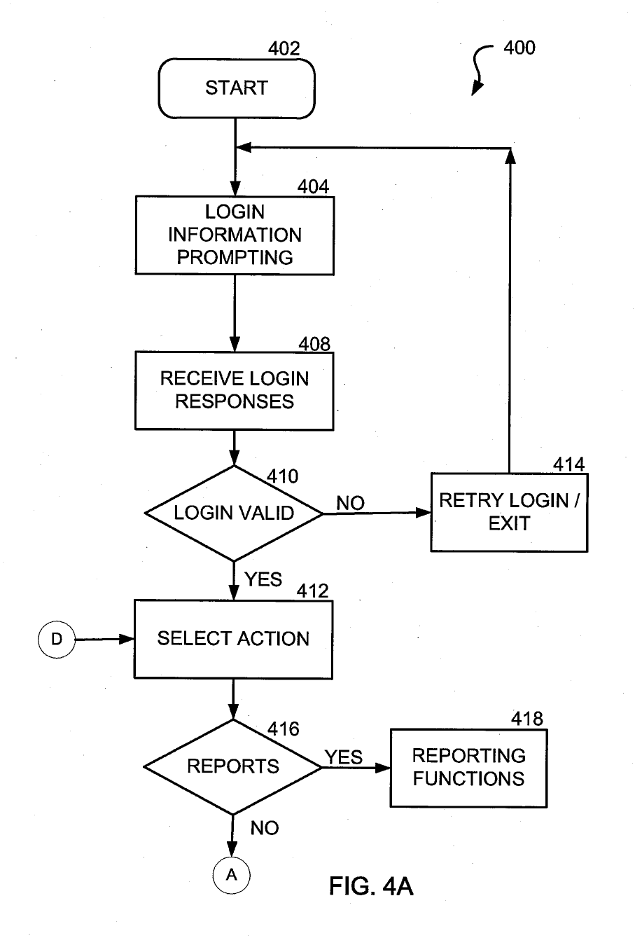

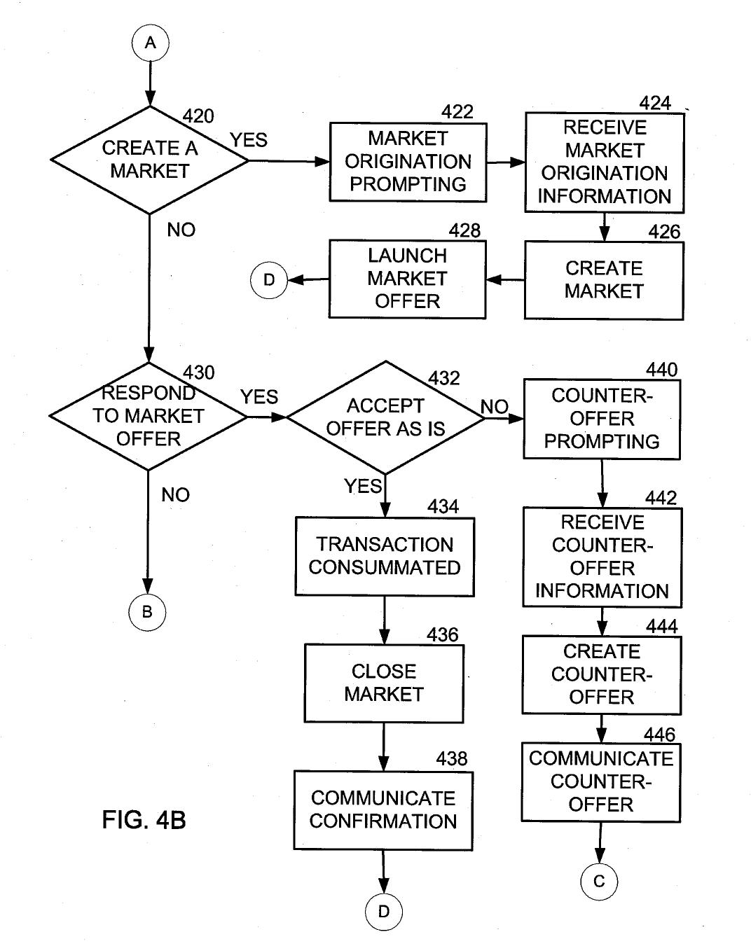

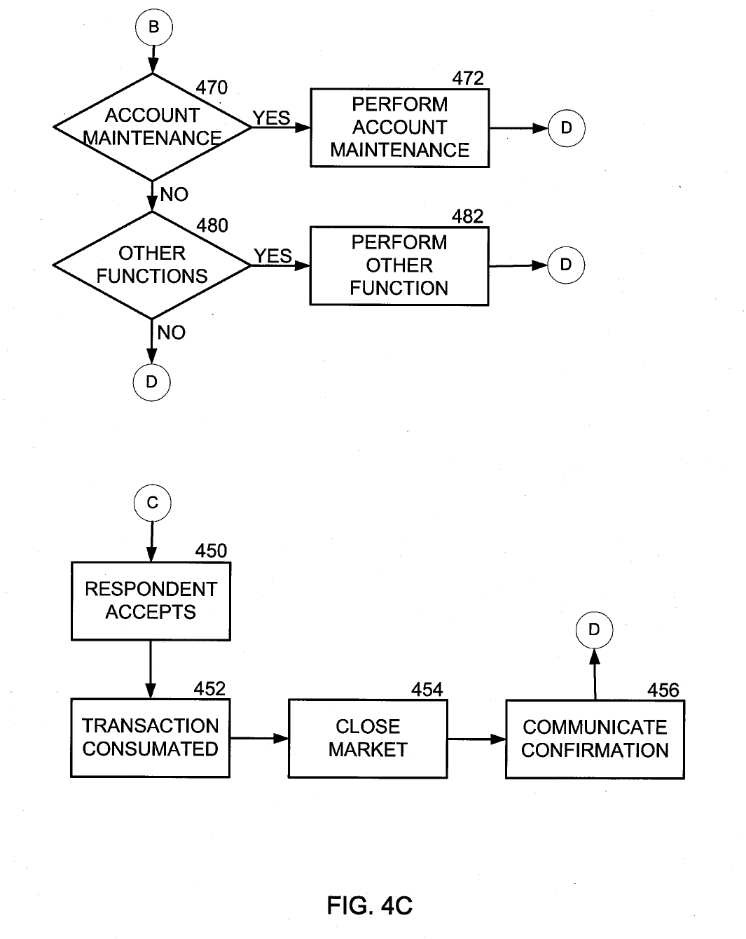

FIG. 4A-4C is a flowchart showing a first exemplary embodiment of the commodity resource private trading market facilitator 310 of FIG. 3, shown as blocks within FIGS. 4A-4C, which can be considered facilitator system 400 as well or in the alternative. In block 402, the processor calls or triggers the facilitator system 210, 310, 400. After block 402, the facilitator system 210, 310, 400 moves to block 404. In block 404, facilitator system 210, 310, 400 communicates to a remote/client computer from the central computer a plurality of sign-in prompts. The sign-in prompts can be for a user without designation of any originator, respondent, or other type of user. In fact, most users of the system 210, 310, 400 will be able to perform both origination functions and respondent functions (create markets and offer to sell/buy commodities (and derivatives thereof), as well as respond to offers to buy/sell commodities (and derivatives thereof), such as a natural gas commodity, using the same user account). However, some user accounts may be restricted through the configuration of transaction-level entitlements for price, volume, and tenor, as well as counterparty, commodity, and regional transaction limits as will be explained further below along with other account setup limitations which can be entered and stored in the central database. Thus, in one example, user login prompts are communicated from the central computer to the client computer where the user is located, and provided for allowing a user to create or originate a market to log into the facilitator system 210, 310, 400. Prompts, such as user ID and password prompts, may be sent to the user at the remote/client computer for this purpose.

After block 404, the facilitator system 210, 310, 400 moves to block 408. At block 408, the system 210, 310, 400 has logic for receiving sign-in or login responses from the remote/client computer at the central computer. The central database will have stored therein user account information including a username and login ID, as well as a company name, address, phone number, email contact information, financial account information relating to the user for executing transactions, and other information which identifies the user and which is associated with the user for implementing transactions. After block 408, the facilitator system 210, 310, 400 moves to block 410. At block 410, the system 210, 310, 400 has logic for determining whether a user, such as an originator is associated with the sign-in or login responses. At block 414, if the user login information does not match login information stored in the central database, the user is not granted access to the system 210, 310, 400 and can try to log into the system again. The system 210, 310, 400 also has logic for verifying whether the originator associated with the sign-in responses should be granted access to functions of the system 210, 310, 400. In one embodiment, the user is only allowed a predetermined number of unsuccessful attempts to log into the system 210, 310, 400 before the user and respective client computer is locked out from further attempts at logging into the system 210, 310, 400 running on the central computer or server. Once the user gains access to the system, some of the functions of the system available to a user include generating reports (see block 416), making or creating a market (see block 420), responding to a market offer (see block 430), maintaining user accounts (see block 470), and other functions (see block 480). Depending on the user level, a user may have access to some or all of these and other functions to select from once the user is logged into the system 210, 310, 400, as will be better understood with references to one preferred embodiment described herein below.

In one general embodiment the facilitator system 210, 310, 400 moves to blocks 412, where appropriate and allowable user selections for the user type which has logged into the system. In one embodiment, FIGS. 4A-4C generally show some of the selections available to a user, as shown with reference to blocks 420 and 430, and related blocks. Thus, beginning at block 410, the system 210, 310, 400 begins looping to provide the user with the ability to select reporting functions (block 416 and related blocks), transaction functions (blocks 420, 430, and related blocks), account maintenance functions (block 470 and related blocks), and other functions (block 480 and related blocks). As such, the system 210, 310, 400 includes logic at block 420 for gaining access to transaction interfaces and functions. The system 210, 310, 400 also include logic at block 422 for providing to the user a plurality of market establishment or transaction interface screens and prompts to the remote/client computer of the user from the central computer, for establishing a market or private commodity resource transaction. Thus, if the user would like to establish a private commodity transaction, the user can select transaction establishment functions provided through one or more interface screens at the remote/client computer from the central computer, as generally indicated at block 420. The system 210, 310, 400 can provide the plurality of market establishment interface screens prompts to the remote/client computer of the user from the central computer, for establishing a market for the private commodity resource transaction.

The system 210, 310, 400 logic at blocks 422 and 424, through one more interface screen provided to the user through a remote/client computer, prompts the user to enter various information needed and/or useful in establishing a market and ultimately making market offers, as will be described in greater detail in the context of one preferred embodiment herein below. The system 210, 310, 400 central computer can receive the market making or origination information for use in establishing or creating a market/transaction For example, this logic is configured to communicate the plurality of market/transaction establishment prompts from the central computer to the remote/client computer for entering market/transaction establishment offer information and other information which is then used to establish a private market for offering to potential respondents a commodity resource transaction. Specifically, the system 210, 310, 400 prompts the user to enter (1) a commodity type to offer other system users in the role of a respondent type to purchase such commodity, such as natural gas; (2) physical trade type (a transaction where the result is a physical delivery of the commodity); (3) financial trade type (a transaction where the result is financial gain or loss, but where there is no physical delivery of the commodity); (4) offer volume, such as the number of Million British Thermal Units (MMBTU) of natural gas; (5) offer price in either USD (U.S. dollars) or CAD (Canadian dollars); (6) delivery location, such as where natural gas will be delivered (for example through or to a particular natural gas line or to a particular pipeline HUB location); (7) delivery start date, such as when the delivery of the natural gas will begin; (8) delivery end date, such as when the delivery of natural gas will end; (9) daily price period adjustments when factors such as delivery, price or other factors may vary over time; (10) timer information for setting an amount of time to leave the market open for; (11) comments for the offer; (12) special terms for the offer (13) linked trade information for offers which may be linked to one other transaction; The user can also be required to enter or select (or optionally enter or select) other information to establish a market offer, such as a company name, commodity type (such as natural gas), trade type, as further described herein below, authorized counter-parties (whom inside the party or counter-party's organization can trade with whom outside a counter-party or party's organization, which is determined by each party), time limit for any transaction to be consummated or for a market to stay open, and/or physical locations for the trade (physical location of the transfer of the commodity or other physical location(s) of the settlement or fulfillment of the transaction, as defined by the party or counter-party). In one embodiment, the user can also specify trade type with more specificity, including (1) physical trade type such as collar, call option, put option, fixed forward, trigger, basis, and/or index forward types; and/or (2) financial trade type, such as put options, call options, collar, basis swap, and/or swing swap types. These trade types are well known in the industry. Other input prompts may also be provided to the user for requesting other information depending on the trade type or other considerations. For example, system 210, 310, 400 has logic for prompting the originating user to enter or select a subset of potential respondents from a list of potential respondents which has already been stored in a database associated with the central computer, as provided above. This system 210, 310, 400 logic generates the list of potential respondents by determining which respondents are qualified to receive offers according to how each of the user accounts are set up or configured. User accounts can be limited to transactions below a predetermined monetary value, offer volume, or above or below a deal tenor limit. In a preferred embodiment, these limits will be set by the party or counter-party's administrator, not by the hosting entity of the system 210, 310, 400. Thus, a respective limitation for each of the pieces of information which the market making user is prompted to enter to establish an offer can exist and limit the respondents which are available for the originator to provide such offers in private. In one embodiment, the market making user can have the option of selecting less then all of the qualified respondents from the provided list within the market making interface provided to the remote/client computer. This selection process of the system 210, 310, 400 logic, of the originator choosing or selecting which accounts to provide the market to (provide the offer to) and/or of the system 210, 310, 400 determining or selecting which accounts to provide the market to, and/or some other process, is ultimately for offering to the selected subset of potential respondents the private commodity resource transaction within the market established by the originator for the private commodity resource transaction. The user responds to each prompt by choosing from pull down menus, directly entering information into an input field or using some other method or structure for entering market making information into the user interface. None of the selected potential respondents will receive any communication from the system 210, 310, 400 allowing any of the potential respondents to determine the identity of any other of the selected potential respondents.

By the user responding to the market making prompts through the remote/client computer, the system and central computer/central database therein receives the market making information which the user enters. At this point, the system 210, 310, 400 can be configured to automatically create a market or the user can be further prompted to finalize the market offer. In either case, the originator is considered to have requested that a market be established for the private commodity resource transaction. Thus, after block 424, the system 210, 310, 400 moves to block 426 and includes logic for establishing a market for a private commodity resource transaction, and for generating a market establishment offer which is then provided to the selected potential respondents. All pre-market and post-market creation activity for a market is tracked, starting with the market making user selecting to open or create a market, within the central database. The tracked information and actions can include all of the selected or entered information of each of the different users which participate in one way or another in creating and responding to a market/market offer, or only certain actions which the system is set up to track and store (if such action takes place). This information and actions include at least the actions of the market marker entering the market making information (including the market making information), the identity and related information of each selected respondent which receives the market offer, as well as all responses by each of the potential respondents, including information on the respondent and the terms of each offer and counter-offer, and the terms of such offer or counter-offer that is ultimately accepted.

After block 426, the system 210, 310, 400 moves to block 428 and includes logic for privately communicating the market establishment offer information to the potential respondents within the selected subset of potential respondents. This communication can take place in several ways. The respondent receiving such notification can log into the system 210, 310, 400 through similar prompts as described above in blocks 402, 404, 408, 410 and 414, and at block 430 the system 210, 310, 400 has logic for the user to view, through an available commodity market offers interface screen, all market offers which are available to that particular respondent user. For example, each of the potential respondents within the selected subset of potential respondents can receive an email, which can include a notification with a link to log into the system 210, 310, 400 through a remote/client computer to gain access to the system 210, 310, 400 running on the central computer. The respondent user can select a particular market offer to review the particular details of the commodity market offer in order for the respondent to determine if they want to respond to the market offer. The system 210, 310, 400 can be configured so that only particular selected potential respondents will receive, can view, and are provided with an opportunity to participate in the opened market for the commodity transaction, as is described above. In this embodiment, only such selected potential respondents can respond to such market offer received as a result of the originator opening the market. If one or more of the selected potential respondents are satisfied with the terms of the market offer, the system 210, 310, 400 has logic at block 432 for providing the respondent with an accept offer interface option to accept the market offer as is, without changing any of the terms of the market offer. Thus, the system 210, 310, 400 includes logic for receiving an acceptance response from at least one of the potential respondents within the selected subset of potential respondents. The system 210, 310, 400 further includes logic for determining a first complete acceptance from the acceptance responses from the potential respondents within the selected subset of potential respondents. Multiple respondents may choose to accept the market offer as is by responding to the market offer through the maker taker user interface screen provided through a remote/client computer. The system 210, 310, 400 is configured to determine in block 432 which one of the acceptance responses from the respondent users is a “complete” (i.e., not a counter-offer) acceptance response received by the system 210, 310, 400 central computer, and for identifying which of the potential respondents of the subset of potential respondents is associated with the complete acceptance response. The respondent associated with the acceptance response can be considered as an identified respondent. In one embodiment, the first complete acceptance is the first response received by the central computer from the remote/client computers being used by the selected subset of potential respondents, which accepts all terms of the market establishment offer.

In the embodiment shown in FIG. 4B in block 432, if the respondent user accepts the offer as is without changing any of the terms of the market offer, the system 210, 310, 400 moves to block 434 indicating that the system 210, 310, 400 includes logic concluding that the market offer has been accepted by a particular respondent (which also identifies such respondent), and that a commodity resource transaction has been consummated. This information is tracked and stored in the central database, including all of the market offer information as it stands at the time of the acceptance of the market offer by the respondent, and is stored for at least record keeping and reporting purposes, and may also be needed for regulatory purposes. The system 210, 310, 400 then moves to block 436 and includes logic for closing the market for the private commodity resource transaction in response to establishing the identified respondent which has accepted the market offer. In one embodiment, the system 210, 310, 400 includes logic for privately communicating to the potential respondents of the subset of potential respondents that the market is closed for the private commodity resource transaction. In one embodiment, only the potential respondents which are not the identified respondent are sent such a communication. The closing of the market is one example of a trigger that can be used to issue the communication being sent to each of the selected potential respondents that originally received a market offer communication to inform such potential respondents that the particular market is closed. Another example includes the acceptance of the market offer by the identified respondent. Other triggers are possible as well. The system 210, 310, 400 then moves to block 438 and includes logic for privately communicating to the identified respondent user an execution communication for informing the identified respondent user that the identified respondent's acceptance response has been accepted, and that the respondent user has entered into a transaction with the originator for that particular market. The parties to the transaction must then fulfill the obligations of the commodity resource transaction which has been consummated, such as payment, delivery, etc. The identified respondent of the selected potential respondents will receive the execution communication along with any other individuals as defined by the customer administrator. Additionally a customer administrator can also view execution communications, and other recent and historical transactions which have been consummated.

Alternatively, referring to block 432 again, instead of one or more selected potential respondents accepting the market offer as is, such selected potential respondents can choose or select a counter-offer option as a form of responding to a market offer that has been provided to such respondents users, and then modify or remove one or more market offer information through the respondent user interface screen. As such, the system 210, 310, 400 moves to block 440 and includes logic for communicating modification prompts to the selected subset of potential respondents for allowing the selected subset of potential respondents to modify the market establishment offer information. In one embodiment, the system 210, 310, 400 prompts the respondent user with one or more portions of the market offer information and allows the respondent user to modify each such portion of market offer information. The system 210, 310, 400 can also provide the respondent with a counter-offer timer through the respondent interface screen, for allowing the respondent to set an amount of time to keep the counter-offer open. The system 210, 310, 400 then moves to block 442 and includes logic for receiving these modification responses which can be considered as counter-offer information from one or more potential respondents. The system 210, 310, 400 also includes logic for determining that all of the necessary counter-offer information has been received from the potential respondent that has provided such information, as well as logic for identifying which of the potential respondents of the subset of potential respondents is associated with the counter-offer. Moving to block 444, the system 210, 310, 400 further includes logic for providing the selected potential respondent user that provided the counter-offer information with one or more prompts to confirm that such respondent user wishes to actually issue and communicate the counter-offer to the originator. Once the system 210, 310, 400 receives a response from the respondent user indicating that the respondent user wishes to issue the counter-offer, at block 444, the system 210, 310, 400 further includes logic for creating a counter-offer representative of counter-offer information received from the remote/client computer (used by the respondent user) by the central computer. The system 210, 310, 400 then moves to block 446, and includes logic for communicating the (first) counter-offer to the originator for consideration by the originator. The communication can take the same form as the Communication of the original market offer to the respondents, or other forms. In one preferred embodiment, the communication of the counter-offer is only communicated to the market maker.

Referring to FIG. 4C, the system 210, 310, 400 then moves to block 450 and includes logic for receiving a counter-offer acceptance from the originator for the counter-offer and for establishing an identified respondent. Once the system 210, 310, 400 and central computer sends the counter offer(s) to the originator, the remote/client computer receives the counter-offer or a plurality of counter-offers (from different selected potential respondents) and displays such counter-offer(s) on the originator interface screen. The originator can view such counter-offers and determine which, if any, to select to accept. Once the originator user accepts the counter-offer, by, for example, pressing an execute button or other input within the originator interface screen, the remote/client computer communicates such acceptance to the central computer and the system 210, 310, 400.

Referring to blocks 452, 454, and 456 of FIG. 4C, if the originator accepts one of the received counter-offers “as is” without changing any of the terms of the counter-offer, the system 210, 310, 400 moves to these blocks, indicating that the system 210, 310, 400 includes logic concluding that the counter-offer has been accepted by the originator, and that a commodity resource transaction has been consummated. This information may be tracked and stored in the central database, including all of the counter-offer information as it stands at the time of the acceptance of the counter-offer by the originator, and may be stored for at least record keeping, reporting, and other purposes. The system 210, 310, 400 further includes logic for closing the market for the private commodity resource transaction in response to establishing the identified respondent for which the originator has accepted such selected potential respondent's counter-offer. In one embodiment, the system 210, 310, 400 includes logic for privately communicating to the potential respondents of the subset of potential respondents that the market is closed for the private commodity resource transaction. In one embodiment, only the potential respondents which are not the identified respondent are sent such a communication. The closing of the market is one example of a trigger that can be used to issue the communication being sent to each of the selected potential respondents that originally received a market offer communication to inform such potential respondents that the particular market is closed. Other triggers are possible as well. The system 210, 310, 400 also includes logic for privately communicating to the identified respondent user an execution communication for informing the identified respondent user that the identified respondent's counter-offer has been accepted and that the respondent user has a transaction with the originator for that particular market. The parties to the transaction must then fulfill the obligations of the commodity resource transaction which has been consummated, such as payment, delivery, etc. Only the identified respondent of the selected potential respondents and any corresponding employees within the respective organizations of the executing counterparties who have been identified via the customer administrator will receive the execution communication. A customer administrator can also generate reports and export data files for transaction executions, and other recent and historical transactions which have been consummated.

Referring to blocks 470 and 472, as indicated above, the system 210, 310, 400 has logic performing account maintenance functions, such as at least user account creation and modification. As such, the system includes logic for communicating to an administrator user at a remote/client computer a plurality of user account information request prompts through an administrator interface screen, for establishing or modifying a user account. As mentioned herein, the prompts requesting the administrator to provide information to set up a user account can include input fields for entering an account name, a username, a login ID, a company name, an address, a phone number, an email address, a user type, such as read only, read-write or customer administrator, commodity types allowed for each type of user (such as natural gas), authorized trade types, as defined herein above, authorized counter-parties (a listing of counter-parties that will be unique to each user/company using the system 210, 310, 400 based on their existing trading contracts and other criteria they utilize to determine willingness to transact with other institutions), restrictions based on region/market point for physical delivery, financial limits per transaction, volume limits (maximum) per transaction, deal tenor, and/or physical locations allowed to trade, as defined herein above. A system administrator can also be provided with prompts to enter information which will apply to the user's company profile, such as commodity or regions where the organization is active, authorized counter-parties, as defined herein, and/or authorized list of trading entities, as defined herein above. In one embodiment, as mentioned above, limits can be placed on a user account on the trade types allowed for such user. These trade types can include many variables. For example, in one embodiment, physical trade type limits can be placed on a user account, such as allowing or preventing collar, call option, put option, fixed forward, basis, trigger, and/or index forward types. Financial trade type limits can also be placed on a user account, such as allowing or preventing put options, call options, collar, basis swap, and/or swing swap types. The system 210, 310, 400 have logic for providing prompts through at least an administrator interface for selecting and/or inputting this information for each user account. The system 210, 310, 400 also has logic for receiving the above and other user account and system information for establishing accounts and for establishing limits on how transaction processing proceeds. Specifically, the system 210, 310, 400 includes logic for the server to receive all of the above administrator's responses to the prompts provided to the administrator requesting information, and to store all such information in the central database for use in transaction processing and for other purposes by the system 210, 310, 400.

Referring to FIG. 4B and blocks 416 and 418, as mentioned above, the system 210, 310, 400 further has logic for logic in the database for compiling summary information about user actions which have been stored in the central database, and logic for communicating the summary information to a user at a remote/client computer. The summary information can include details of each consummated transaction for each user, details of each market offer and/or counter-offer sent and/or received by a user, total transactions in a time period, total volume (in a measurement of the respective commodity) sold and/or bought over a time period, total price paid and or received over a time period, a break down of volume sold/purchased and/or dollars paid/received based on delivery route or some other criteria. Various other summaries and/or breakdowns of information come to mind based on the various criteria needed to establish any market and transaction for a private commodity transaction according to the present description.

In another embodiment, the system 210, 310, 400 can include logic and interface screens to provide for the following system functionality. Through one or more administrator interface screens, an administrator can set up their own customer/user accounts, and run reports on user activity, on message tracking (for at least market offer and respondent response communications, and on trade execution logging). Through one or more of these administrator interface screens, an administrator can also set up user accounts, including setting the following for each type of user: authorized markets, authorized trade types, authorized counter parties, financial limits (per transaction, etc.), volume limits (per transaction), tenor limits to trade—1 to X months out (time frame can vary), and/or physical locations allowed to trade. Counterparty setup—add/delete/modify authorized counterparties, authorized list of trading entities, and/or trading limits (see list above). The administrator can also be provided with interface screen prompts for confirming setup, managing email lists for automatic confirmation notification and other communications described above, as well as for viewing audit log access.

In further embodiment, the system 210, 310, 400 can include logic and interface screens to provide for the following system functionality. Through one or more user interface screens, a user can be provided with seven main interface screens or windows for messaging and other functionality, described above: (1) inbound messages or communications, such as for market offers, acceptance messages, response messages, forwarded (internal) messages, and/or counter-offer messages, (2) active messages originated by the user (messages that have not yet expired or been executed/killed, (3) draft messages that have been either fully or partially created but not yet sent to any identified counterparties, (4) sent messages or communications, such as for market offers, acceptance messages, response messages, forwarded (internal) messages, and/or counter-offer messages, (5) completed transaction messages or communications, for consummated transactions, (6) broken messages resulting from the mutual agreement from both executing counterparties on a previously executed transaction, and (7) archived messages that have been removed from one of the other folders as defined herein above. Users can be alerted through interface screen alarms and external alerts (for example email) when new messages arrive. Through one or more user interface screens, a user and/or the system can also be provided with the ability to create new request for price (RFP) or trade screen, save and recall partially completed screens such as in the process of making a market (drafts), copy offers which are similar to prior creation of market offers, view completed offers/counter-offers, view executed trade or transaction messages, group, filter, and/or sort messages within each window or interface screen, create a timer as a part of a message for offers and counter-offers (originator sets time, time is tracked on all instances of the message, and time can expire). Through one or more user interface screens, a user can also be provided with the ability to view comprehensive logging of system messages and transactions.

Referring additionally to the remaining Figures, in one preferred embodiment the system 210, 310, 400 can include a messaging system designed to facilitate the negotiation and execution of bi-lateral commodity transactions in the context of a private marketplace. In order to express a need to counterparty recipients, a deal originator opens a private market and decides whom to “invite” to that market and how long that market will be available to the invited counterparties. When the deal is completed (i.e. when it is executed, expired, or killed), that private market is closed. When opening a private market, the system 210, 310, 400 can provide a series of flexible interface screens that help a user to (1) identify their need (buy or sell, physical or financial, delivery location, volume, price, etc.), (2) determine which counterparties to present the offer to, and (3) set an expiration date and time for the, offer which lets the user's or originator's counterparties know how long they have to respond to and execute the transaction. For all transactions within this preferred embodiment of the system 210, 310, 400, the originating user determines which counterparties to present their transaction to (i.e. which counterparties to “invite” to their private market). In one embodiment, each counterparty recipient is informed of who originated the transaction, but is not informed of the identity of the other counterparties, if any were invited to the market. The system 210, 310, 400 can also support a confidential (one-to-one) negotiating process, so that only the two counterparties communicating directly have access to their messages, responses, and executions.

To further enhance the confidential nature of this preferred embodiment of the system 210, 310, 400, when a transaction message is no longer available (i.e. once it is executed, expired, or killed), the message is immediately inactivated and can no longer be accessed by non-executing counterparties. In this way, these counterparties have no means within the system to identify the reason why a transaction is no longer available (i.e. whether it was executed, expired, or killed). Only the executing and/or originating parties to the transaction have access to those details, as appropriate based on the final transaction status described above. The system 210, 310, 400 is also designed to send external email notifications to all designated users whenever a new transaction message is received in their message inbox, as will be better understood with reference to the below description. Users do not need to be continuously logged into the system in order to effectively use the platform. These email notifications inform recipients of who the originating counterparty is and when the message is set to expire. The email messages also provide a web link to the login screen of the system so that users can quickly access their message inbox. In addition to the notifications described above, automated execution confirmations are sent (via external email) to both executing counterparties whenever a transaction is executed within the system 210, 310, 400. The system administrator (for each user's organization/company/entity) can also configure the system 210, 310, 400 to send these confirmations to any number of additional valid email addresses, whether those individuals are system users or not, as will further described below. The system 210, 310, 400 also provides an audit trail for executing counterparties, including the original transaction message, any intervening negotiations, any notes, comments, or special terms, as well as the terms on which the execution of the transaction was completed. This audit information can be extracted from the system 210, 310, 400 and uploaded into other systems, also as will be described a greater detail below.

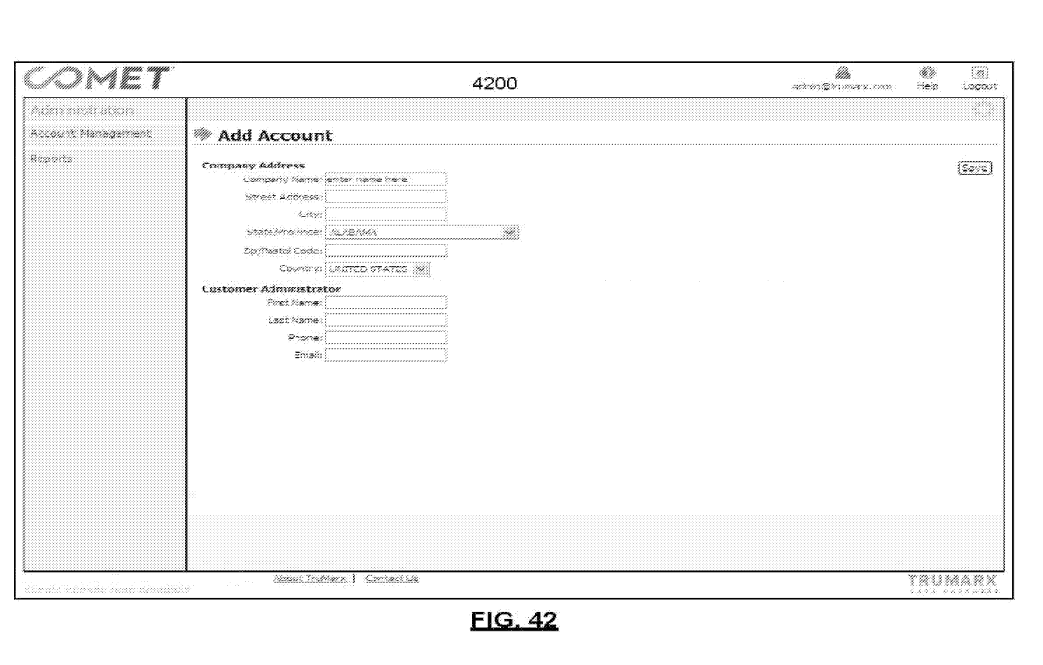

In one preferred embodiment of the present invention, the system 100, 200 is configured as an application service provider (ASP), hosted by a host entity, such as the assignee of the present invention, as shown in FIG. 2 with the central computer 210 and central database 216, as well as commodity resource private trading market facilitator software application 310 and operating system 312 generally functioning as the ASP system. In order to access the system, the host entity can provide a web link for the software application 310 to the user for use in accessing the system through a client device. The facilitator application 310 can be structured as separate applications, each performing separate, yet integrated, functions. Specifically, the system 210, 310, 400 can be structured to include at least 1) a transaction client application for performing at least the functions shown and described in relation to FIGS. 5 to 23, 2) a customer administration application for performing at least the functions shown and described in relation to FIGS. 24 to 40, and 3) a host administration application for performing at least the functions shown and described in relation to FIGS. 41 to 43. Conceptually, access to these separate applications within the preferred embodiment of the system 210, 310, 400 described below is structured based on how user entitlements are assigned. In general, the transaction client application is used to create transaction messages and consummate deals. The customer administration application, which is also customer-facing, is used by customers or “users” of the system to manage their company or entity profile, to create and manage individual user accounts, which are then subsequently used to log into the transaction client application. The customer administration application allows such company or entity users, as part of account management functionality, to set entitlements that include access level, restrictions, if any, in terms of counterparties who they can transact with, the commodities and regions that they can transact in and then specifically transactional level restrictions in terms of total volume, total price, or the term of the deal itself, as will be described in greater detail below. Also, within the customer administration application are some other functional tools that allow entity users to log reports, including generating export files of transactional data, as well as being able to have some visibility into messages within the system, for the account of the users that the entity user created, which provides the entity user the ability to view and potentially manipulate transaction messages of such users, in a defined manner. The host administration application is an internal tool for the host entity, to create and manage customer entity accounts at a business level.

### Transaction Client Application

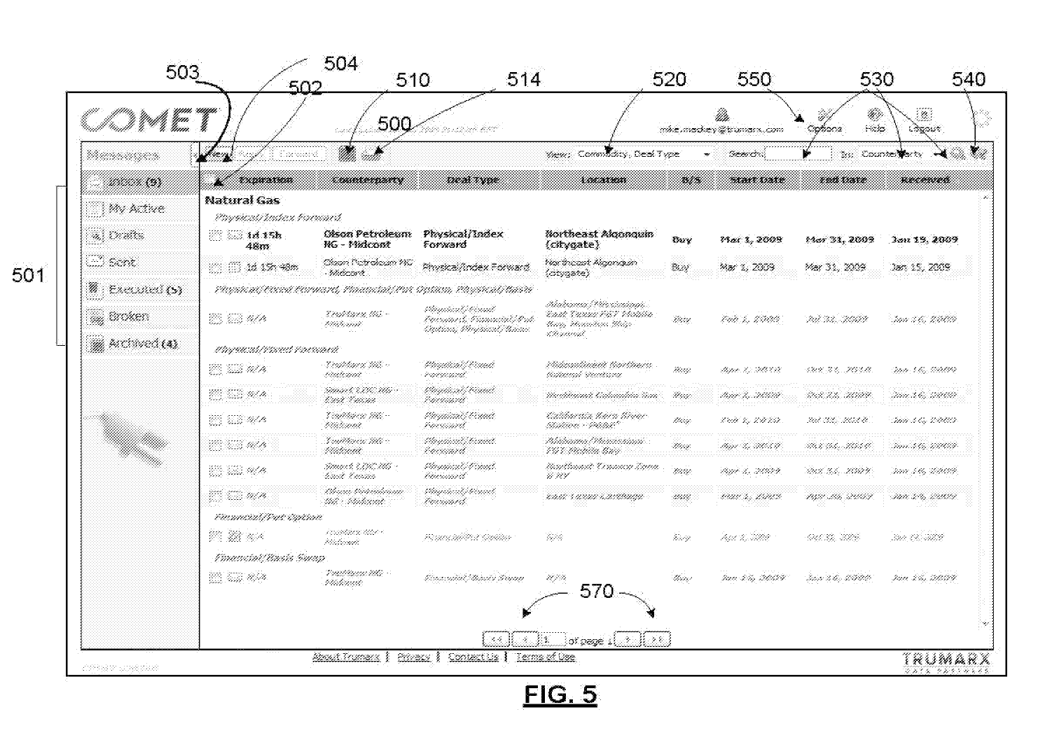

Referring first to the functions provided through the transaction client application, a login screen (not shown) is provided to allow a user to log into the system. Login input fields are transmitted to user interface (client computer or device) by the transaction client application for entering a username and password. The user then enters their username and password which are received by the transaction client application and verified against usernames and passwords stored in the central database 216 for system users. If the verification is successful, the transaction client application transmits a main messages/inbox interface screen 500, shown in FIG. 5, to the client device. On the left side of interface screen 500 a set of viewing selectors 501 are provided to select by a user. If selected, the transaction client application transmits the following information to the client device for viewing and other actions, for each of the respective viewing selectors 501:

| | |
|---|---|
| Inbox | Transaction messages that have been sent to the user. |
| My Active | All transaction messages that that are originated by the |
| | user and that have not yet expired. |
| Drafts | Transaction messages that have been created and saved |
| | as drafts but have not yet sent to other users. |
| Sent | Transaction messages have been sent to other users. |
| Executed | All executed transactions. |
| Broken | Any previously executed transactions which have |
| | been broken by mutual consent of the two |
| | executing counterparties. |
| Archived | All archived transaction messages. |

FIG. 5 and many of the other figures related to each of the above viewing selectors 501 and respective interface screens, depict viewing headers as set forth in the following table along with a definition of the information listed under each such viewing header provides. These viewing headers assist in presenting the information associated with each deal/transaction and within each message.

| | |
|---|---|
| Expiration | The amount of time (in days, hours, and minutes) remaining |
| | until the message expires. |
| Counterparty | The identified counterparty for the transaction. |
| Deal Type | The type of deal the transaction message represents. |
| Location | The delivery location of the transaction if it is a physical |
| | deal. This column will be blank for financial transactions. |
| B/S | Whether the transaction is a buy or a sell (B = buy, |
| | S = sell), from the message originator's point of view. |
| Start Date | The start date of the transaction. |
| End Date | The end date of the transaction. |
| Received | The date this message was received. |

For each of the interface screens associated with each of the viewing selectors 501, a select all selector 502 can be provided to allow a user to quickly select all messages in such interface screens, as shown within the inbox depicted in FIG. 5, by selecting the select all selector 502 to the left of the “Expiration” viewing or “column” heading. In addition, each of listing of messages within each of these interface screens can be sorted by selecting any of the viewing or column headers. The transaction client application can also transmit status icons within the interface screens to the client device, which are shown to the left of each message, to allow a user to quickly identify the status or other relevant information about each message. Examples of such icons can include: unread (picture of envelope), read (picture of page), includes attachment (picture of paper clip on envelope), replied to (picture of page with blue arrow pointing to the left), and break request (picture of an envelope or page with a red circle containing a white line through it). Further, the left navigation pane can be expanded or contracted to adjust the viewable space for the selected message folder by selecting a an expand/contract selector 503, shown as a blue arrow button within FIG. 5.

The transaction client application can be structured to allow each message to be selected using the right mouse button by performing a “right click” action. This right click action will cause the transaction client application transmit to display a context menu (not shown) on the client device, with the following options: view the message; reply to the message; forward the message; execute the message; archive the message; print the message; mark the message as read; mark the message as unread, and initiate a break executed transaction message. These and related actions and functions are described in greater detail below. The availability of each of these context menu options is based on the state of the individual message.

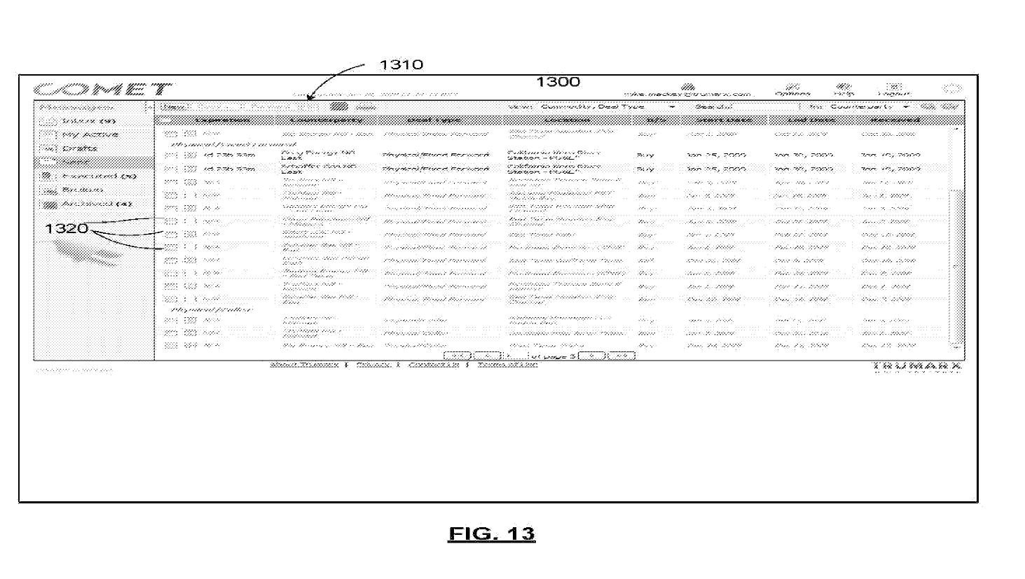

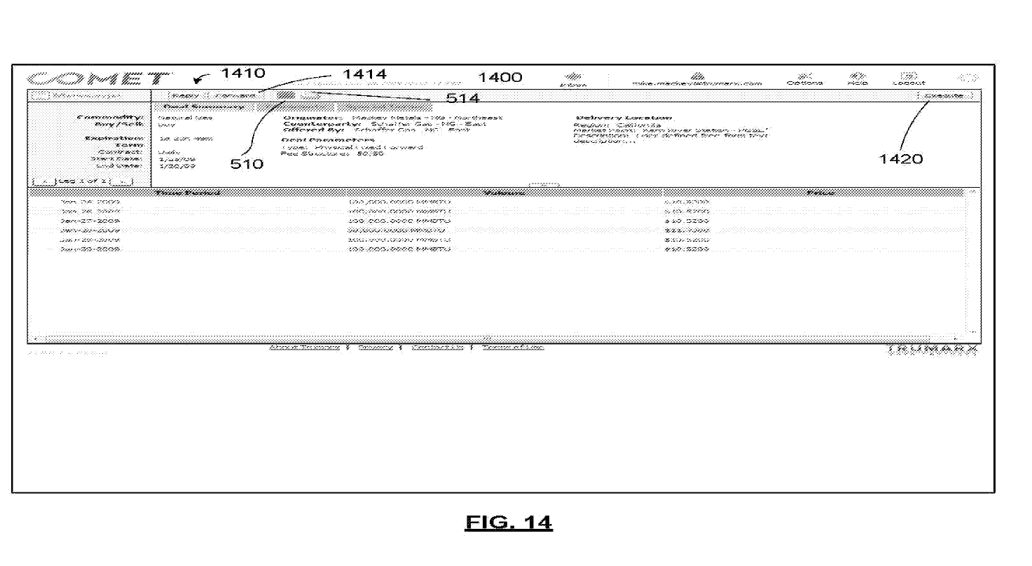

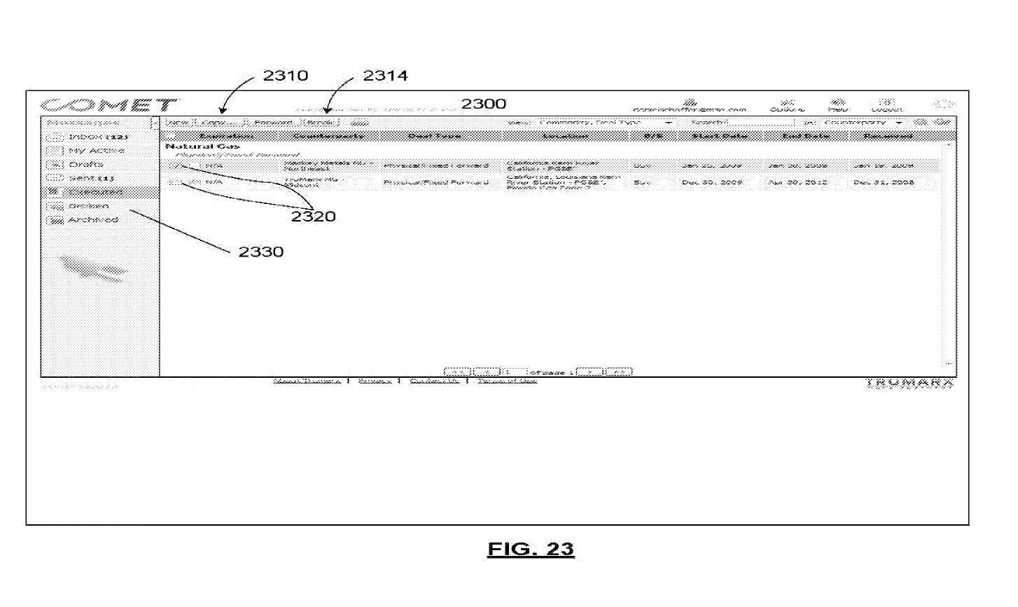

The transaction client application can also be structured to allow a user to 1) create a new message by selecting a new message selector 504, 2) copy an existing message to a new message by selecting a copy message selector 2310 (shown in at least FIG. 23); 3) reply to a message by selecting a reply to message selector 1410 (shown in at least FIG. 14); 4) forward a message by selecting a forward message selector 1414 (shown in at least FIG. 14); 5) kill a message by selecting a kill message selector 1310 (shown in at least FIG. 13); 6) break a previously executed message by selecting a break message selector 2314 (shown in at least FIG. 23); 7) archive a message by selecting an archive message selector 510 (shown in at least FIG. 5); and 8) print a message by selecting a print message selector 514 (shown in at least FIG. 5).

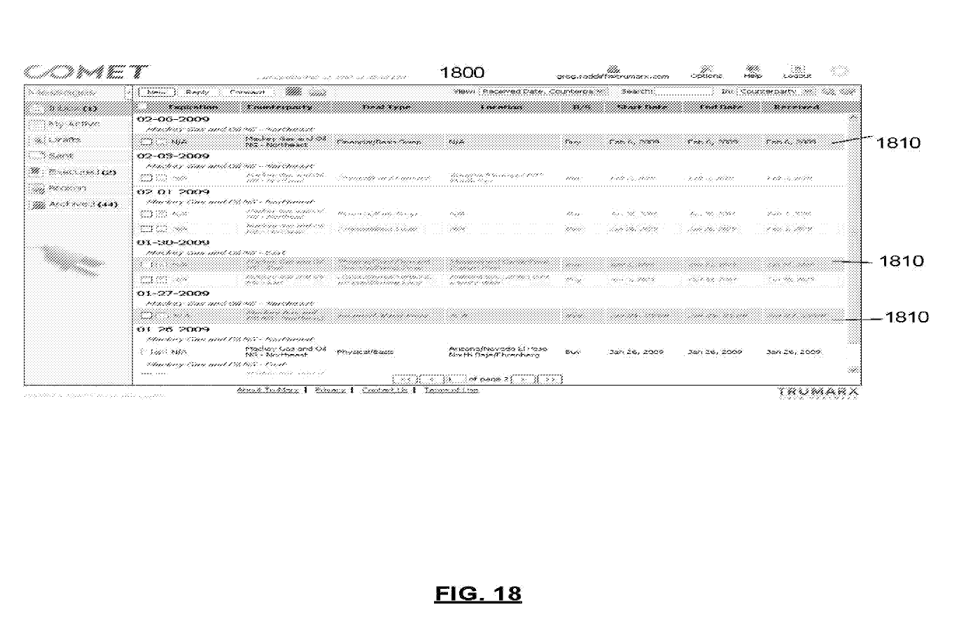

Selecting the copy a message selector 2310 allows the user and system to reuse transaction messages for deal types that the user frequently works with. This action retains common information, including at least price, index, volume, delivery location, etc., but does not copy unique values, such as counterparties and expiration. Such unique values must be entered from in the new message. Selecting the reply to a message selector 2310 allows the user and system to generate a direct reply to the originating counterparty that sent you a transaction message. Selecting the forward message selector 1414 allows the user and the system to forward messages internally to other system users within the user's organization/entity. An internal message can be segregated from other messages, such as highlighting internal messages in a color such as green within a user's inbox, as shown in FIG. 18. Internal notes can also be appended to a message when forwarding a message, as will be further described below. The internal notes and messages will remain as part of an audit trail of a deal/transaction, but will not be transmitted to counterparties. In one embodiment, messages cannot be forwarded to any external organization or counterparty. Selecting the kill message selector 1310 allows the user and system to kill any active or live messages that the particular user has originated. The transaction client application shows killed messages “stricken-through” (inactivated), and removes such messages from being accessible to counterparties (counterparty users). In one embodiment, the kill message selector 1310 is only available for selection from the My Active and Sent messages interface screens.

Selecting the break message selector 2314 allows the user and system to break (or attempt to break) an already executed message. In one embodiment, the break message selector 2314 is only available from the Executed messages interface screen. Selecting the archive message selector 510 allows the user and system to archive one or more messages. In one embodiment the transaction client application and system does not allow messages to be deleted, with the exception of draft messages. However, expired or unwanted messages can be moved from folder views using the archive message selector 510: This action allows the user to “clean up” the interface screens by moving messages into the Archived folder, and also allows for historical retrieval when necessary. Archived messages only appear in the Archived messages interface screen, where they are retained for audit purposes. Additionally, previously archived messages can be unarchived via the message context menu. In this case, the message is restored to the original folder or folders where it resided before being archived based on the current state of the message.

The transaction client application can also be configured to allow a user to group lists of messages through a grouping selector 520. Some examples of groupings which the system provides includes: No Grouping: Commodity, Deal Type; Commodity, Location; Transaction Type, Commodity; Deal Type, Location; Counterparty, Commodity; Commodity, Counterparty; and Received Date, Counterparty. This functionality allows a user to group and organize messages within a particular folder/interface screen view. One example of the grouping selector 520 is the View pulldown menu shown in FIG. 5 is as follows:

The transaction client application can also be structured to allow a user to search for specific message text using a search message selector 530. Selecting the search message selector 530 allows the user and system to perform a text match search of all messages within a folder/interface screen view. In one example, this can be done by selecting a value listed in the “In:” drop-down list, selecting the appropriate value from the “In:” list, entering the text string the user wants to match in the “Search:” box, and selecting the Search button (shown as a magnifying glass, as shown in FIG. 5. The messages which match the criteria are then shown then listed within the interface screen (not shown). The user can clear the parameters of searching as well as the search results, and reset the interface screen by selecting a clear search selector 540 (shown as a magnifying glass with a minus sign in FIG. 5).

The transaction client application can further be configured to provide a user options selector 550, which when selected, allows the user to manage personal information (password information, password recovery details, and local time zone) as well as transaction message distribution lists. The transaction client application can further be configured to provide help functionality, a log out selector 560 to log out of the system, as well as navigation selectors 570 to navigate through multiple pages in the message interface screens.

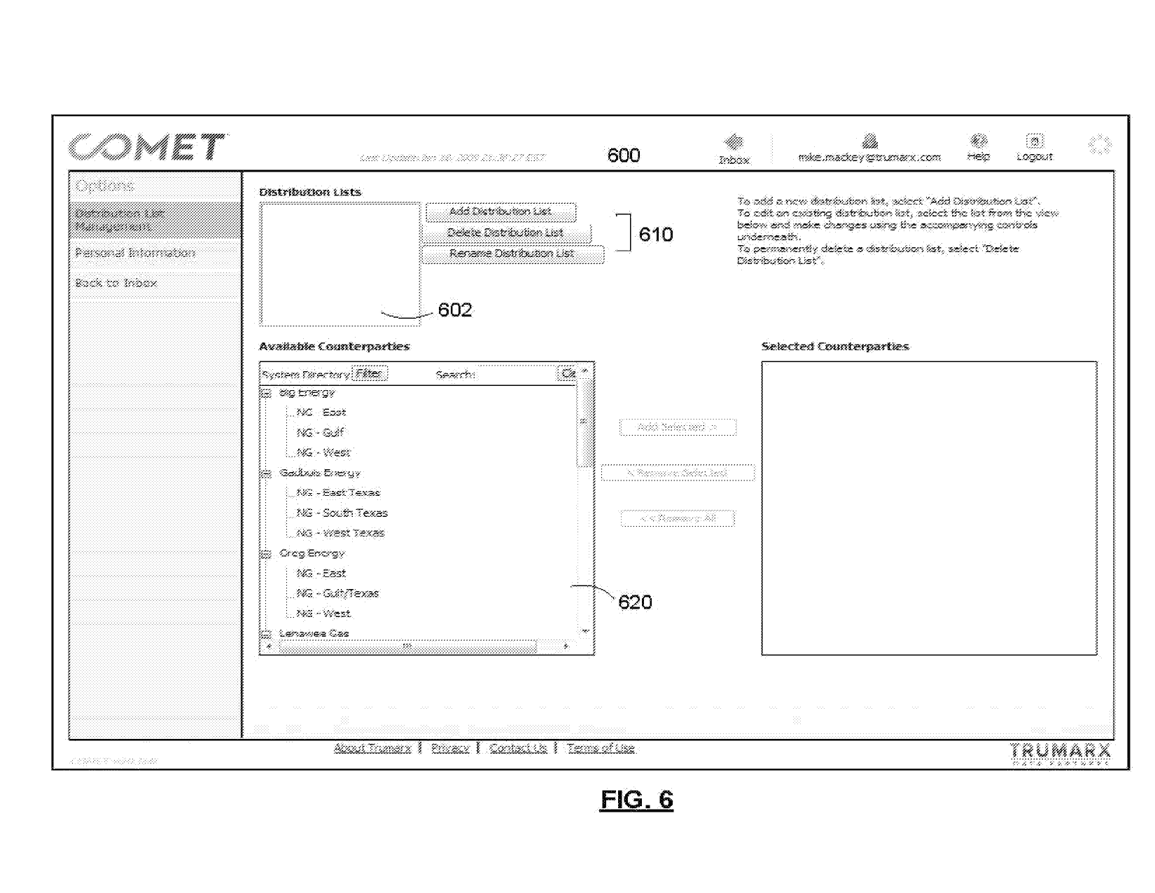

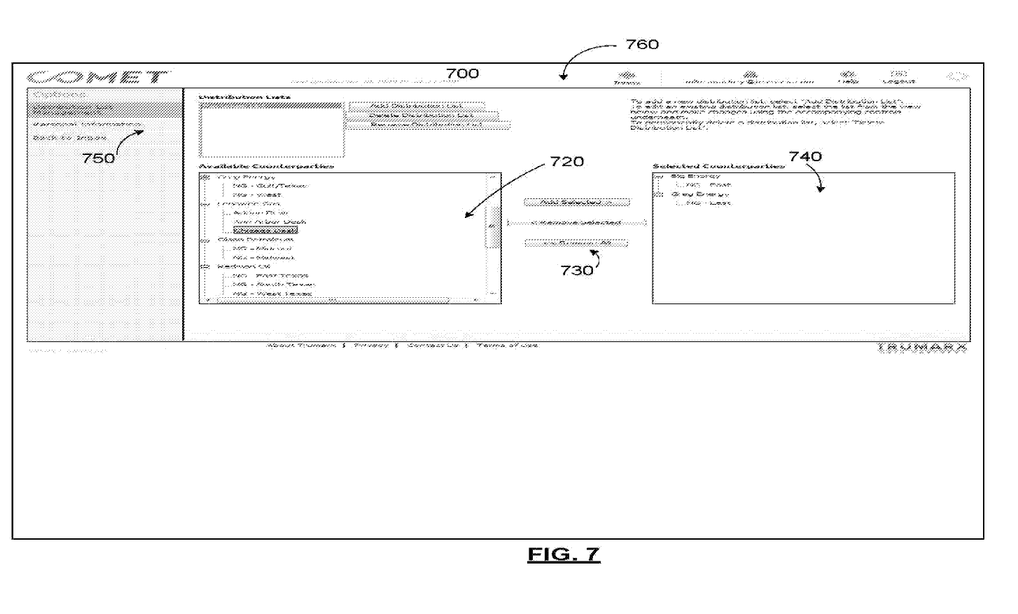

As mentioned, the transaction client application can be configured to transmit the user options selector 550 to the client device within one or more interface screens, such as the interface screen shown in FIG. 5. Once selected, the transaction client application transmits a distribution list management interface screen 600, 700 shown in FIGS. 6 and 7, to the client device. These interface screens 600, 700 can be used by a user to manage transaction message distribution lists. Options available from this interface screen also allow a user to manage the user's password and the local time zone. On the right side of distribution lists window 602 shown in FIG. 6 is a set of distribution list selectors 610. The distribution list selectors 610 and respective system functions initiated by each are as follows:

| | |
|---|---|
| Add Distribution List | Adding a new distribution list. |
| Delete Distribution List | Deleting an existing distribution list. |
| Rename Distribution List | Rename an existing distribution list. |

When the Add Distribution List distribution list selector 610 is selected by a user, the transaction client application transmits an Add Distribution List pop-up window to the client device, for example, as follows.

The user can then enter a “List Name” and select OK to cause the transaction client application store and transmit the new distribution list to the client device for displaying in the distribution lists window 602, as shown in FIG. 7.

Interface screens 600, 700 can also be used by a user to manage counterparties that comprise a user's distribution list. On the right side of an available counterparties window 620, 720 shown in FIGS. 6 and 7, is a set of counterparty selectors 730. The counterparty selectors 730 and respective system functions initiated by each are as follows:

| | |
|---|---|
| Add | Adding selected counterparties from the “Available |
| Selected | Counterparties” window 720 to the “Selected Counterparties” |
| | window 740. |
| Remove | Removing selected counterparties from the “Selected |
| Selected | Counterparties window 740 to the “Available Counterparties” |
| | window 720. |
| Remove | Removing all counterparties from the “Selected Counterparties” |
| All | window 740 to the “Available Counterparties” window 720. |

As mentioned, this interface screen 600, 700 can be also used to manage the user's password and the local time zone. To change a user's password, a Personal Information selector 750, shown in FIG. 7 is provided for a user to select. The user can then enter the appropriate passwords in “Old Password,” “New Password,” and “Confirm New Password” fields (not shown), and then confirm the entered information to save this information to the central database 216. The transaction client application can also provide a user the ability to recover a password if a user cannot remember their password at login. The Personal Information selector 750 will also present the user with the ability to enter a password recovery question and answer, such as by selecting the desired question from a “Password Recovery Question” drop-down list (not shown), entering the appropriate answer in a “Password Recovery Answer” field (not shown), and confirm and save these selections to the central database 216. The Personal Information selector 750 will also present the user with the ability to set the local time zone, such as by selecting an appropriate value from a “Timezone” field (not shown) and confirming and saving the selection to the central database 216. When the user has completed their desired tasks, a user can select a Back to Inbox selector 760 which will cause the transaction client application to transmit to the client device and display thereon the InBox, for example, as shown in FIG. 5.

### Creating a New Transaction Message

The transaction client application can be further structured to allow a user to create a new transaction message. Selecting the new message selector 504 from one of the main messages interface screens, such as the main messages/inbox interface screen 500 shown in FIG. 5, allows a user to create a new transaction message. When the new message selector 504 is selected, the transaction client application will transmit a new message popup screen to the client device for display. The new message popup screen (shown below) allows the user to select one of the three following selectors. First, an Executable selector (shown below) can be selected, which indicates that the transaction is capable of being executed by one of the user's counterparties based on the terms the user defines within the message. This type of transaction requires the originator to provide both volume and price information for the deal. Second, an Indicative selector (shown below) can be selected, which indicates that the transaction is not executable but is rather a request only for volume or price information. A recipient of an indicative transaction message may respond with an executable message by adding price and other terms. Third, an RFP selector can be selected, which indicates a request for proposal message that is not executable and typically has a longer duration for response. Like an indicative transaction, an RFP does not require volume or price information. The following shows one example of the new message popup screen, with the Executable selector selected:

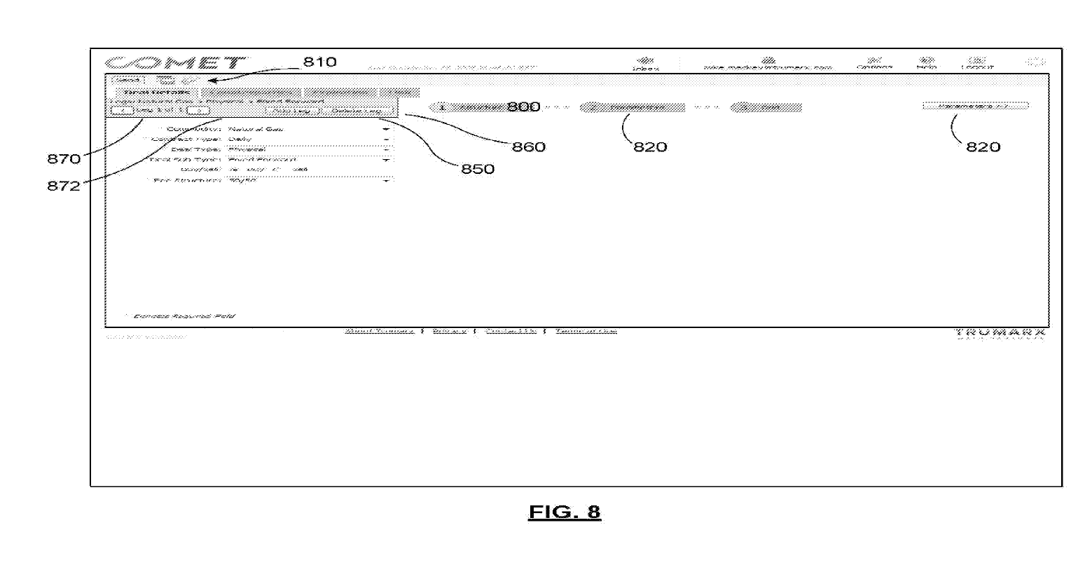

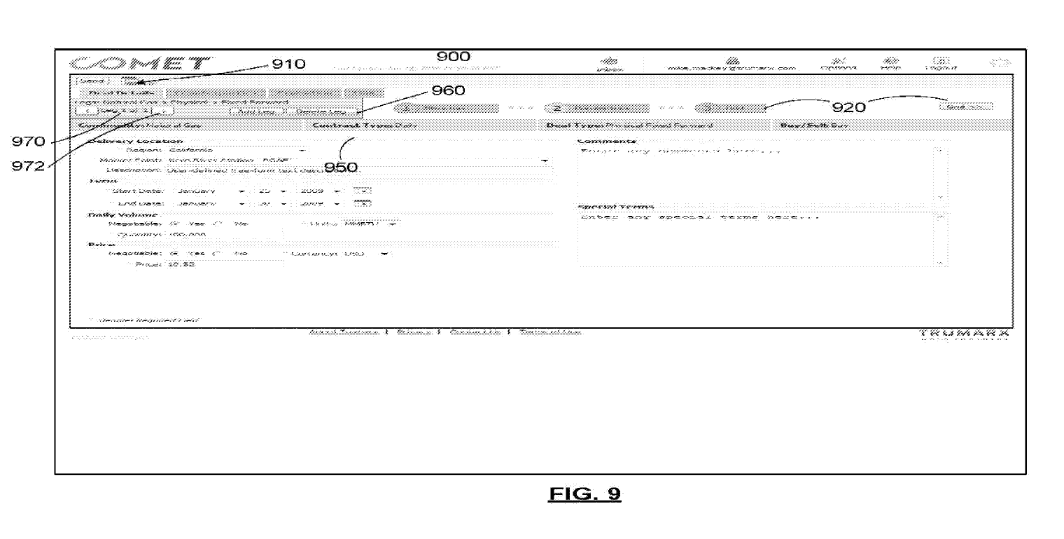

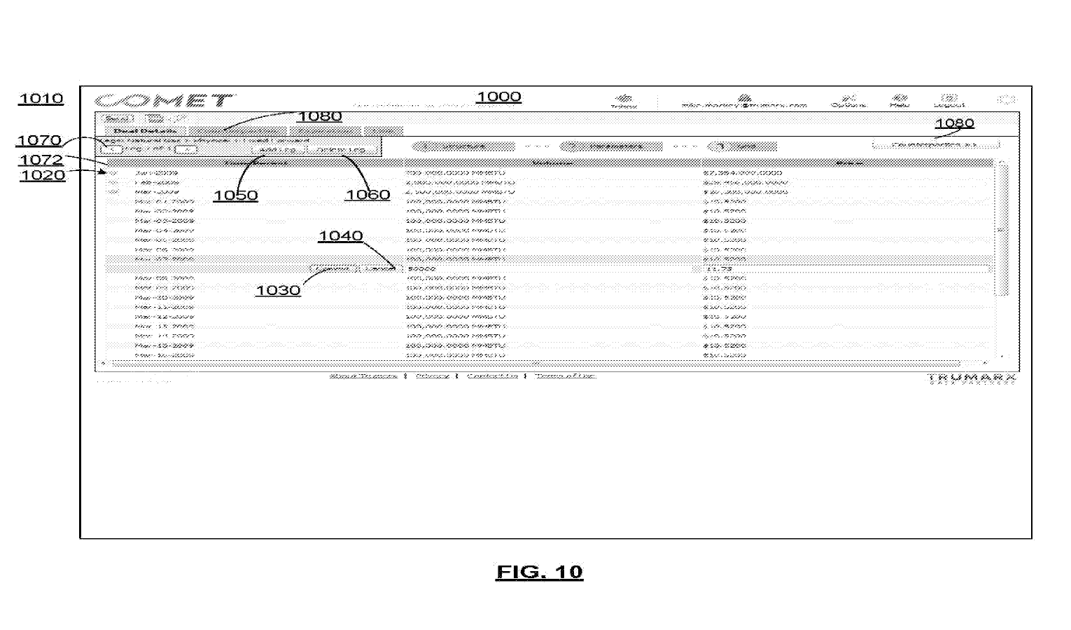

Once the user selects the transaction type using one of these selectors, the transaction client application can be further structured to allow details of a deal/transaction. When the transaction type is selected, the transaction client application will transmit a deal detail/structure interface screen 800, shown in FIG. 8, to the client device for display. The deal detail interface screens, also shown in FIGS. 9 and 10, as will be describe below, allows the user to the enter the details of the new transaction message. Specifically, in one embodiment, the deal detail interface screens include a deal detail/structure interface screen 800, a deal detail/parameters interface screen 900, and a deal detail/grid interface screen 1000, which generally allow the user to perform the following functions. The deal detail/structure interface screen 800 shown in FIG. 8 allows a user to select and enter the overall structure of the deal (whether it is daily or monthly, physical or financial, a buy or a sell, etc.). The deal detail/parameters interface screen 900 shown in FIG. 9 allows a user to select and enter the specific parameters of the deal (term, volume, price, etc.). The deal detail/grid interface screen 1000 shown in FIG. 10 displays a default price grid which the transaction client application establishes from the specific parameters entered, and also allows the user to select and modify specific parameters to shape the individual deal periods.

The selection fields within the deal detail/structure interface screen 800, shown in FIG. 8, are defined in the Appendix, attached to the present specification. The required selection fields are marked with an asterisk (*) in FIGS. 8 and 9. The selection fields displayed to the client device by the transaction client application, for each of the new transaction interface screens, will change based on the specific combinations of values that are selected in the “Deal Type” and “Deal Sub-Type” drop-down lists (for example Physical and Fixed Forward, as shown in FIG. 8). Different combinations will result in different fields being presented within the interface screens of FIGS. 8, 9, and 10. The Appendix provides the field definitions related to each of the possible combinations, including the following: Financial/Basis Swap; Financial/Call Option; Financial/Collar; Financial/Put Option; Financial/Swing Swap; Physical/Basis; Physical/Call Option; Physical/Collar; Physical/Fixed Forward; Physical/Index Forward; Physical/Put Option; and Physical/Trigger.

The transaction client application can be further structured to provide a draft selector 810, 910, 1010 to save the new transaction message as a draft within the database, in order to complete the details at a later time without sending the new transaction message. The draft message can be recalled from the database from a “Drafts” main menu interface screen, by selecting a Drafts viewing selector 501, shown in FIG. 5, for completion and sending. The transaction client application can also be structured to provide an attach external files selector, 820, 920, 1020 to attach external files to the new message being created, for sending along with the transaction message, once sent.

When a user selects one of the two parameters selectors 820 shown in FIG. 8, the transaction client application will transmit a deal detail/parameters interface screen 900, shown in FIG. 9, to the client device for display. Various selections can then be made by the user through this interface screen 900, including the selection fields defined in the Appendix at the end of this specification.

When a user selects one of the two grid selectors 920 shown in FIG. 9, the transaction client application will transmit a deal detail/grid interface screen 1000, shown in FIG. 10, to the client device for display. The transaction client application will automatically generate a default price grid for the deal based on the “Contract Type” (daily or monthly) and price and volume information the user entered within the previous interface screens 800, 900. If the user has selected to establish a daily contract, the grid within interface screen 1000 of FIG. 10 will display each day of the contract's term as an individual row. If the user has selected to establish a monthly contract, the grid within the interface screen 1000 of FIG. 10 displays monthly totals in individual rows, based on the daily price and volume numbers entered. The transaction client application can provide a daily view selector 1020, to allow the user to select to expand the view to see the values for each day within a month. As shown within the interface screen 1000 of FIG. 10, the grid can be amended by selecting any of the rows. The transaction client application/system highlights the selected row and allows the user to enter the appropriate values. The user can then select a commit selector 1030 to save any changes that the user has made to row, or select a cancel selector 1040 to cancel the user's changes. In one embodiment a user can only amend daily rows in the price grid, and monthly rows, which indicate monthly totals, cannot be amended.

### Multiple Legs for a Transaction Message

The transaction client application/system supports the concept of multiple legs or sub-offers within a single transaction message. Specifically, in one embodiment, the transaction client application is structured to allow a user to create up to six legs in a single transaction, and each individual leg includes all the unique information contained under the Deal Details interface screens (the structure, parameters, and grid interface screens 800, 900, 1000). By creating multi-leg transactions, a user can complete up to a maximum of six separate deals all under the umbrella of a single transaction message. Message legs provide a way for a user to indicate within the system multiple needs (i.e. buys or sells, varying delivery points, etc.) within a single transaction, and send them to the same group of counterparties with the same expiration timing. This functionality would, for example, allow a user to indicate a base load need in one leg and a swing or peaking supply in another. To manage multiple legs for transaction message, the transaction client application displays and can receive selections from an add leg selector 850, 950, 1050 and delete leg selector 860, 960, 1060 in the top left corner of each of the deal detail interface screens 800, 900, 1000. The transaction client application also displays and can receive selections from a previous leg selector 870, 970, 1070 and a next leg selector 872, 972, 1072 to allow a user to navigate between legs.

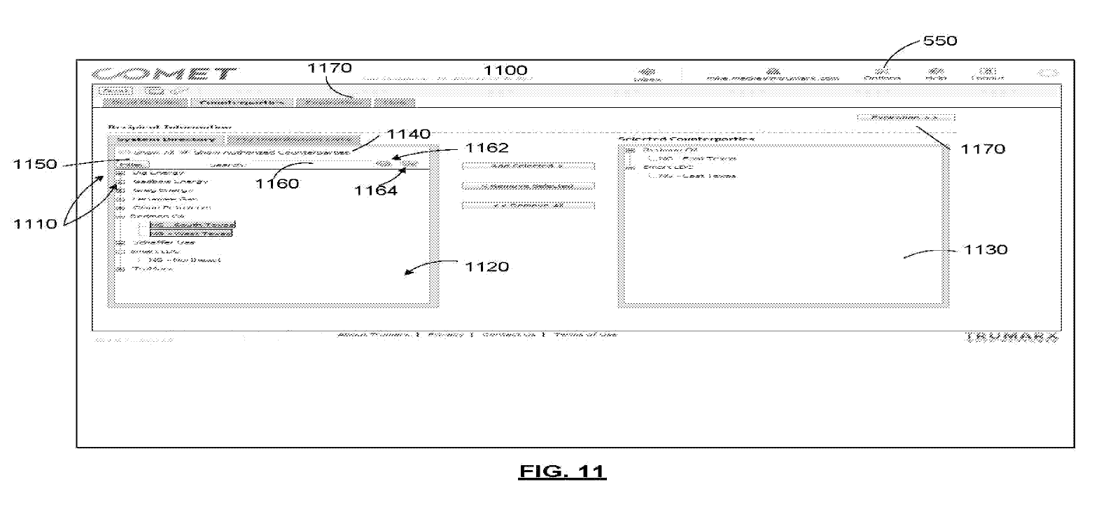

When a user selects one of the counterparties selectors 1080 shown in FIG. 10, the transaction client application will transmit a counterparties interface screen 1100, shown in FIG. 11, to the client device for display. The transaction client application transmits the individual counterparties to the client device for display, and in one embodiment the counterparties are organized by company name and then by trading entity, and are further displayed in two sections on the screen: available (i.e. unselected) counterparties in the “System Directory” window 1120 appearing on the left, and “Selected Counterparties” window 1130 appearing on the right. The transaction client application provides expansion selectors 1110 to the left of each company name to expand the contents and view that company's trading entities. Additionally, a user can select to view basic contact information (company address and main contact details) by selecting (i.e., “clicking on”) a company name from within the “System Directory” window 1120, shown in FIG. 11. The transaction client application provides counterparty selectors 1130 for adding, removing and removing all of the selected counterparties. After expanding a company name, the user can select one trading entity per organization and further select one or more of the counterparty selectors in the middle of the counterparties interface screen 1100 to perform the following actions.

| | |
|---|---|
| Add Selected | Adding the selected counterparties from the System |
| | Directory window 1120 section to the Selected |
| | Counterparties window 1130. |
| Remove Selected | Removing the selected counterparties from the |
| | Selected Counterparties window 1130 to the System |
| | Directory window 1120. |
| Remove All | Removing all counterparties from the Selected |
| | Counterparties window 1130 to the System Directory |
| | window 1120. |

When selecting the counterparties that user wishes to present the user's deal to, the user can also refine the list of available counterparties in three ways. The transaction client application provides a show authorized counterparties only selector 1140, a filter selector 1150 and a search selector 1160. The transaction client application will transmit and display only those counterparties that a user is authorized to transact with when the Show Authorized Counterparties selector 1140 is selected. As will be described below, the company's system administrator selects and enters which counterparties a user is authorized to transact with. That list may change and grow over time as additional companies join the overall system. The system default is to “Show All.” Thus, a user must use the Show Authorized Counterparties selector 1140, if the user wishes to see only those counterparties the user is authorized to transact with.

The transaction client application will transmit and display only those counterparties that match the filter selections the filter selector 1150 is selected and filter parameters are entered. To filter the list of available counterparties, the user can select the filter selector 1150 and a filter popup window (shown below) will be transmitted by the transaction client application to the client device for display. The user can then select one or more of the values described below. When finished, the user can click OK to apply the filter.

| | |
|---|---|
| Commodities | Filter the list of available counterparties by the type |
| | of commodity the counterparties transact in. |
| Region | Filter the list of available counterparties by the region in |
| | which the counterparties transact. |
| Hub | Filter the list of available counterparties by the market |
| | point in which the counterparties transact. |
| Buy/Sell | Filter the list of available counterparties by whether the |
| | counterparties only buy, only sell, or both. |

The third way in which the transaction client system allows a user to search for specific counterparties by company name through a search selector 1160 or field. The user can enter their search criteria in the search selector 1160 and press a start search selector 1162 (any combination of letters can be entered to search). To cancel the effects of a filter or search and return to the complete list of available counterparties, a user can select a clear selector 1164.

The transaction client application also provides a My Distribution Lists selector 1170 for displaying potential counterparties to a user to choose from. In one embodiment, the transaction client application transmits to the client device for display, the distribution lists in two sections on the screen: “Available Distribution Lists” appear on the left (not shown), and “Selected Distribution Lists” appear on the right (not shown). Distribution lists can be combined with individual selections from the “System Directory” when addressing messages. In order to use this feature, a user must first create one or more distribution lists. Distribution lists are managed via the options selector 550 shown in FIG. 11, as described herein. The user can select one or more distribution lists and select the following distribution list selectors (not shown) to perform the actions described in the following table.

| | |
|---|---|
| Add Selected | Adding the selected distribution lists from the |
| | “Available Distribution Lists” window (not shown) |
| | to the “Selected Distribution Lists” window |
| | (not shown). |
| Remove Selected | Removing the selected distribution lists from the |
| | “Selected Distribution Lists” window to the “Available |
| | Distribution Lists” window. |
| Remove All | Removing all distribution lists from the “Selected |
| | Distribution Lists” window to the “Available |
| | Distribution Lists” window. |

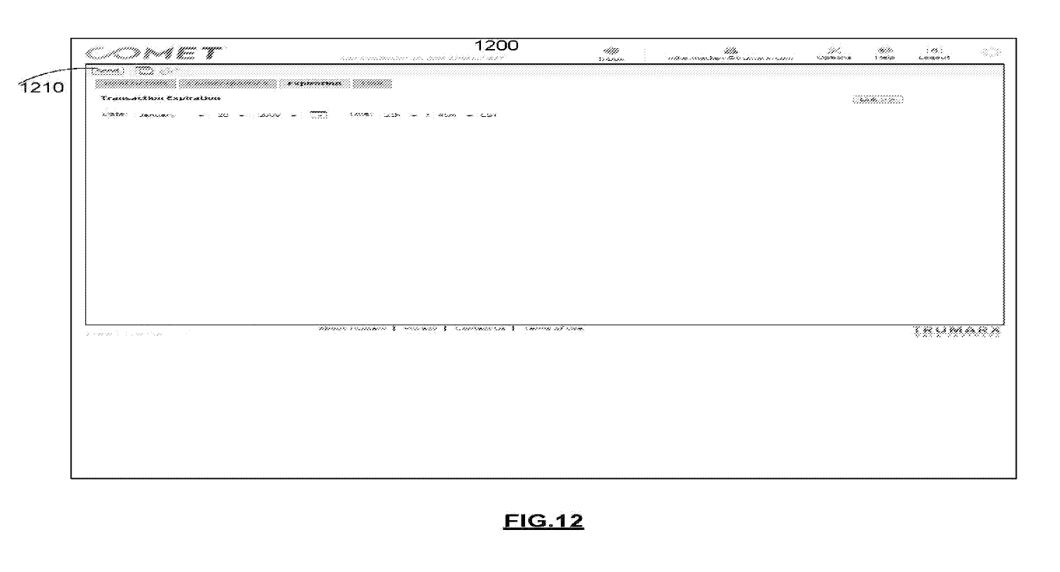

When a user selects one of the expiration selectors 1170 shown in FIG. 11, the transaction client application will transmit an expiration interface screen 1200, shown in FIG. 12, to the client device for display. The transaction client application transmits a date and time field to the client device for allowing a user to enter a date and time for the transaction message to expire. This expiration is meant to convey to a user's counterparties a time frame within which the user wants to receive responses and execute the transaction. In one embodiment, once a transaction message expires, the designated counterparties will no longer have access to the contents of the transaction message. In one embodiment, message expiration must be set at least ten minutes in the future.

When a user has completed all the appropriate interface screens, the transaction client application is configured to provide a Send selector 1210 for the user to select to send the transaction message. The transaction client application is configured to automatically transmit and display the main messages/inbox interface screen 500 to the client device, and also transmit an external email notification to any counterparties addressed in the message. The email notifies the counterparties that the user' company and associated trading entity has sent them an offer on the system and also provides them the expiration information for that offer, as well as URL which can be used to access the system. Prior to sending a transaction message, a user can review and/or amend the information entered on the previous interface screens by selecting the various described selectors used to navigate to such respective interface screens. To view a transaction message, a user can select the “Sent” view selector 501, which then shows the sent messages interface screen 1300 shown in FIG. 13.

### Viewing Received Transaction Messages

The transaction client application retrieves “received” transaction messages from the database and transmits the “received” transaction messages for that user to the user's Inbox interface screen 500, as shown in FIG. 5. Thus, whenever one of a user's counterparties sends the user a message they have originated, this will present the offer or counter offer to the user. Likewise, whenever a user's counterparties replies to a message that the user has sent them, this may present a counteroffer as well. In both cases, when a new message is received in the user's Inbox interface screen 500, the transaction client application/system will send the user an external email notification indicating that such user has received a new transaction message, including which counterparty sent the message and the time left until the message expires, as well as URL which can be used to access the system.

To view a transaction message received from one of a user's counterparties, a user can perform the following. From the Inbox message interface screen 500, the transaction client application is structured to allow a user to select any of the attributes of a message (i.e. the text values under each column heading) to view the message. As a user moves the cursor over any of the message attributes, the text is highlighted. In the example above, the cursor is held over the “Deal Type” value. As shown in FIG. 14, transaction client application transmits and displays the deal summary interface screen 1400 on the client device. The information displayed within this interface screen 1400 will vary based on the type of transaction message a user is viewing (i.e. the specific combination of values that were selected in the “Deal Type” and “Deal Sub-Type” drop-down lists when the message was created). Different types will result in different fields being presented. For a complete list of field definitions for all transaction message types, please refer to the Appendix at the end of this specification. The information displayed in the deal summary interface screen 1400 is read only and cannot be modified from this interface screen. In addition, in one embodiment, if the transaction message is a reply message, any changes that have been made to volume or price information by the user's counterparty will be highlighted in yellow in the grid, as shown in FIG. 14.

As will be described in greater detail below, the transaction client application is structured to allow a user to perform the following actions by clicking the buttons at the top of the screen: 1) reply to a message by selecting a reply to message selector 1410; 2) forward a message by selecting a forward message selector 1414; 3) archive a message by selecting an archive message selector 510; 4) print a message by selecting a print message selector 514; and 5) execute a message by selecting an execute transaction selector 1420, as shown in FIG. 14.

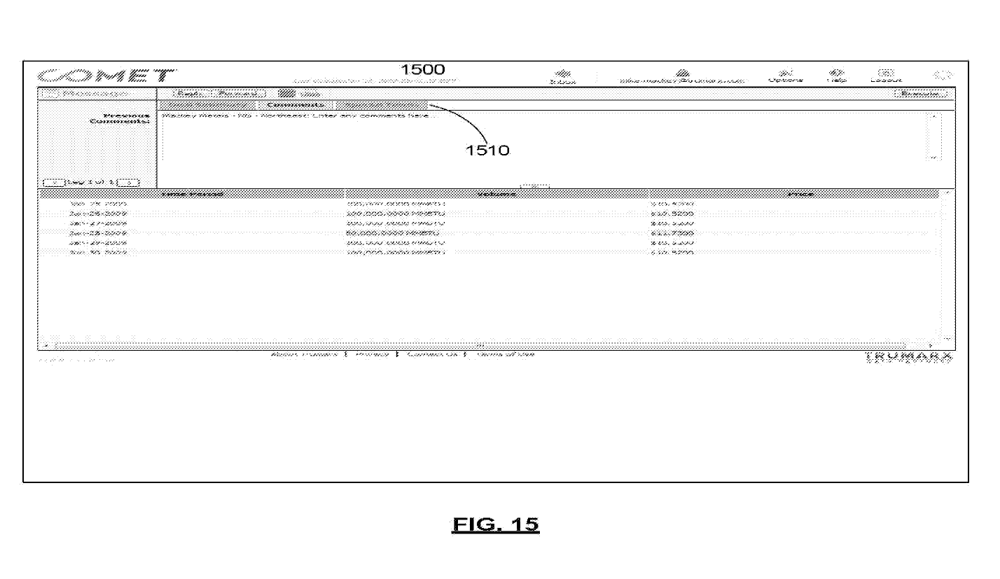

When a user selects a comments selector 1430 shown in FIG. 14, the transaction client application will transmit a view comments interface screen 1500, shown in FIG. 15, to the client device for display. The view comments interface screen 1500 will display any comments that the sender has appended to the transaction message. As shown in the view comments interface screen 1500 of FIG. 15, the comments are displayed historically in the “Previous Comments” section of the screen by the name of the counterparty that entered the comments.

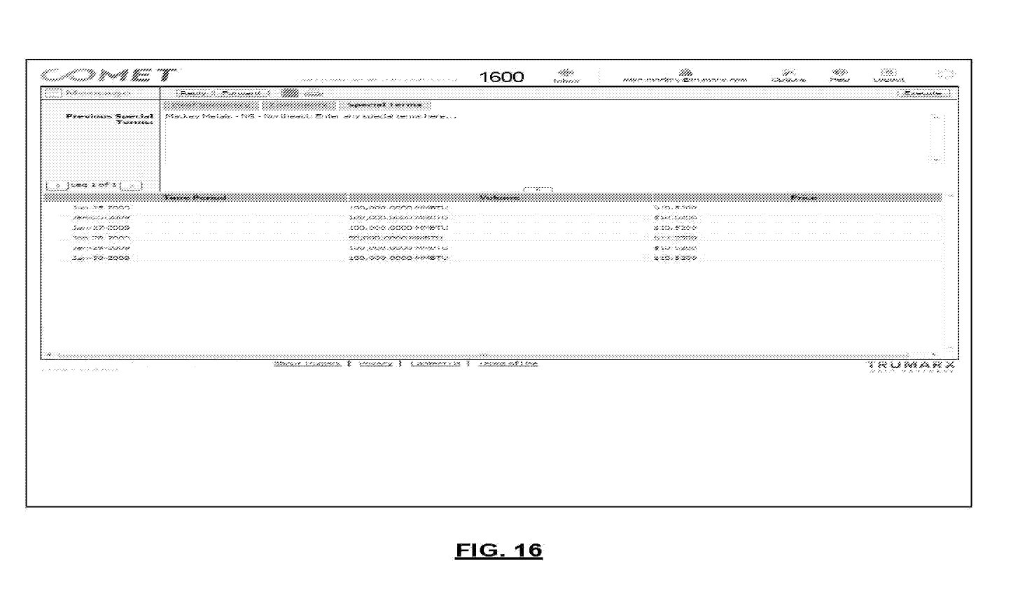

When a user selects a special terms selector 1510 shown in FIG. 15, the transaction client application will transmit a view special terms interface screen 1600, shown in FIG. 16, to the client device for display. The view special terms interface screen 1600 will display any special terms that the sender has appended to the transaction message. As shown in the view special terms interface screen 1600 of FIG. 16, the special terms are displayed historically in the “Previous Comments” section of the screen by the name of the counterparty that entered the special terms. Special terms differ from comments in that they are regarded as part of the terms of the transaction and are therefore included in the external email execution confirmation message that the transaction client application sends when a deal is executed.

### Forwarding a Message

The transaction client application/system allows users that work for the same company or trading entity to collaborate on transactions by forwarding messages to each other. To utilize this functionality, both users must have valid user profiles entered and stored within the transaction client application and central database. When forwarding a message, a user can append internal notes to a message in order to communicate information, such as describe the deal. The internal notes become part of the audit log of the transaction, and are stored within the database, but are never transmitted to a user's counterparties when the user responds to messages.

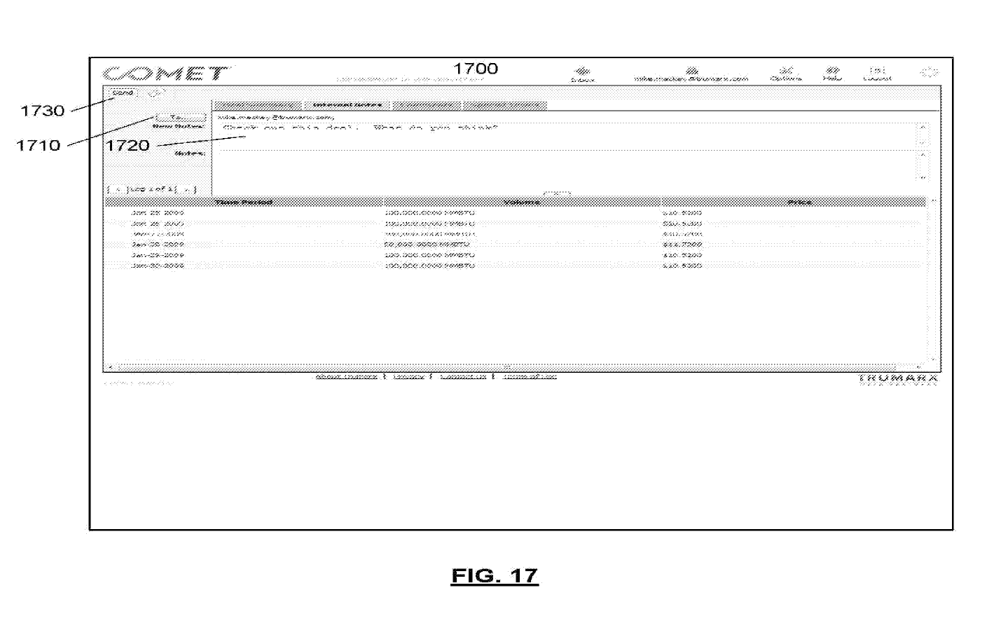

Thus, after opening a message in view mode, when a user selects a forward selector, such as the forward selector 1430 shown in FIG. 14, the transaction client application will transmit an internal notes/forwarding a message interface screen 1700, shown in FIG. 17, to the client device for display. The internal notes/forwarding a message comments interface screen 1700 will present a “To” selector 1710 for the user to select in order to enter one or more recipient email addresses to forward the message to. A forward message popup window is then transmitted to and displayed on the client device (not shown). A list of possible recipients is then shown, and the user can select the recipients they wish to forward the message to. The list of recipients displayed in this popup window only includes those users within the user's company that have access to the transaction client application/system. In one embodiment, messages cannot be forwarded to users outside of the user's organization. Thereafter, transaction client application then redisplays the internal notes/forwarding a message interface screen 1700 to the client device, and the recipients that the user selected now appear on an address line, as shown in FIG. 17. The transaction client application allows the user to enter any internal notes the user wish to include with the forwarded message in a “New Notes” field 1720. In one embodiment, all previous “Notes” are preceded by the name of the user who entered the notes as well as the date/time the notes were entered. As mentioned, any notes entered as part of a message forward are included in the message's internal audit trail, but are not included with the message as it appears to any external counterparties. The user can then select the send selector 1730 to send the user's forwarded message, and the transaction client application then retransmits and redisplays the main messages/Inbox interface screen 500 to the client device. Prior to sending a message, the user can review the forwarded message information by selecting one or more of the selectors provided for navigating between and among the interface screens described above. To view sent “forwarded” messages, the sent messages interface screen 1300 can be selected and displayed on the client device, as previously described.

### Viewing a Forwarded Message

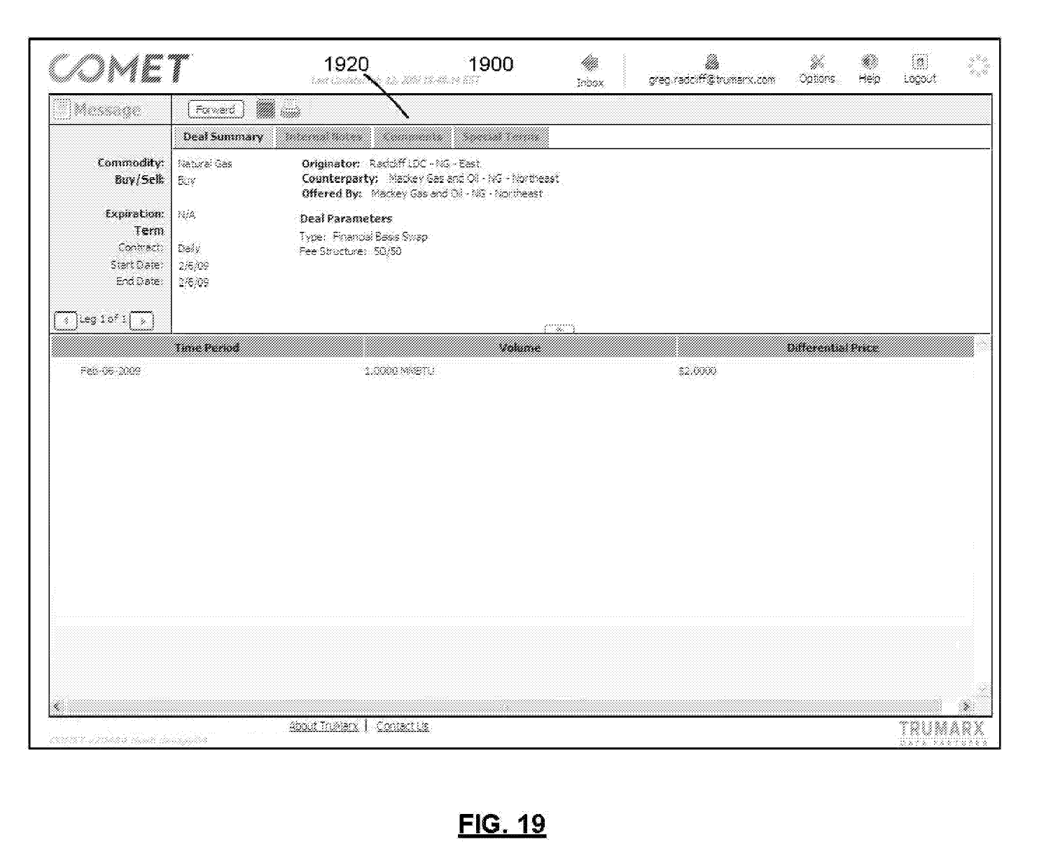

Once a forwarded message is sent to a user, the transaction client application is structured to display such messages within the main messages/Inbox interface screen 500, 1800, shown is FIGS. 5 and 18. FIG. 18 provides one example of a main messages/inbox interface screen 1800 showing highlighted messages 1810 having internal notes appended to such messages with the message highlighted (in green, in one embodiment), in order to distinguish such messages from those which do not have any internal notes appended thereto. From the main messages/Inbox interface screen 1800, the transaction client application is structured to allow a user to select any of the attributes of a forwarded message (i.e. the text values under each column heading) to view the message. As a user moves the cursor over any of the message attributes, the deal text is highlighted. As shown in FIG. 19, transaction client application transmits and displays the deal summary interface screen 1900 on the client device. A user can perform the following actions from a forwarded message: 1) forwarding a message; 2) archiving a message, and 3) printing a message. The transaction client application provides an internal notes selector to allow the user to select to advance to the internal notes interface screen (not shown). Any forwarded notes appear in the “Notes” area within the interface screen. All previous “Notes” are preceded by the name of the user who entered the comments. The transaction client application also provides a comments selector to allow the user to select to advance to the comments interface screen (not shown). Any forwarded comments for the forwarded message appears (not shown). All “Previous Comments” are preceded by the name of the counterparty that entered the comments. The transaction client application also provides a special terms selector to allow the user to select to advance to the special terms interface screen (not shown). Any forwarded special terms tab of the forwarded message appears (not shown). All “Previous Special Terms” are preceded by the name of the counterparty that entered the comments.

### Replying to a Message

The transaction client application can be further structured to allow a user to reply to or respond to a user's counterparties with counter offers. A user can do so when responding to transaction messages sent to such user by originating counterparties or when responding to replies to messages the user originally sent. Replying initiates a set of response interface screens in which the user can modify the grid (price & volume), add any additional comments or special terms, and set an expiration timer for the user's response. The reply action sends a response back only to the originator of the message the user is responding to.

After opening a message from within a main messages/inbox interface screen 500, 1800, selecting a reply selector 1410 allows a user to create a new transaction message. When the reply selector 1410 is selected, the transaction client application will transmit a reply message popup screen to the client device for display. The reply message popup screen (not shown) allows the user to select one of the two following selectors. First, an Executable selector can be selected, which indicates that the transaction is capable of being executed by one of the user's counterparties based on the terms the user defines within the message. This type of transaction requires the originator to provide both volume and price information for the deal. Second, an Indicative selector can be selected, which indicates that the transaction is not executable but is rather a request only for volume or price information. A recipient of an indicative transaction message may respond with an executable message by adding price and other terms. After the user makes their selection, the transaction client application displays the deal summary interface screen 1900 on the client device, and the information displayed in the upper portion of the interface screen 1900 cannot be modified. In the lower portion of the screen is the price grid, which in most cases will allow price and volume numbers to be changed. If the message originator selected non-negotiable for either the price or the volume when setting up the deal initially, the corresponding fields in the grid will not be editable. The transaction client application can be structured to allow a user to amend a daily row in the grid, shown within the interface screen 1900. To do so, the user need only select the respective row within the grid. The transaction client application then highlights the row and allows the user to enter the appropriate values. A commit selector (not shown) can be provided to save any changes the user has made, and a cancel selector (not shown) can be provided to allow the user to cancel any changes.

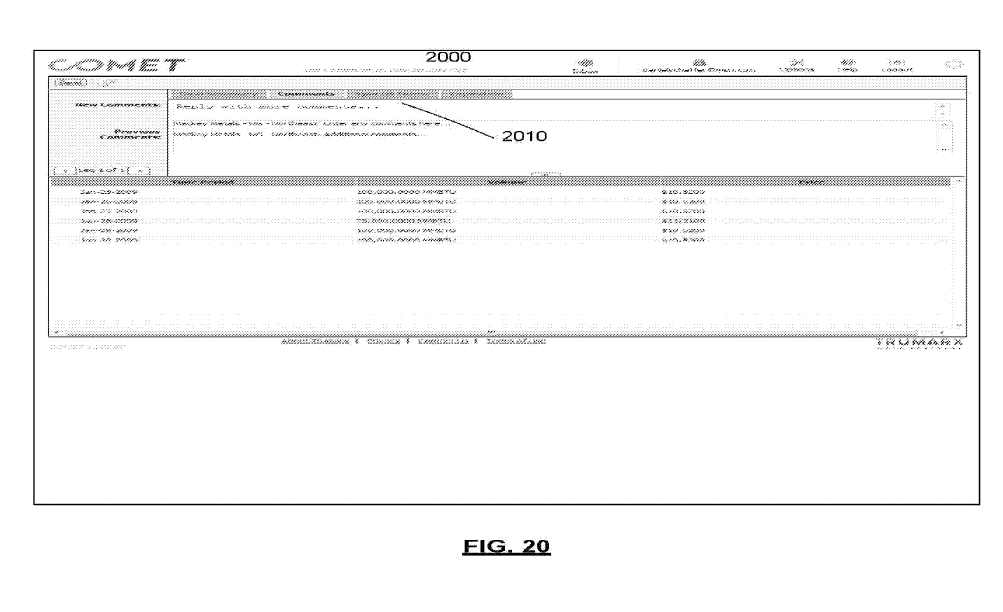

If the transaction message represents a monthly contract, an expand view selector can be provided to expand the view and display the values for each day within the month. A user can only amend daily rows in the price grid. Monthly rows, which indicate monthly totals, cannot be amended. Any changes made to a row in the grid will be highlighted, such as in yellow, both for the daily row and for any related monthly total rows, as shown in FIG. 20. This provides highly visible indicators to the recipient of what the user is proposing as part of the user's counter offer.

When the comments selector 1920 is selected, the transaction client application will transmit a comments interface screen 2000, shown in FIG. 20, to the client device for display. The comments interface screen 2000 allows the user to enter any comments the user wishes to include with the message reply in the “New Comments” field, shown in FIG. 20. All “Previous Comments” are preceded by the name of the counterparty that entered the comments. Comments are not required when completing a message reply. The comments can include any text or messages to the user's counterparty that the user believes will facilitate the completion of the transaction/deal. The comments can also be used as a communication thread between the user and their counterparty to help in the negotiation process. While all comments entered become part of the audit log of the transaction message, comments are not included as part of the external email execution confirmation. If a user would like the text to be included as part of the execution confirmation, the special terms can be used to do so.

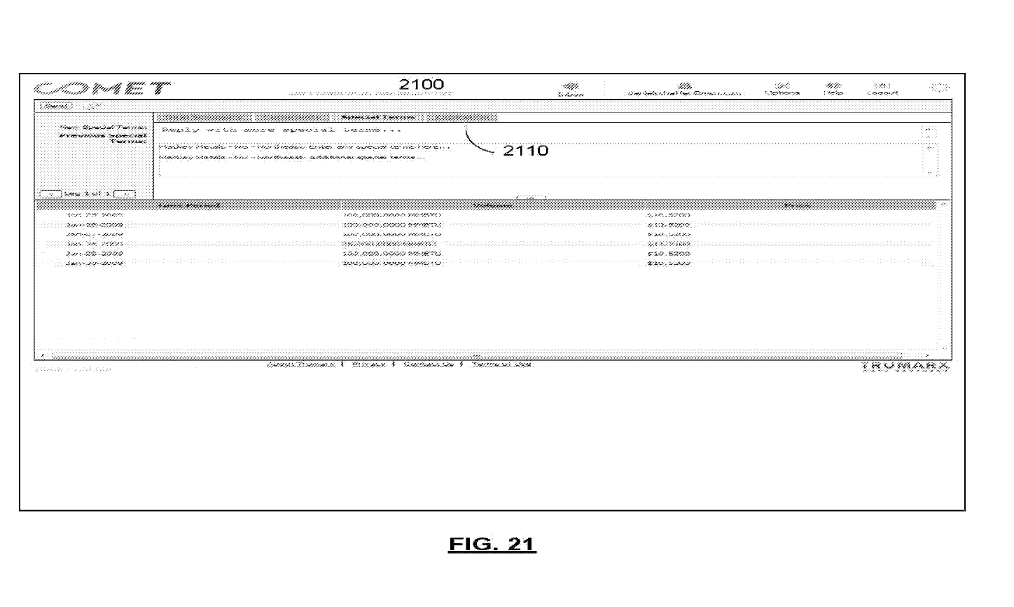

When the special terms selector 2010 is selected, the transaction client application will transmit a special terms interface screen 2100, shown in FIG. 21, to the client device for display. The special terms interface screen 2100 allows the user to enter any special terms the user wishes to include with the message reply in the “New Special Terms” field within the interface screen 2100. All “Previous Special Terms” are preceded by the name of the counterparty that entered the special terms. Special terms are not required when completing a message reply. The special terms interface screen 2100 should only be used to record terms or conditions (i.e. contract number or date, load factor, trigger terms, etc.) that will govern the deal and as such should be included as part of the external email execution confirmation. Any other text or information should be entered as comments, as previously mentioned.

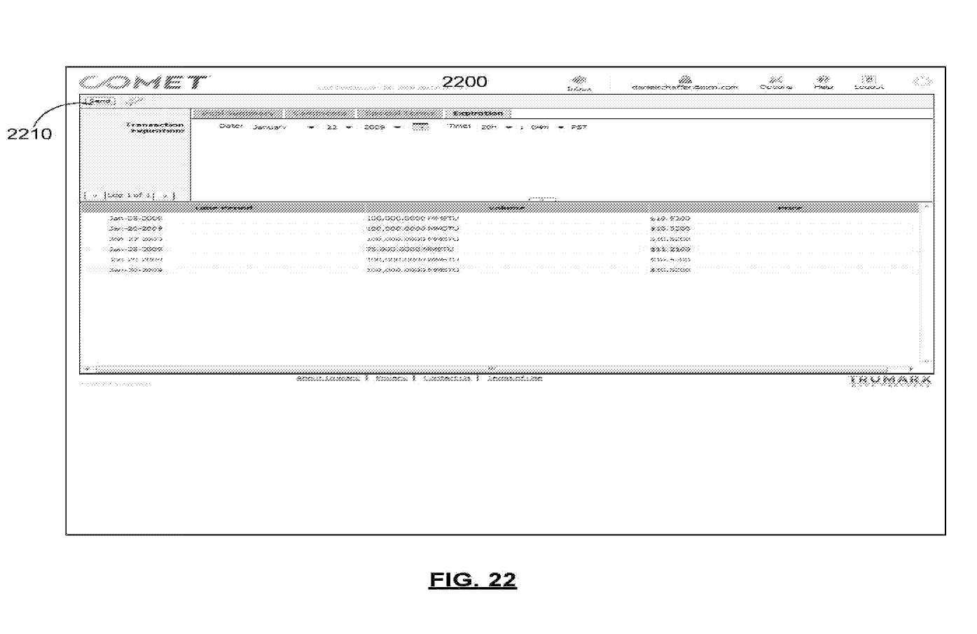

When the expiration selector 2110 is selected, the transaction client application will transmit an expiration interface screen 2200, shown in FIG. 22, to the client device for display. The expiration interface screen 2200 allows the user to enter an expiration date and time that the user would like their reply message to expire. By setting the expiration, the user is informing the counterparty how long they have to respond to the user's message if the user's reply is indicative, or how long the user's offer is valid for, if it is executable. Expiration information is required when completing a message reply. In one embodiment, the expiration time advances in one minute intervals and must be set at least ten minutes in the future. When a user has completed all the appropriate interface screens, the transaction client application is configured to provide a Send selector 2210 for the user to select to send the transaction message. The transaction client application is configured to automatically transmit and display the main messages/inbox interface screen 500 to the client device, and also transmit an external email notification to any counterparties addressed in the message. The email will include at least the originator that sent the transaction message and the transaction message expiration information, as well as a URL which can be used to access the system. Prior to sending the message, the transaction client application allows the user to review and/or amend the information entered within the previous interface screens by using the respective selectors to navigate to such interface screens. To view a transaction message, a user can select the “Sent” view selector 501, which then shows the sent messages interface screen 1300 shown in FIG. 13.

### Executing a Transaction

When a user receives an executable message, such as within the main message/inbox interface screen 500 that contains terms the user is agreeable to, the user can complete the deal by “executing” the transaction. Executions are processed by the transaction client application/system using a “first in wins” methodology, which generally means that the first counterparty to execute a transaction is awarded the deal, which also presumes that it is not possible for multiple counterparties to execute the same transaction. Thus, the transaction client application is configured to prevent more than one counterparty from executing a transaction. When a deal is executed either by the originator or by a counterparty, the transaction client application immediately inactivates all related transaction messages to all other counterparties that may have received the original submission. In addition, the transaction client application only allows the two executing counterparties to be aware of the terms of the executed deal.

The transaction client application can be further structured to allow a user to execute a transaction message. After opening a message, as is shown in deal summary interface screen 1400 shown in FIG. 14, the transaction client application allows a user to execute a transaction message by selecting an execute selector 1420. When the execute selector 1420 is selected, the transaction client application, a popup interface screen (not shown) appears, asking the user if they want to execute the message. Selecting a confirmation or “yes” selector will cause the transaction client application to receive the execution request. If the confirmation selector is selected, the transaction client application will transmit and display another popup interface screen on the client device, which includes the message ID and the offer ID for the particular message and offer being executed, confirming that the message and transaction was successfully executed. Selecting a further confirmation, such as “OK”, then confirms the Yes selection. The transaction client application then transmits and displays the main messages/inbox interface screen 500, to the client device, and transmits an external email execution confirmation to both executing counterparties. In addition to the email notification being sent to the executing counterparties, the system administrator can configure the system to send these confirmations to any valid email address, whether that person is a transaction client application/system user or not.

### Breaking an Executed Transaction

Even though a transaction has been executed within the system, the transaction client application allows the user and the counterparty within whom the deal/transaction was consummated, to “break” the deal. Thus, it is possible to break an executed transaction within the transaction client application, but the transaction client application will only recognize a deal as being broken if both executing counterparties send communications within the transaction client system indicating their mutual consent to do so. Specifically, referring to FIG. 23, a main messages/executed transactions interface screen 2300 is shown, which allows a user to view executed transactions within the transaction client application. In order to break an executed transaction, the transaction client application allows a user to select an executed transaction, such as using a message selector 2320 to the left of the executed transaction message, as shown in FIG. 23. The transaction client application then allows the user to select the break selector 2314 to attempt to break the transaction. The transaction client application then transmits and displays a break transaction popup screen (not shown) to the client device, asking the user to confirm that the user wants to send a break request to the counterparty. When the user confirms the request by selecting a confirmation selector, such as by selecting a “yes” selector, the transaction client application redisplays the main messages/executed transactions interface screen 2300 to the client device, and importantly, transmits an external email notification to the executing counterparty addressed in the transaction message. Included in the email notification are the identity of the originator of the break request message and a link to the transaction client application/system login screen.

To accept a “Break” request on an executed message/transaction, transaction client application is structured to allow the respective counterparty to select the executed transaction message in question, such as from the main messages/inbox interface screen 500. In one embodiment, the transaction client application is configured to allow the respective counterparty to “right click” the transaction message that has been requested to be broken and select the break selector from a right click menu (nor shown) upon right clicking on the user mouse. Additionally, a user may open the break request message and click the “Accept Break” 2392 button in the upper right hand corner of a break executed message request interface screen 2390 as shown in FIG. 23A. Upon selection of the accept break selector 2392, the transaction client application transmits and displays a confirmation popup interface screen (not shown) to the client device requesting the respective counterparty to confirm that the counterparty wants to break the transaction as well (making the break request mutual). The transaction client application provides a confirmation selector, such as a “yes” selector, for the counterparty to select in order to confirm the break is accepted by the counterparty. The transaction client application then retransmits and redisplays the main messages/inbox interface screen 500 to the client device.

In order to view a user's broken message, the transaction client application provides a broken messages viewing selector 501, 2330, as shown in FIGS. 5 and 23. When the user selects the broken messages viewing selector 501, 2330, the transaction client application transmits and displays a main messages/broken messages interface screen view (not shown) to the client device, which is similar in format to the main messages/inbox interface screen 500, but each broken message/transaction is highlighted, such as being displayed in red. Additionally, the transaction client application generates and transmits an external email break confirmation communication to each of the original executing counterparties.

### Killing a Message

When a user receives an executable message, such as within the main message/inbox interface screen 500 that contains terms the user is agreeable to, the user can complete the deal by “executing” the transaction. However, at any time prior to the actual execution of the transaction, the transaction client application is structured to allow the originator of the executable transaction to cancel or “kill” such active executable messages which you are the originator by using the kill feature. Specifically, the main messages/sent transactions interface screen 1300 and the main messages/My Active interface screen (not shown, but similar to the main message/inbox interface screen 500 and other message interface screens) allows a user to view sent/active transactions within the transaction client application. In order to kill an active executable transaction, the transaction client application allows a user to select an active executable transaction, such as using a message selector 1320 to the left of the active executable transaction messages, as shown in FIG. 13. The transaction client application then allows the user to select the kill selector 1310 to kill or cancel the transaction.

The transaction client application will then transmit and display a kill message popup interface screen (not shown) to the client device, which can include a kill selector and a kill and replace selector, which if selected will cause the transaction client application to perform the following functions. Selecting the kill selector causes the transaction client application to kill or cancel the selected offer, rendering it inactive for any counterparties the user has presented it to. The transaction client application can be configured to “gray out” this killed transaction for all recipient counterparties, but the counterparties will remain unaware of whether the offer was executed with another counterparty, expired, or killed. Selecting the kill and replace selector causes the transaction client application to kill or cancel the selected offer in the same way described above, but also copies the details of the killed offer to a new transaction message. The user can then modify the deal details before re-sending the message, as described herein. The transaction client application will retransmit and redisplay the message view the user was working in to the client device, such as the main message/sent items interface screen 1300, and the transaction client application will now display the killed message as struck through (e.g. like this) within this view.

### Customer Administration Application

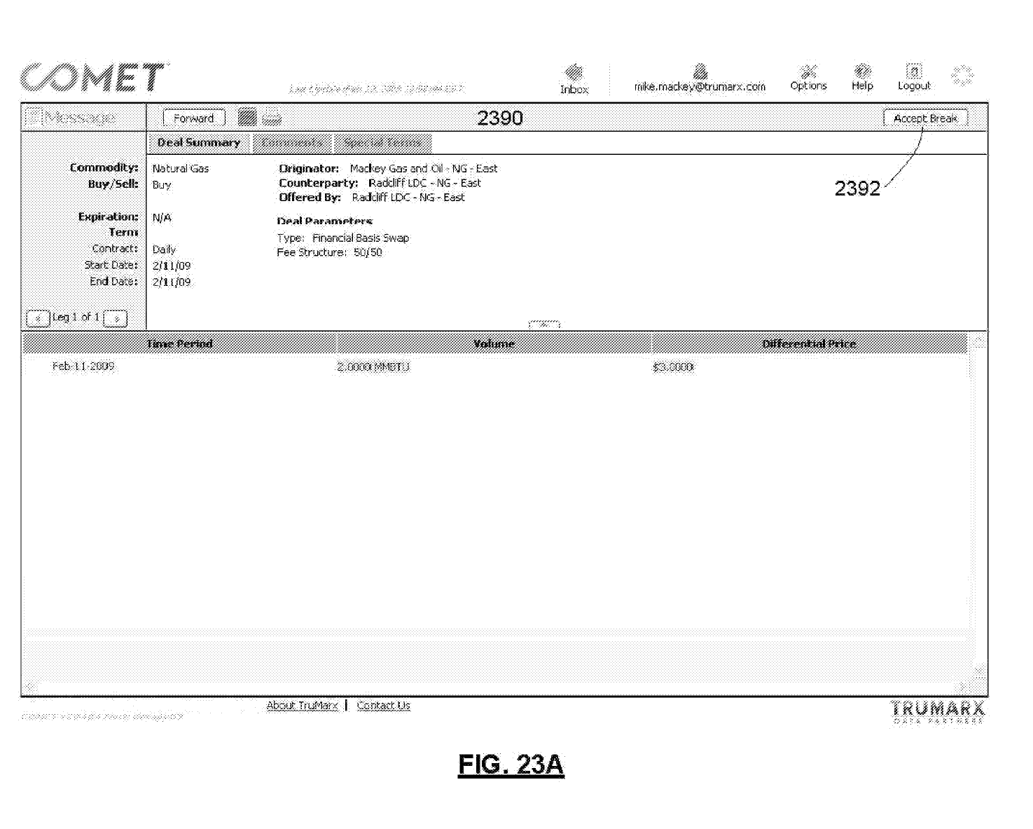

As described above, the system 210, 310, 400 can be structured to include a customer administration application for performing at least the functions shown and described in relation to FIGS. 24 to 40. Generally, access to this application within the preferred embodiment of the system 210, 310, 400 is structured based on how user entitlements are assigned. The customer administration application, which is customer-facing, is used by customers or “users” of the system to manage their company or entity profile, to create and manage individual user accounts, which are then subsequently used to log into the transaction client application. The customer administration application allows such company or entity users, as part of account management functionality, to set entitlements that include access level, restrictions, if any, in terms of counterparties who they can transact with, the products and regions that they can transact in and then specifically transactional level restrictions in terms of total volume, total price, or the term of the deal itself, as will be described in greater detail below. Also, within the customer administration application are some other functional tools that allow entity users to log reports, including generating export files of transactional data, as well as being able to have some visibility into messages within the system, for the account of the users that the entity user created, which provides the entity user the ability to view and potentially manipulate transaction messages of such users, in a defined manner.

### Logging In

Referring to the functions provided through the customer administration application, a login screen (not shown) is provided to allow a company administration user to log into the system. Login input fields are transmitted to user interface (client computer or device) by the transaction client application for entering a username and password. The user then enters their username and password which are received by the customer administration application and verified against usernames and passwords stored in the central database 216 for system users. If the verification is successful, the customer administration application transmits a company profile/general information interface screen 2400, shown in FIG. 24, to the client device. On the left side of interface screen 2400, a set of administration selectors 2410 are provided to select by a company administration user. If selected, the customer administration application transmits the following information to the client device for viewing and other actions, for each of the respective viewing selectors 2410:

| | |
|---|---|
| Company Profile | Set up and maintain: |
| | company's address and contact information |
| | The commodities and regions in which the |
| | company transacts |
| | Individual trading entities for the company |
| Counterparty Management | Select all the counterparties with whom |
| | the company transacts. |
| User Management | Manage the company's user profiles and |
| | system authorities. |
| Transaction Management | Manage the company's deal confirmation |
| | notifications and to kill specific |
| | transaction messages. |
| Reports | Access the Data Export tool, which generates |
| | XML files that can be used in other systems. |

### Company Profile

As indicated above, the customer administration application provides a company profile administration selector 2410 for at least 1) setting up and maintaining a company's address and contact information, 2) setting up and maintaining the commodities and regions in which the company transacts, and 3) setting up and maintaining individual trading entities for the company. Upon selection of the company profile administration selector 2410, in one embodiment, the customer administration application transmits and displays a company profile/general information interface screen 2400, shown in FIG. 24 to the client device. The company profile/general information interface screen 2400 provides the following fields for entering or modifying the respective information about the company.

Company Address

| | |
|---|---|
| Company | Company name is displayed here and cannot be changed. |
| Name | |
| Street | Enter the company's street address. |
| Address | |
| City | Enter the city in which the company resides. |
| State | Enter the state in which the company resides. |
| Zip Code | Enter the zip code for the area in which the company resides. |
| Country | Enter the count in which the company resides. |

Main Contact Details

| | |
|---|---|
| Name | Enter the name of the company's main contact. |
| Email | Enter the email address of the company's main contact. |
| Phone | Enter the phone number of the company's main contact. |

Billing Contact Details

| | |
|---|---|
| Name | Enter the name of the company's billing contact. |
| Email | Enter the email address of the company's billing contact. |
| Phone | Enter the phone number of the company's billing contact. |

A save selector 2420 is provided for a user to select to save this general information to the central database 216.

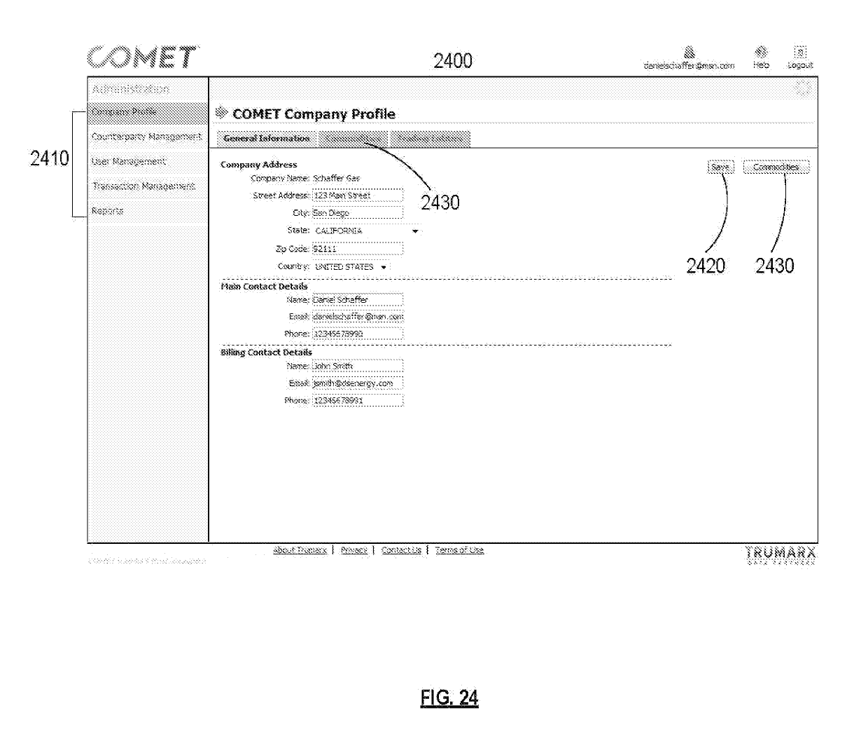

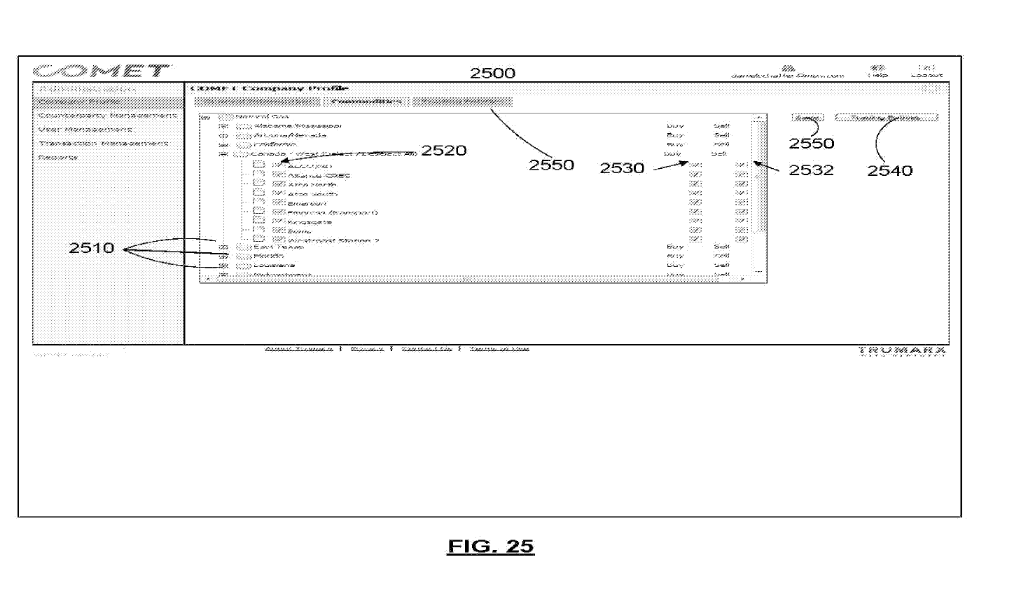

When a user selects one of two commodities selectors 2430 shown in FIG. 24, the customer administration application will transmit and display a company profile/commodities interface screen 2500, shown in FIG. 25, to the client device. The company profile/commodities interface screen 2500 organizes individual market points into folders by commodity type and then by region. The customer administration application provides an expand selector 2510, such as a plus (+) symbol to the left of a folder for a user to select to expand that folder's contents. The customer administration application is also structured to allow a user to select each market point that their company transacts in, by selecting a respective market point selector 2520. Selecting each market point selector will cause the customer administration application to automatically select both a “Buy” selector 2530 and a “Sell” selector 2532, shown as check boxes in FIG. 25 to the right of each selected market point. The customer administration application can also be configured to allow a user to select the individual “Buy” selector 2530 and/or the “Sell” selector 2532, to describe the capabilities of the user's company at a particular market/point. A Select/Deselect All selector can be provided to allow a user to quickly select or deselect all the market points in a region. A save selector 2540 is provided for an administration user to save any changes to the central database 216. When creating user profiles for a company, a user can designate different market points for each individual user, as will be described in greater detail below. However, as part of the company profile setup, an administration user should select all market points that the company transacts in.

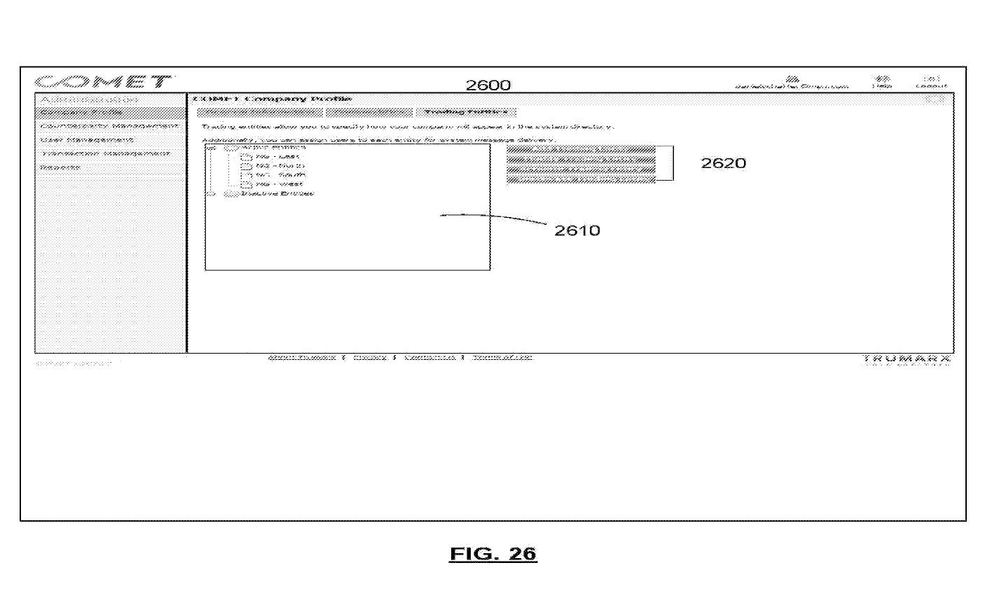

When a user selects one of two trading entities selectors 2550 shown in FIG. 25, the customer administration application will transmit and display a company profile/trading entities interface screen 2600, shown in FIG. 26, to the client device. The company profile/trading entities interface screen 2600 organizes existing trading entities into folders by status (active or inactive). Trading entities are unique business entities or groups within your company that will transact within the present trading facilitator system. At least one trading entity is required for each company on the system. The creation of trading entities is an important aspect of the setup of a company profile, as it will dictate how a company appears to other companies in both the customer administration application and within the transaction client application. For ease of use, naming conventions can be used when creating a company's trading entities. For example, one naming convention can include: Commodity—Region (i.e.—“Natural Gas—California”). Thus, the customer administration application is configured to transmit and display the following selectors to the display to perform respective actions in relation to trading entities. Specifically, a user can select a trading entity from a trading entity list 2610 in order to modify an existing trading entity or choose the option to create a new trading entity. Trading entity selectors 2620 are provided for selection, as shown in FIG. 26, which perform the following functions, once selected.

| | |
|---|---|
| Add Trading Entity | Adding a new trading entity for the company. |
| Modify Trading Entity | Modifying the name of that entity. |
| Activate Trading Entity | Activating an inactive entity. |
| Inactivate Trading Entity | Inactivating an active entity. |

Once a user has created their trading entities for their company, the customer administration application is configured to transmit and display such trading entities within the trading entity list 2610. The customer administration application can also be configured to provide an expand selector, such as a plus (+) symbol, to select to expand a listed trading entity, as shown in FIG. 26. When user profiles are created for a company, the administration user should assign users to each trading entity for system message delivery, which can be performed with the user management functionality, as described below.

To add a new trading entity for a company, as mentioned, a user can select the Add Trading Entity trading entity selector 2620 to add a new trading entity. The customer administration application will then transmit and display a New Trading Entity popup interface screen to the client device, which allows the user to enter the “Name” of the trading entity and click a confirmation selector. The customer administration application will then save the new trading entity to the central database 216 for later use and display, and will display the new trading entity in the trading entity list 2610. As a default, all new trading entities are initially added and stored with an active status within the database 216.

### Counterparty Management

The customer administration application is further configured to provide counterparty management functionality, which is a significant part of the administration user/system administrator responsibilities, since the trading facilitator system is configured such that users are only able to work with companies that are registered and active within the system. Therefore, as the community of companies in the system expands, the system administrator may need to periodically add counterparties, as described herein. As indicated above, the customer administration application provides a counterparty management administration selector 2410, 2710 for at least selecting counterparties with whom a company transacts. Upon selection of the counterparty management administration selector 2410, 2710, in one embodiment, the customer administration application transmits and displays a counterparty management interface screen 2700, shown in FIG. 27 to the client device. The customer administration application transmits and displays the individual counterparties organized by company name and by trading entity, in two sections on the screen: a “Not Selected” counterparties region 2720 and a “Selected Counterparties” region 2730, shown in FIG. 27. The customer administration application is configured to allow the user to select one or more trading entities under each company name, and to provide counterparty management selectors 2740 for a user to select to perform the actions described below. The customer administration application is also configured to provide an expand selector, such as a plus (+) symbol to the left of a company name, to expand the contents of the company name to show each of the regions for such company name.

| | |
|---|---|
| Add Selected | Adding the selected counterparties from the “Not |
| | Selected” window 2720 to the “Selected |
| | Counterparties” window 2730. |
| Remove Selected | Removing the selected counterparties from the |
| | “Selected Counterparties” window 2730 to the “Not |
| | Selected” window. |
| Remove All | Click this button to remove all counterparties from |
| | the “Selected Counterparties” section on the right to |
| | the “Not Selected” section on the left. |

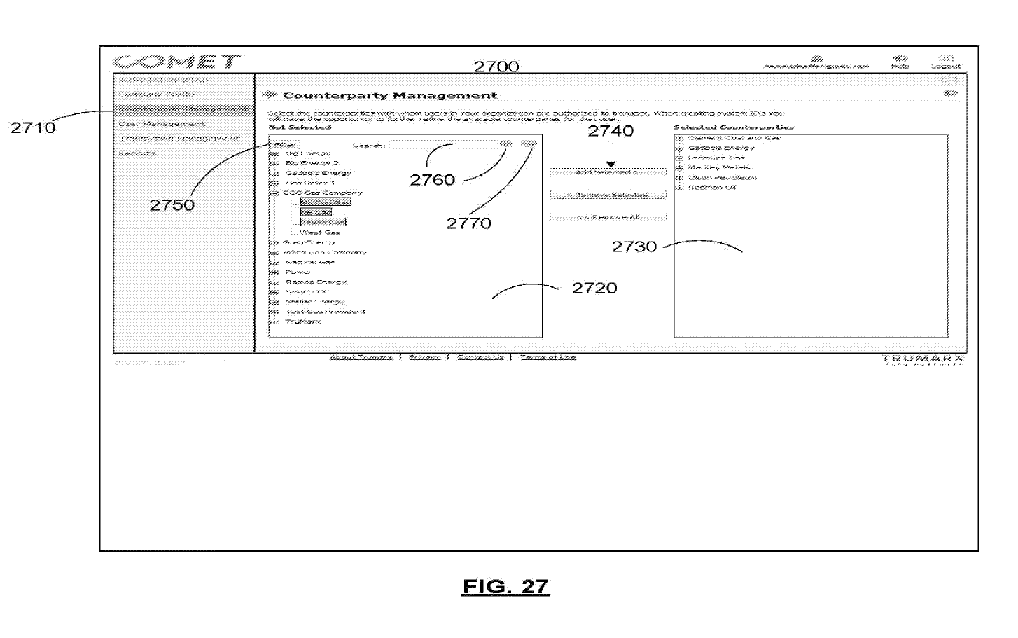

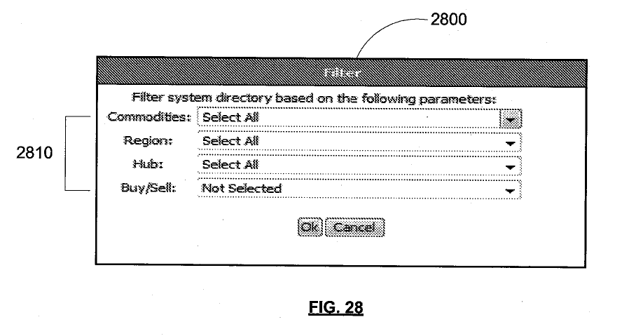

As mentioned, when creating user profiles for users within a company, the customer administration application can be configured to allow an administration user to further refine which counterparties are available for each individual user. The customer administration application can also be configured to display and transmit any added counterparties to the “Selected Counterparties” area 2730, and store these counterparties for that company within the database for later use. The customer administration application will now allow the specific company's users to transact with those counterparties. A filter function can be used to assist in searching for counterparties a user wishes to transact with. The customer administration application can transmit and display a filter selector 2750, shown in FIG. 27, to a client device for selection by a user. When a user selects the filter selector 2750, the customer administration application transmits and displays a filter popup interface screen 2800, which includes various filter parameter selectors 2810, as shown in FIG. 28. The below table sets forth and defines the various filter parameter selectors 2810 and respective options for the filter function. Generally, this function allows a user to filter the list of available counterparties by selecting one or more of the values described below.

| | |
|---|---|
| Commodities | Select a value here to filter the list of available |
| | counterparties by the type of commodity the |
| | counterparties transact in. |
| Region | Select a value here to filter the list of available |
| | counterparties by the geographic region in which the |
| | counterparties transact. |
| Hub | Select a value here to filter the list of available |
| | counterparties by the market point in which the |
| | counterparties transact. |
| Buy/Sell | Select a value here to filter the list of available |
| | counterparties by whether the counterparties only |
| | buy, only sell, or both. |

A search function can also be used to assist in searching for specific counterparties a user wishes to transact with. The customer administration application can transmit and display a search field 2760, shown in FIG. 27, to a client device for use by a user. When a user enters a search term into the search field 2760, the customer administration application searches the database for matching counterparties and transmits and displays the search results to the counterparty management interface screen 2700, for possible selection by the user. To cancel the effects of a filter or search and return to the complete list of available counterparties, the customer administration application transmits and displays a clear search selector 2770.

### User Management

The customer administration application is further configured to provide user management functionality, including at least 1) adding a new user profile for a user's company, 2) resetting a user's password, 3) unlocking a user account that has been locked due to exceeding the allowed limit of failed password login attempts, and 4) managing a company's users' profiles and system authorities. As indicated above, the customer administration application provides a user management administration selector 2410, 2910 for performing these functions. Upon selection of the user management administration selector 2410, 2910, in one embodiment, the customer administration application transmits and displays a user management interface screen 2900, shown in FIG. 29 to the client device. The customer administration application transmits and displays users within a users window 2920, which is organized by user status (active and inactive) in FIG. 29. The customer administration application is configured to allow the user to select an expand selector 2930 to expand that folder's contents. The customer administration application is further configured to allow a user to select a user profile from the list within each folder, to work with that profile or to create a new user profile. The customer administration application is further configured to allow a user to select the user management selectors 2940, the functions of which are described in the following table.

| | |
|---|---|
| Add User | Click this button to add a new user profile for |
| | the company. |
| Reset User Password | Select a user profile from the list and click this |
| | button to reset the user's password. This |
| | operation sends the user an email containing their |
| | new password. |
| Unlock User | Click this button to unlock a user profile. A user |
| | profile becomes locked when the user enters an |
| | incorrect password more than five times at login. |
| Manage User | Select a user profile from the list and click this |
| | button to modify the details and authorities |
| | for the user. |
| Inactivate User | Select a user profile from the list and click this |
| | button to inactivate an active profile. |
| Activate User | Select a user profile from the list and click this |
| | button to activate an inactive profile. |
| Copy to New User | Select a user profile from the list and click this |
| | button to copy the profile to a new user profile. |

Upon selection of the add user management selector 2940, in one embodiment, the customer administration application transmits and displays an add user/general information interface screen (not shown) to the client device. The customer administration application transmits and displays the field for allowing the user to enter the respective information and save such information for the added user, as set forth in the following table.

| First Name | Enter the user's first name. | |
|---|---|---|
| Last Name | Enter the user's last name. | |
| Email Address | Enter the user's email address. | |
| User Role | Select the appropriate role for this user from the drop-down list. | |
| | Options include: | |
| | User RO | This role provides the user read-only access |
| | | to the system transaction client application. |
| | User RW | This role provides the user read/write access |
| | | to the system transaction client application. |
| | Customer Admin | This role provides the user system |
| | | administration authority to all functionality |
| | | in the system customer administration |
| | | application. |

| | |
|---|---|
| Time Zone | Select the time zone in which the user resides from the drop- |
| | down list. |
| Trading Entities | Select the trading entities that the user is assigned to for system |
| | message delivery. Based on this setting, any messages from |
| | external counterparties which are addressed to those trading |
| | entities will be delivered to the user's (and any other users' |
| | assigned to the trading entities) Inbox in the system transaction |
| | client application. A user profile can be associated with multiple |
| | entities. |

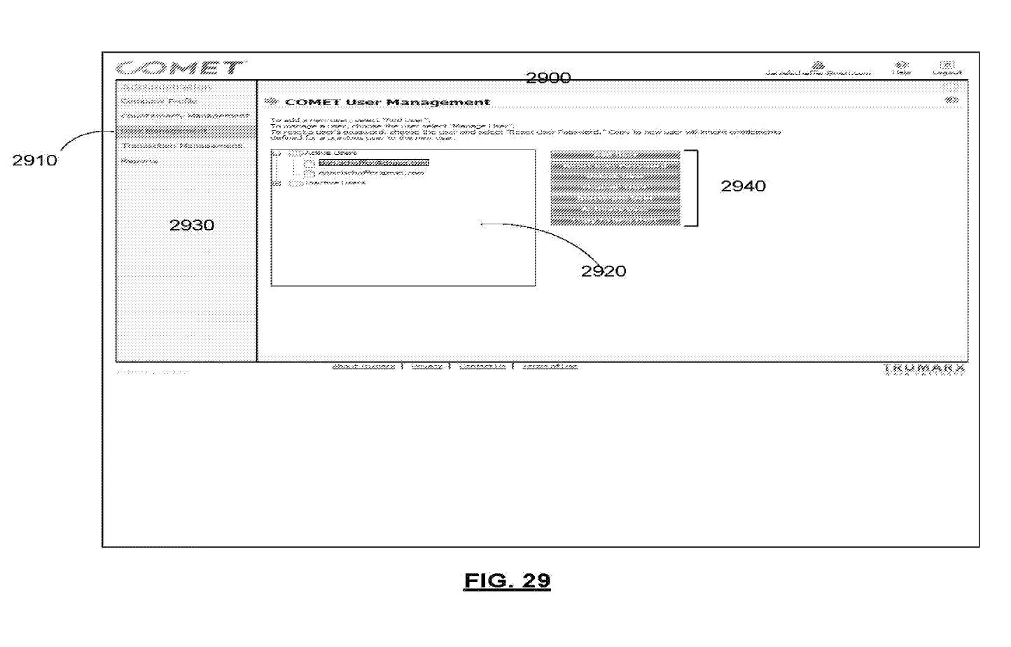

Upon selection of the entitlements selector 3010, in one embodiment, the customer administration application transmits and displays an add user/entitlements interface screen 3000, shown in FIG. 30 to the client device, which allows a user to manage the added user's system authorities. The customer administration application is further configured to transmit and display an entitlements function selectors 3020, for allowing a user to select specific areas of entitlements to set for the newly added user or to manage for existing users, which are described in the following table.

| | |
|---|---|
| Authorized Markets | This option allows the user to manage |
| | which markets the specific user is authorized |
| | to transact in. |
| Authorized Deal Types | This option allows the user to manage which |
| | deal types the specific user is authorized to |
| | transact. |
| Authorized Counterparties | This option allows the user to manage which |
| | counterparties the specific user is authorized |
| | to transact with. |
| Transaction Limits | This option allows the user to set |
| | transaction price, volume, and tenor limits |
| | for the specific user. |

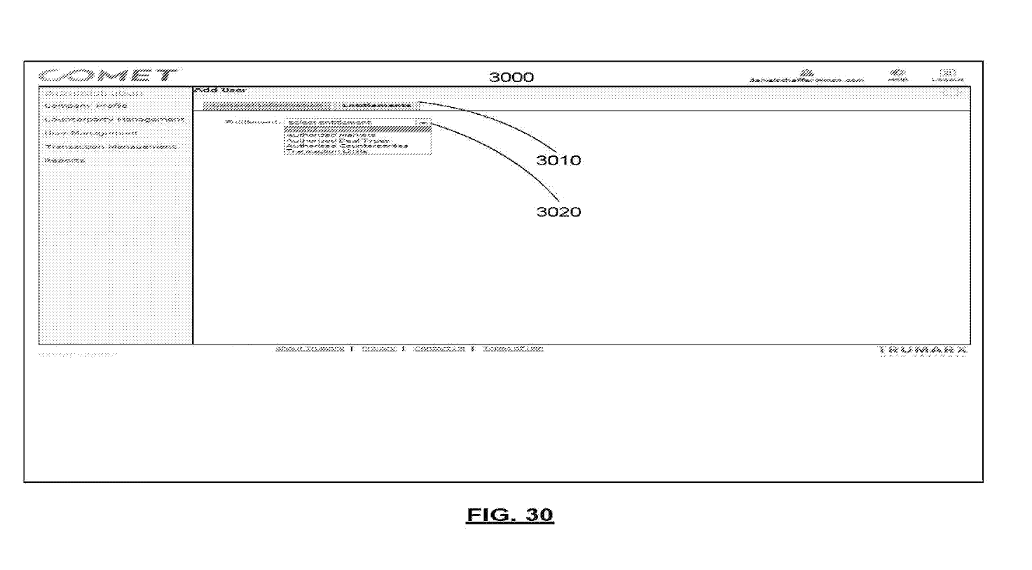

If the user selects the Authorized Markets entitlements function selector 3020, the customer administration application transmits and displays an authorized markets interface screen 3100, shown in FIG. 31 to the client device, which allows a user to select which markets the specified user is authorized to transact in. Individual market points are organized into folders by commodity type and then by region, as shown in this interface screen 3100. The customer administration application can provide an expand selector, as shown as a plus (+) symbol to the left of each folder within FIG. 31, for expanding that folder's contents.

The customer administration application is further configured to transmit and display market selectors 3110, buy selectors 3120, and sell selectors 3130 to the client device, for selecting each market point that the user is authorized to transact in, as well as for selecting whether the user should be entitled to both buy and sell, or only buy or sell within an particular market point. Selectors are also provided to allow a user to quickly select or deselect all the market points in that region, to quickly select all the market points in all regions, as well as to save the selections to the central database 216.

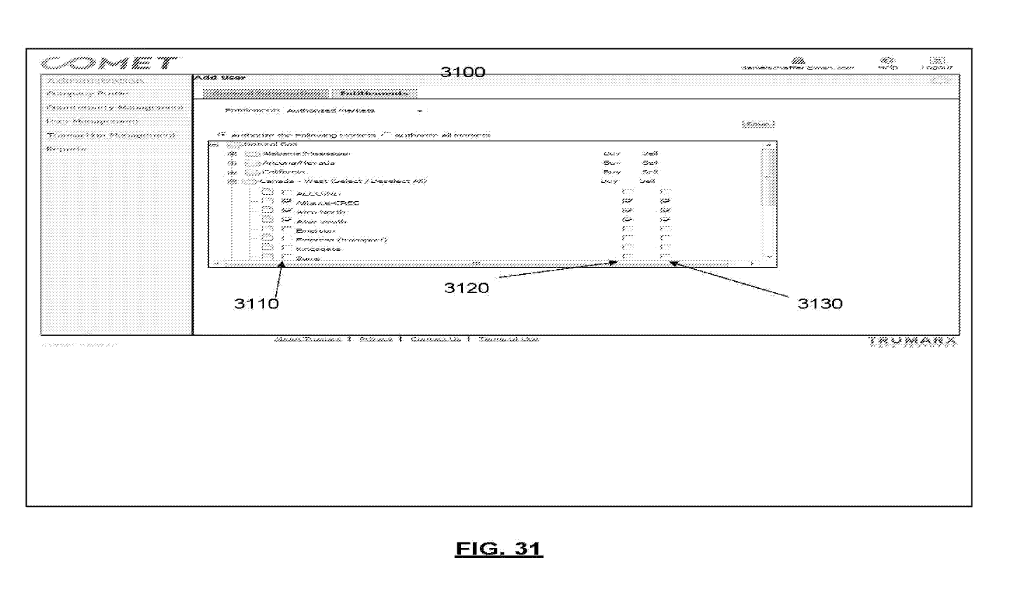

If the user selects the Authorized Deal Types entitlements function selector 3020, the customer administration application transmits and displays an authorized deal types interface screen 3200, shown in FIG. 32 to the client device, which allows a user to select which deal types the specified user is authorized to transact. Individual deal types are organized by commodity type and then by whether the deal is financial or physical in nature, as shown in this interface screen 3200. The customer administration application can provide an expand selector, (not shown) for each folder, for expanding that folder's contents, which turns into a minus (−) once expanded, for contraction once the minus is selected.

The customer administration application is further configured to transmit and display deal type selectors 3210 to the client device, for selecting which deal types the user is authorized to transact in. Additional selectors are also provided to allow a user to quickly select or deselect all deal types as well as to save the selections to the central database 216.

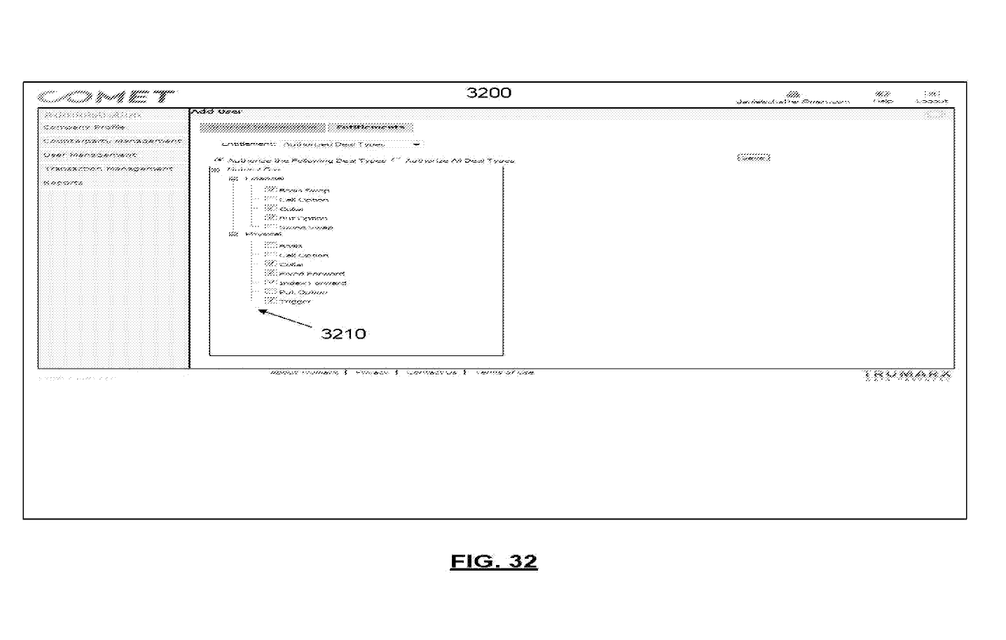

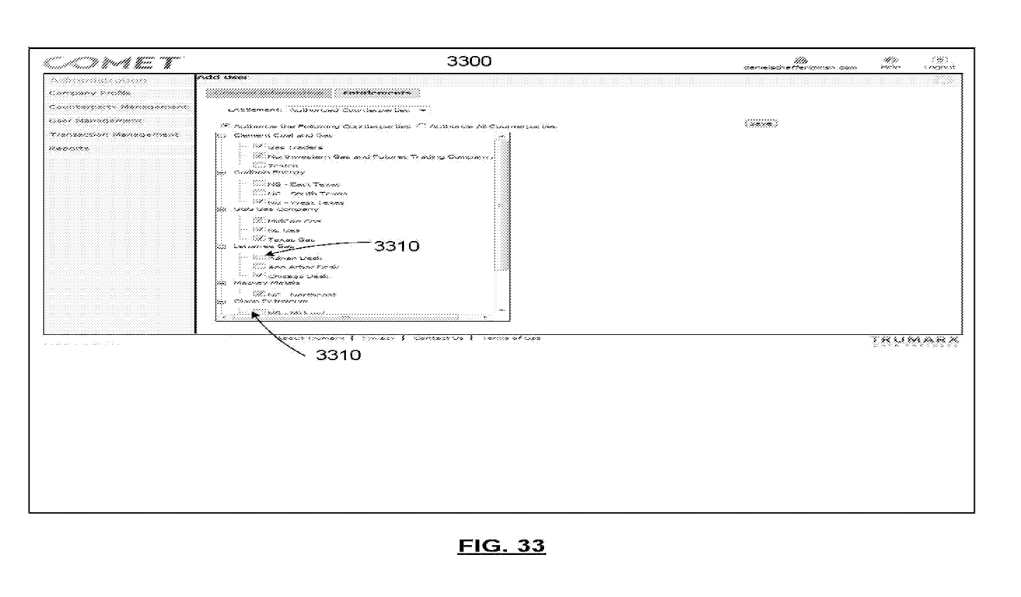

If the user selects the Authorized Counterparties entitlements function selector 3020, the customer administration application transmits and displays an authorized counterparties interface screen 3300, shown in FIG. 33 to the client device, which allows a user to select which counterparties the specified user is authorized to transact with. Counterparties are organized by company name and divisions/regions of such company, as shown in this interface screen 3300. The list of available counterparties presented on this interface screen 3300 comes directly from the list of “Selected Counterparties” for the user's company which is established via the Counterparty Management area of the application. The customer administration application can provide an expand selector, (not shown) for each folder, for expanding that folder's contents, which turns into a minus (−) once expanded, for contraction once the minus is selected.

The customer administration application is further configured to transmit authorized counterparty selectors 3310 to the client device, for selecting which authorized counterparties the user is authorized to transact in. Additional selectors are also provided to allow a user to quickly select or deselect all authorized counterparties as well as to save the selections to the central database 216.

If the user selects the Transaction Limits entitlements function selector 3020, the customer administration application transmits and displays a transaction limits interface screen 3400, shown in FIG. 34 to the client device, which allows a user to set transaction price, volume, and tenor limits for any one transaction for that user to transact in, as shown in FIG. 34 and described in the following table.

| | |
|---|---|
| Financial Limits | This limit category allows a user to set financial |
| | transaction limits, by currency, for a specific user. |
| | No single transaction for the specific user may |
| | exceed the defined amount. |
| Volume Limits | This limit category allows the user to set volume |
| | transaction limits, by commodity, for the specific user. |
| | No single transaction for the specific user may exceed |
| | the defined volume. |
| Tenor Limits | This limit category allows the user to set tenor |
| | transaction limits for the specific user. No single |
| | transaction for the specific user may exceed the |
| | defined tenor. |

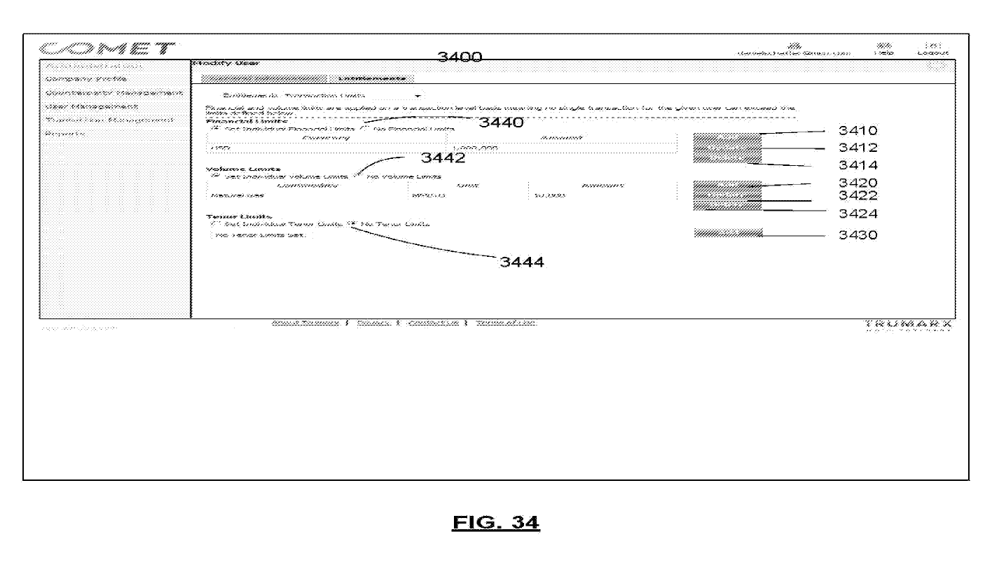

If the user selects an Add financial limits selector 3410, the customer administration application transmits and displays an add financial limit popup interface screen 3500, shown in FIG. 35 to the client device, which allows a user to enter/select a currency type and numerical value for that currency amount. The customer administration application transmits and displays a confirmation selector and a cancel selector to confirm/save the entered information or to cancel the entry of the financial limit, respectively, which in either case will cause the customer administration application to retransmit and redisplay the previous interface screen 3400. The customer administration application is also configured to provide allow a user to select an existing financial limit and update/modify or delete/remove an existing financial limit using the Update and Delete selectors 3412. 3414, respectively, provided through and shown in the transaction limits interface screen 3400, shown in FIG. 34.

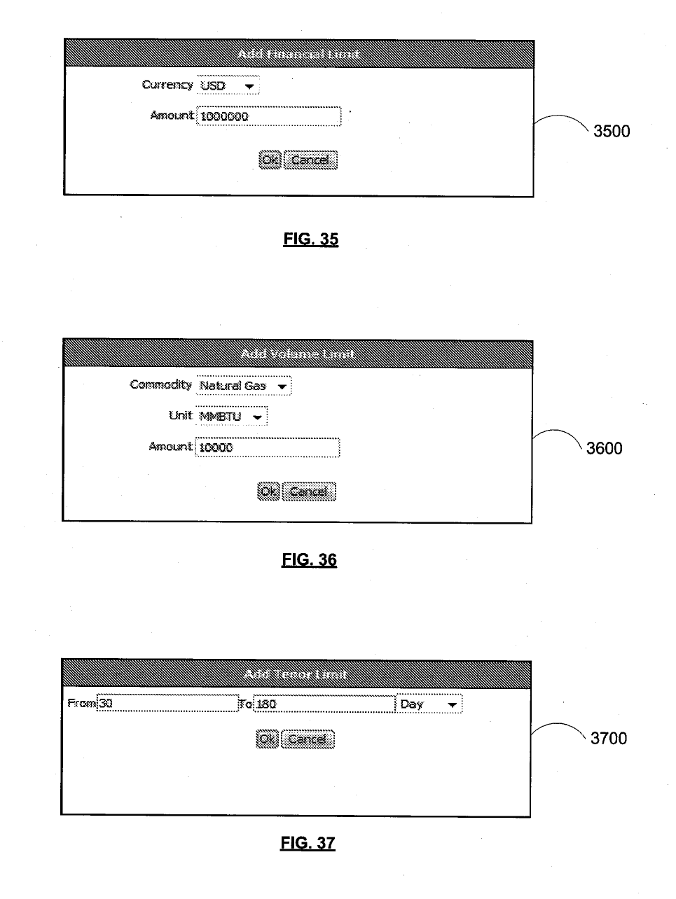

If the user selects an Add volume limits selector 3420, the customer administration application transmits and displays an add volume limit popup interface screen 3600, shown in FIG. 36 to the client device, which allows a user to enter/select a commodity type, unit type, and a numerical value for that unit type and commodity. The customer administration application transmits and displays a confirmation selector and a cancel selector to confirm/save the entered information or to cancel the entry of the volume limit, respectively, which in either case will cause the customer administration application to retransmit and redisplay the previous interface screen 3400. The customer administration application is also configured to allow a user to select an existing volume limit and update/modify or delete/remove an existing financial limit using the Update and Delete selectors 3422, 3424, respectively, provided through and shown in the transaction limits interface screen 3400, shown in FIG. 34.

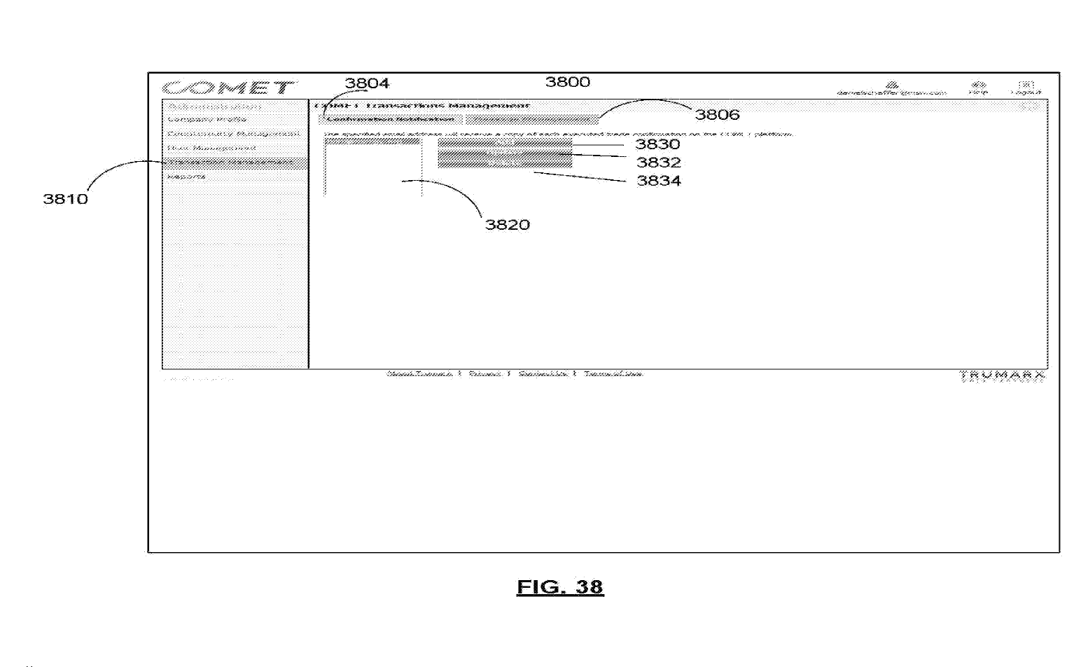

If the user selects an Add tenor limits selector 3430, the customer administration application transmits and displays an add tenor limit popup interface screen 3700, shown in FIG. 37 to the client device, which allows a user to enter/select a specific user's tenor limits for a transaction in days, months, weeks, or years. These limits create a range of how long at a minimum and maximum transaction start and end dates may be set by the user (the deal tenor) in the transaction client application. The customer administration application transmits and displays a confirmation selector and a cancel selector to confirm/save the entered information or to cancel the entry of the tenor limit, respectively, which in either case will cause the customer administration application to retransmit and redisplay the previous interface screen 3400. The customer administration application is also configured to provide allow a user to select an existing tenor limit and update/modify or delete/remove an existing tenor limit using update and delete selectors (not shown), respectively, provided through the transaction limits interface screen 3400. The customer administration application is also configured to allow a user to select no financial limits, no volume limits, and/or no tenor limits, using a no financial limits selector 3440, a no volume limits selector 3442, and/or a no tenor limits selector 3444, respectively, to completely remove all of the user's transactions limits for each limit category.

### Transaction Management

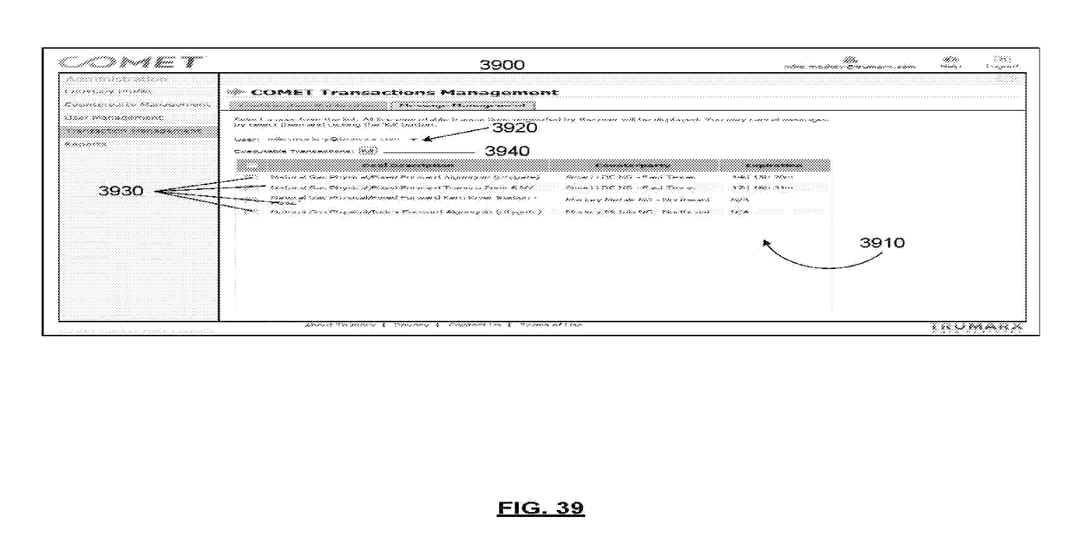

The customer administration application is further configured to provide transaction management functionality, including at least functionality to manage a user's company's transaction confirmation notifications and to kill specific users' active transaction messages. Specifically, the transaction management functionality within the customer administration application allows a user to at least 1) indicate who receives a copy of each executed transaction confirmation via external email notifications (a user/system administrator can elect to send email copies of executed transaction confirmations to any valid external email address, whether or not the recipient is a user of the facilitator application/system) and 2) kill active transaction messages, by originating user (which allows the user/system administrator to kill messages that their company's users have active on the system). As indicated above, the customer administration application provides a transaction management administration selector 2410, 3810 for performing these functions. Upon selection of the transaction management administration selector 2410, 3810, or confirmation notification selector 3804, in one embodiment, the customer administration application transmits and displays a transaction management/confirmation notification interface screen 3800, shown in FIG. 38 to the client device. The customer administration application transmits and displays individual email addresses which are to receive a copy of each executed transaction confirmation within a confirmation list window 3820.

If the user selects an Add confirmation notification selector 3830, the customer administration application transmits and displays an add confirmation notification popup interface screen (not shown) to the client device, which allows a user to enter/select an email address. The customer administration application transmits and displays a confirmation selector and a cancel selector to confirm/save the entered information or to cancel the entry of the email address to the confirmation notification list, respectively, which in either case will cause the customer administration application to retransmit and redisplay the previous interface screen 3800. The customer administration application is also configured to allow a user to select an existing email address from the confirmation list window 3820 and update/modify or delete/remove such existing email address using the Update and Delete selectors 3832. 3834, respectively, provided through and shown in the transaction management/confirmation notification interface screen 3800, shown in FIG. 38.

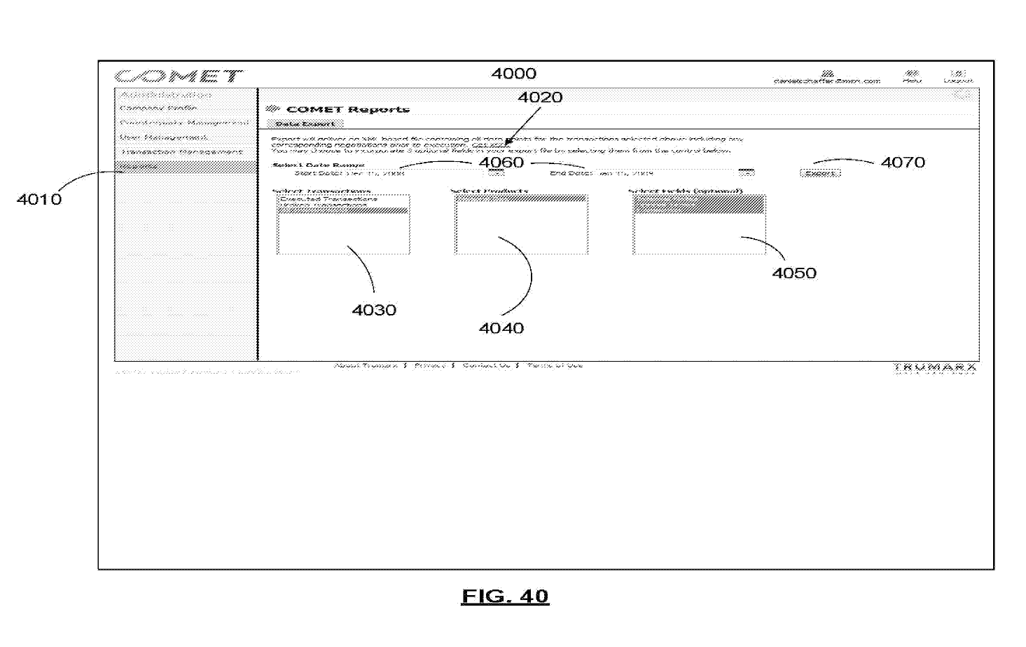

Upon selection of the message management selector 3806, in one embodiment, the customer administration application transmits and displays a transaction management/message notification interface screen 3900, shown in FIG. 39 to the client device. The customer administration application transmits and displays all active transaction messages within the system in an active transactions list 3910, which were originated by the user listed in a user selection region 3920. The customer administration application transmits and displays a transaction selector 3930 for each of the active transactions listed in the active transactions list 3910 to the client device, to allow the user to select which active transactions the user wishes to kill. To kill each such selected executable transaction, the customer administration application transmits and displays a kill transaction selector 3940 to the client device, which once selected will cause the customer administration application to kill such transactions within the central database 216, as can be better understood from the above portions of the specification regarding killing transactions.

The customer administration application is also structured to provides the user/system administrator with the ability to select a different originating user listed in the user selection region 3920, which will cause the customer administration application to transmit and display all active transaction messages to the client device, for the newly selected originating user within the system within the active transactions list 3910, as shown in FIG. 39.

### Client Administrator Reports and Tools

The customer administration application is further configured to provide reporting functionality, including at least functionality to export system transaction audit trail information for use in a user's company's other internal management and reporting systems. This feature generates files in XML format that can then be uploaded or imported into trade capture, risk management, or other data warehouse systems. Specifically, the transaction management functionality within the customer administration application allows a user to at least 1) generate an XSD (XML SchemaDefinition) file that defines the schema for the corresponding generated XML files, and 2) create an XML export file for uploading system transaction information into other company (internal) systems.

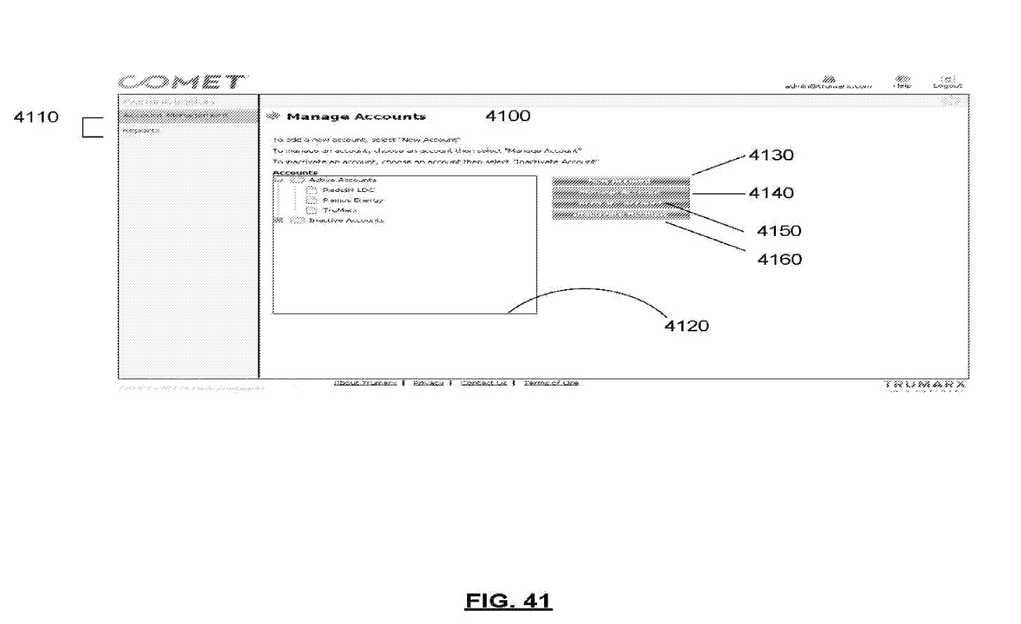

Upon selection of the reports administration selector 2410, 4010, in one embodiment, the customer administration application transmits and displays a transaction management/reports/data export interface screen 4000, shown in FIG. 40 to the client device. The customer administration application transmits and displays a Get XSD selector 4020 for beginning the process of exporting an XSD file that contains the XML Schema Definition that corresponds to the XML export file generated in the next procedure. IT personnel will likely need this XSD file in order to map the resulting XML export file to other systems. Once the user selects the Get XSD selector 4020, the customer administration application transmits and displays an XSD popup window interface screen (not shown) to the client device, prompting the user to either open or save the XSD file, by selecting an open selector (not shown) or a save selector (not shown), respectively. If the save selector is selected, the customer administration application transmits and displays a “Save As” dialog box (not shown) to the client device, allowing the user to navigate to the directory in which the user wishes to save the XSD file and save the XSD file to a location within memory of the user's choice. Once the save operation takes place, the customer administration application retransmits and redisplays the transaction management/reports/data export interface screen 4000, shown in FIG. 40, to the client device.

The customer administration application also allows the user to create an XML export file. The XML export file is the actual file that contains the audit trail information for the company's system transactions. The customer administration application is also structured to transmit and display a select transactions selector window 4030, a select products selector window 4040, a select fields selector window 4050, and select data range selector 4060 to the client device for allowing a user to select the audit trail the user wishes to export defined by transaction types, product types, particular fields, and date range, respectively. In particular, transaction types can include Executed Transaction (all executed transactions for that date range), Broken Transactions (all previously executed transactions that were broken by mutual consent of both counterparties in the system for that date range), and All Transactions (both executed and broken transactions for that date range). The customer administration application is also structured to transmit and display an export selector 4070 to the client device for allowing the user to select in order to create the XML export file. The only fields that are not included in the default exported audit trail information file are the fields listed in the select fields selector window 4050. These fields are free-form text fields that are available within the transaction client application and as such may contain long strings created in “back-and-forth” dialogs between counterparties. Once the user selects the export selector 4070, the customer administration application transmits and displays an save XML popup window interface screen (not shown) to the client device, prompting the user to either open or save the XML file, by selecting an open selector (not shown) or a save selector (not shown), respectively. If the save selector is selected, the customer administration application transmits and displays a “Save As” dialog box (not shown) to the client device, allowing the user to navigate to the directory in which the user wishes to save the XML file and save the XML file to a location within memory of the user's choice. Once the save operation takes place, the customer administration application retransmits and redisplays the transaction management/reports/data export interface screen 4000, shown in FIG. 40, to the client device.

### Host Administration Application

The host administration application is an internal tool for the host entity, to create and manage customer entity accounts at a business level.

### Logging In

Referring to the functions provided through the host administration application, a login screen (not shown) is provided to allow a host administration user to log into the system. Login input fields are transmitted to user interface (client computer or device) by the host client application for entering a username and password. The host administration user then enters their username and password which are received by the host administration application and verified against usernames and passwords stored in the central database 216 for system host administration users. If the verification is successful, the host administration application transmits a manage accounts interface screen 4100, shown in FIG. 41, to the client device. On the left side of the manage accounts interface screen 4100, a set of host administration selectors 4110 are provided to select by a host administration user. In the embodiment shown, if selected, the host administration application transmits either the account management interface screen 4100 or a reports interface screen (not shown).

### Account Management

The host administration application and manage accounts interface screen 4100 generated thereby, shown in FIG. 41, allows a host administration user to view company or entity accounts within an accounts selection window 4120. The manage accounts interface screen 4100 and accounts selection window 4120 organizes existing accounts into folders by status (active or inactive). Accounts are companies or entities that have agreed to certain terms and conditions with the host for being able to use the facilitator system. Thus, the customer administration application is configured to transmit and display the following selectors to the client device to perform respective actions in relation to accounts. Specifically, a host administration user can select a new account selector 4130, a manage account selector 4140, an activate account selector 4150, and an inactivate account selector 4160, which are provided for selection, as shown in FIG. 41, which can perform the following functions, once selected.

| | |
|---|---|
| New Account | Adding a new business account to the system. |
| Manage Account | Modifying information on an existing account. |
| Activate Account | Activating an inactive account. |
| Inactivate Account | Inactivating an active account. |

Once a user has created an account for an entity or company, the host administration application is configured to transmit and display such trading entities within the accounts selection window 4120. The host administration application can also be configured to provide an expand selector, such as a plus (+) sign (not shown) for each folder, for expanding that folder's contents, which turns into a minus (−) once expanded, for contraction once the minus is selected, as shown in FIG. 41.

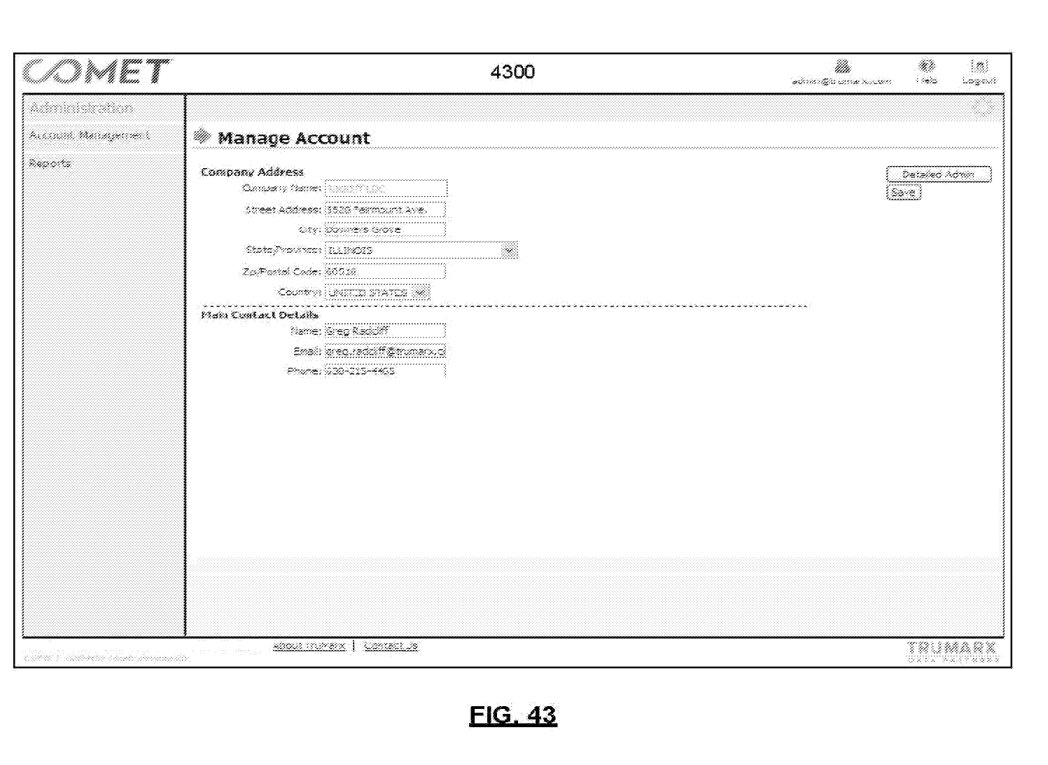

To add a new account, as mentioned, a user can select the new account selector 4130 which will cause the host administration application to transmit and display an add account interface screen 4200 to the client device, shown in FIG. 42. Within the add account interface screen, the host administration application transmits and displays company address fields, such as a company name field, a street address field, a city field, a state/province field, a zip code field, and a country field, as well as customer administrator fields, such as a first name field, a last name field, a phone number field, and an email address field, to the display, for allowing the user to enter and save this information to the central database 216, for later use and display. As a default, all new accounts are initially added and stored with an active status within the database 216.

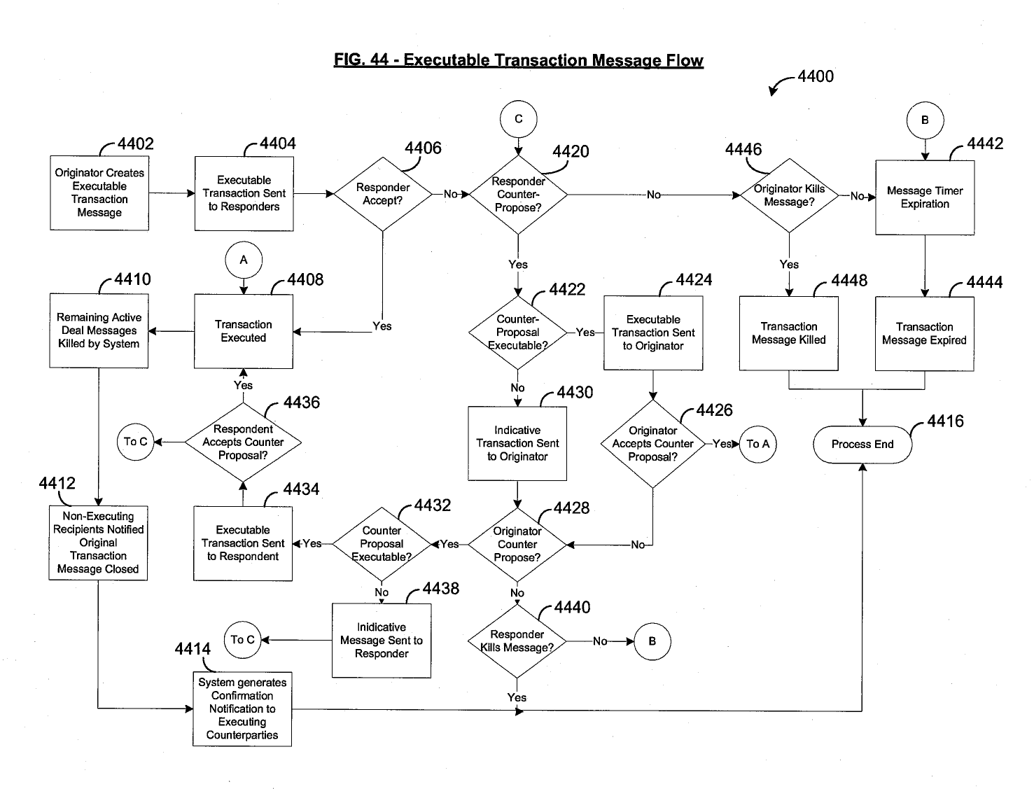

To manage an existing account, as mentioned, a user can select an account within the accounts selection window 4120, and then select the manage account selector 4140 which will cause the host administration application to transmit and display an manage account interface screen 4300 to the client device, shown in FIG. 43. Within the manage account interface screen, the host administration application transmits and displays information an existing account within company address fields, such as within a company name field, a street address field, a city field, a state/province field, a zip code field, and a country field, as well as within customer administrator fields, such as within a first name field, a last name field, a phone number field, and an email address field, to the display, for allowing the user to modify and save this information to the central database 216, for later use and display.

To activate or inactivate an existing account, as mentioned, a user can select an account within the accounts selection window 4120, and then select either the activate account selector 4150 or the inactivate account selector 4160, which will cause the host administration application to either activate or inactivate the selected account, which will in turn then cause the host administration application to transmit and display the account in the appropriate active or inactive group/file within the accounts selection window 4120 to the client device.

### Executable Transaction Message Flow

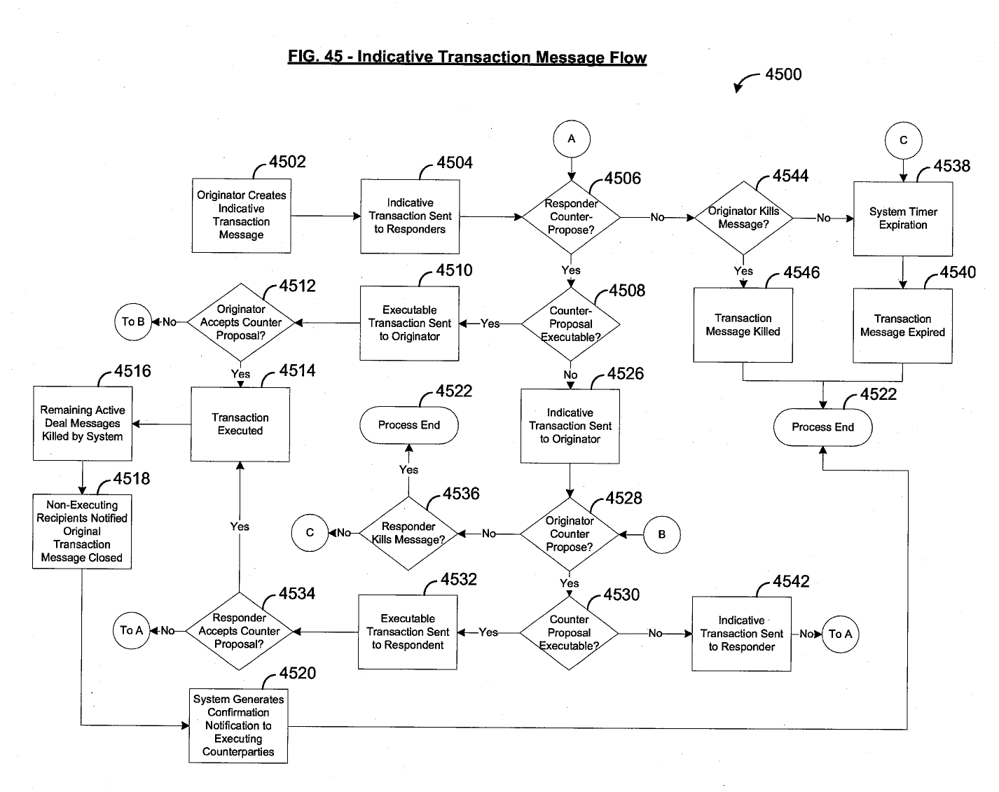

FIG. 44 is an executable transaction message flow diagram or flowchart of one preferred embodiment of the commodity resource private trading market facilitator 310 of FIG. 3 described herein, shown as blocks within FIG. 44, which can be considered the facilitator application or system 210, 310, 4400 as well or in the alternative. In block 4402, the facilitator system 210, 310, 4400 receives information from a user or originator through a client device to create an executable transaction message. Once the originator selects to send the transaction message to one or more respondents, the facilitator system 210, 310, 4400 moves to block 4404. In block 4404, facilitator system 210, 310, 4400 communicates the executable transaction message to the respondent or respondents that were set up to receive the transaction message by the originator, such as within the respondents' messages Inbox shown in FIG. 5. The facilitator system 210, 310, 4400 then moves to block 4406, to determine if and how the respondents respond to received executable transaction message.

If the respondent accepts the transaction message, the facilitator system 210, 310, 4400 then moves to block 4408 and executes and stores the executed transaction message in the database 216. The facilitator system 210, 310, 4400 then moves to block 4410 and kills all remaining deal active messages related to that executed transaction message. The facilitator system 210, 310, 4400 then moves to block 4412 and communicates a notification to all non-executing recipients/respondents that the original transaction message is closed. The facilitator system 210, 310, 4400 then moves to block 4414 and communicates a confirmation notification to executing counterparties confirming that the transaction message has been executed along with the deal details. The facilitator system 210, 310, 4400 then moves to block 4416, which ends the process.

Referring back to block 4406, if the respondent does not accept the transaction message, the facilitator system 210, 310, 4400, the respondent will then perform one of at least three possible actions. First, at block 4420, if the respondent does not accept the transaction message, the respondent can request the facilitator system 210, 310, 4400 to create a counterproposal. If the facilitator system 210, 310, 4400 determines that the respondent wishes to change the terms of the transaction message and has requested the facilitator system 210, 310, 4400 to create a counterproposal, then the facilitator system 210, 310, 4400 moves to block 4422 to determine whether, or to receive an indication from the respondent that, the counterproposal is an executable transaction message or not. If the respondent requests the facilitator system 210, 310, 4400 to designate the counterproposal as an executable transaction message, the facilitator system 210, 310, 4400 moves to block 4424. At block 4424, the facilitator system 210, 310, 4400 communicates the executable transaction message to the originator and then moves to block 4426. At block 4426, the facilitator system 210, 310, 4400 determines if and how the originator responds to the received executable counterproposal transaction message. If the originator requests the facilitator system 210, 310, 4400 to accept the transaction message, the facilitator system 210, 310, 4400 then moves to block 4408 and executes and stores the executed transaction message in the database 216. The facilitator system 210, 310, 4400 will then perform the functions within blocks 4410, 4412, 4414 and 4416.

Referring back to block 4422, if the respondent decides to make the counterproposal indicative, the respondent can request the facilitator system 210, 310, 4400 to send the counterproposal transaction message back to the originator as an indicative transaction message. If the respondent requests the facilitator system 210, 310, 4400 to send the counterproposal transaction message back to the originator as an indicative transaction message, the facilitator system 210, 310, 4400 moves to block 4430 and sends the counterproposal transaction message back to the originator as an indicative transaction message, which can then be viewed and acted on by the originator, such as from within the message Inbox shown in FIG. 5.

Referring back to block 4426, if the originator does not accept the executable counterproposal transaction message, the facilitator system 210, 310, 4400 moves to block 4428. At block 4428, the facilitator system 210, 310, 4400 determines if and how the originator responds to received executable counterproposal transaction message. If the facilitator system 210, 310, 4400 receives a request from the originator to create a counterproposal, then the facilitator system 210, 310, 4400 moves to block 4432. At block 4432, the facilitator system 210, 310, 4400 determines if the originator has requested to make the counterproposal an executable transaction message. If the facilitator system 210, 310, 4400 receives a request from the originator to make the counterproposal an executable transaction message, then the facilitator system 210, 310, 4400 moves to block 4434, and communicates the counterproposal executable transaction message to the respondent and then moves to block 4436. At block 4436, the facilitator system 210, 310, 4400 determines if and how the respondent responds to the received executable counterproposal transaction message. If the respondent accepts the transaction message, the facilitator system 210, 310, 4400 then moves to block 4408 and executes and stores the executed transaction message in the database 216. The facilitator system 210, 310, 4400 will then perform the functions within blocks 4410, 4412, 4414 and 4416. At block 4436, if the respondent does not accept the transaction message, the facilitator system 210, 310, 4400 then moves to block 4420 to determine if the respondent is requesting the facilitator system 210, 310, 4400 to create another counterproposal.

At block 4432, if the facilitator system 210, 310, 4400 determines that the originator has requested to make the counterproposal an indicative transaction message, then the facilitator system 210, 310, 4400 moves to block 4438, and communicates the counterproposal indicative transaction message to the respondent and then moves to block 4420. At block 4428, if the facilitator system 210, 310, 4400 receives a request from the originator that they do not want to send a counterproposal, then the facilitator system 210, 310, 4400 moves to block 4440. At block 4440, if the facilitator system 210, 310, 4400 receives a request from the originator that they want to kill the transaction message, then the facilitator system 210, 310, 4400 moves to block 4416 and the process ends. At block 4440, if the respondent does not take any further action and the transaction message timer expires, then the facilitator system 210, 310, 4400 moves to block 4442, to block 4444, and then onto block 4416, and the process ends.

Similarly, at block 4420, if the facilitator system 210, 310, 4400 receives a request from the respondent that they do not want to send a counterproposal, then the facilitator system 210, 310, 4400 moves to block 4446. At block 4446, if the facilitator system 210, 310, 4400 receives a request from the respondent that they want to kill the transaction message, then the facilitator system 210, 310, 4400 moves to block 4448 and the facilitator system 210, 310, 4400 kills the transaction message. The facilitator system 210, 310, 4400 then moves to block 4416 and the process ends.

### Indicative Transaction Message Flow

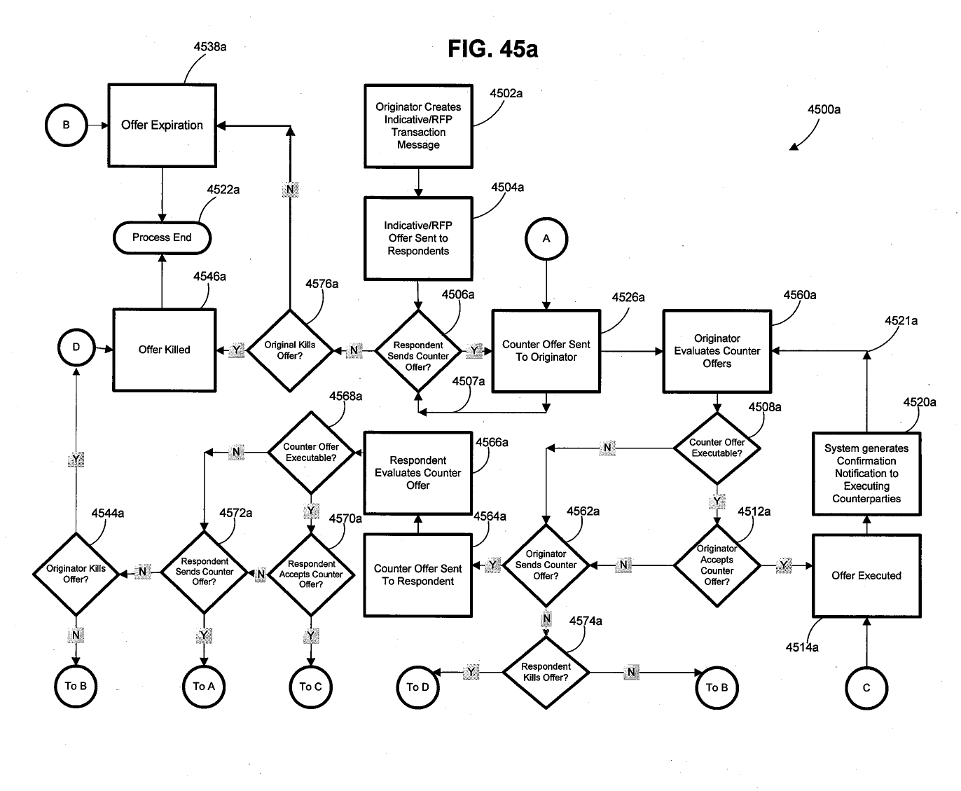

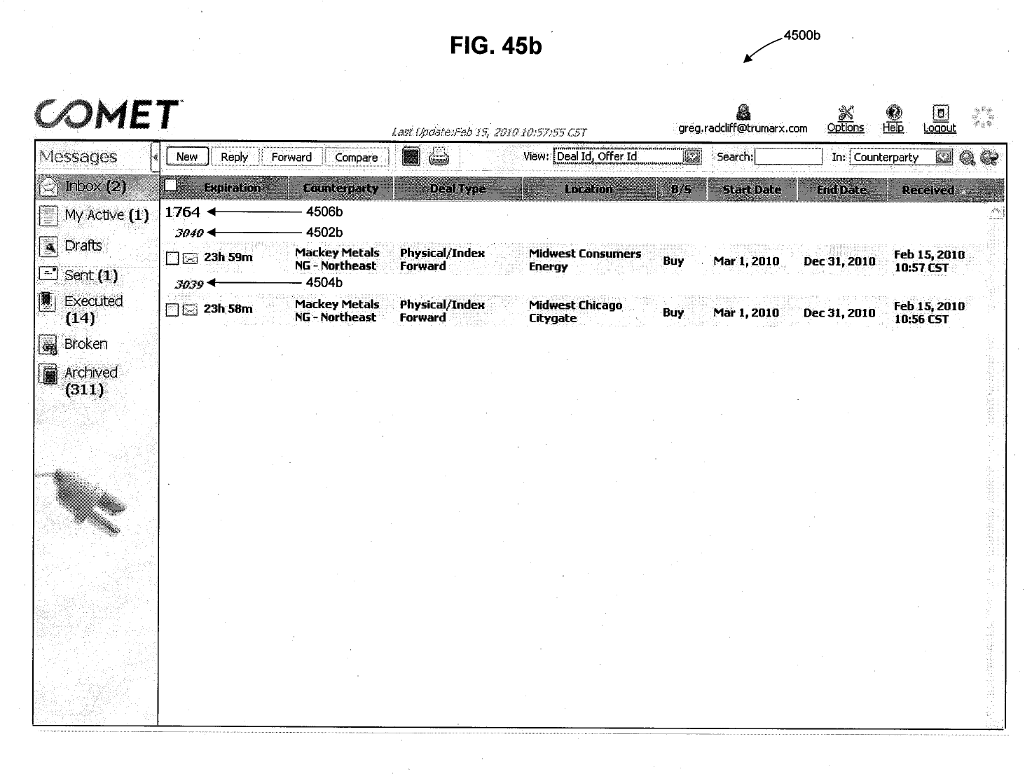

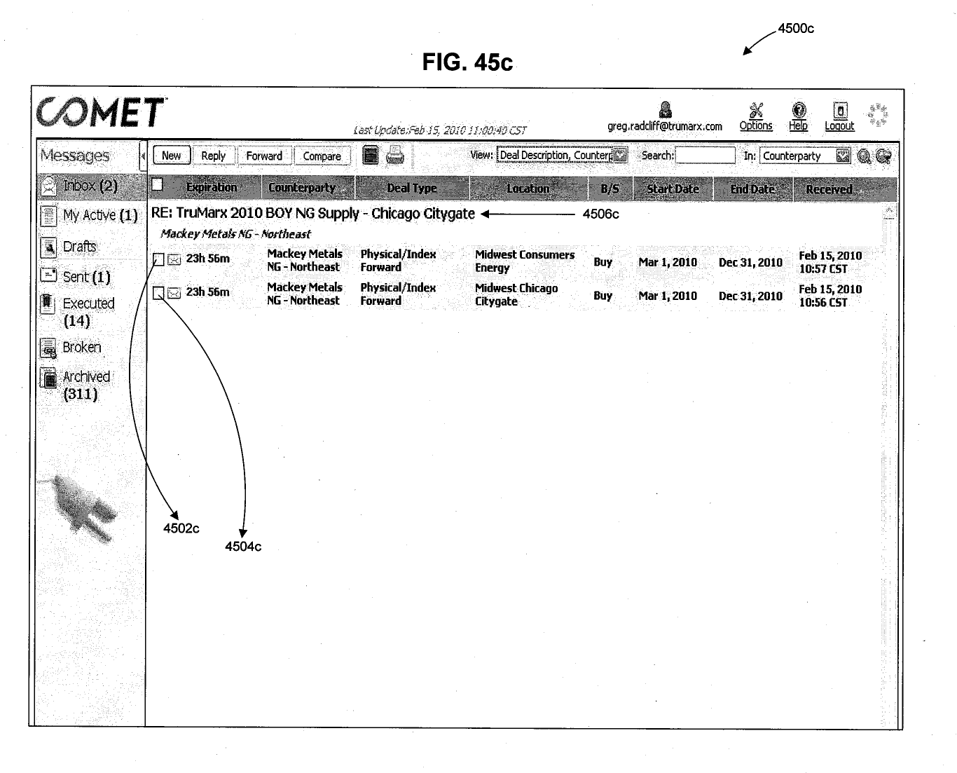

FIG. 45 is an indicative/RFP (request for proposal) transaction message flow diagram or flowchart of one preferred embodiment of the commodity resource private trading market facilitator 310 of FIG. 3 described herein, shown as blocks within FIG. 45, which can be considered the facilitator application or system 210, 310, 4500 as well or in the alternative. In block 4502, the facilitator system 210, 310, 4500 receives information from a user or originator through a client device to create an indicative transaction message. Once the originator selects to send the transaction message to one or more respondents, the facilitator system 210, 310, 4500 moves to block 4504. In block 4504, facilitator system 210, 310, 4500 communicates the indicative transaction message to the respondent or respondents that were set up to receive the transaction message by the originator, such as within the respondents' messages Inbox shown in FIG. 5. The facilitator system 210, 310, 4500 then moves to block 4506. After receiving this indicative transaction message, at block 4506, the respondent can request the facilitator system 210, 310, 4500 to create a counterproposal. If the facilitator system 210, 310, 4500 determines that the respondent wishes to change the terms of the transaction message or wishes to respond to the indicative transaction message with an executable transaction message, and has requested the facilitator system 210, 310, 4500 to create a counterproposal, then the facilitator system 210, 310, 4500 moves to block 4508 to determine whether, or to receive an indication from the respondent that, the counterproposal is an executable transaction message or not. If the respondent requests the facilitator system 210, 310, 4500 to generate a counterproposal that is an executable transaction message, the facilitator system 210, 310, 4500 moves to block 4510. At block 4510, the facilitator system 210, 310, 4500 communicates the executable transaction message to the originator and then moves to block 4512. At block 4512, the facilitator system 210, 310, 4500 determines if and how the originator responds to the received executable counterproposal transaction message. If the originator requests the facilitator system 210, 310, 4500 to accept the transaction message, the facilitator system 210, 310, 4500 then moves to block 4514 and executes and stores the executed transaction message in the database 216. The facilitator system 210, 310, 4500 then moves to block 4516 and kills all remaining deal active messages related to that executed transaction message. The facilitator system 210, 310, 4500 then moves to block 4518 and communicates a notification to all non-executing recipients/respondents that the original transaction message is closed. The facilitator system 210, 310, 4500 then moves to block 4520 and communicates a confirmation notification to executing counterparties confirming that the transaction message has been executed along with the deal details. The facilitator system 210, 310, 4500 then moves to block 4522, which ends the process.

Returning to block 4508, if the respondent requests the facilitator system 210, 310, 4500 to send the counterproposal transaction message back to the originator as an indicative transaction message, the facilitator system 210, 310, 4500 moves to block 4526 and sends the counterproposal transaction message back to the originator as an indicative transaction message, which can then be viewed and acted on by the originator, such as from within the message Inbox shown in FIG. 5. The facilitator system 210, 310, 4500 then moves to block 4528. At block 4528, the facilitator system 210, 310, 4500 determines if and how the originator responds to received indicative counterproposal transaction message. If the facilitator system 210, 310, 4500 receives a request from the originator to create a counterproposal, then the facilitator system 210, 310, 4500 moves to block 4530. At block 4530, the facilitator system 210, 310, 4500 determines if the originator has requested to make the counterproposal an executable transaction message. If the facilitator system 210, 310, 4500 receives a request from the originator to make the counterproposal an executable transaction message, then the facilitator system 210, 310, 4500 moves to block 4532, and communicates the counterproposal executable transaction message to the respondent, and then moves to block 4534. At block 4534, the facilitator system 210, 310, 4500 determines if and how the respondent responds to the received executable counterproposal transaction message. If the respondent requests the facilitator system 210, 310, 4500 to accept the transaction message, the facilitator system 210, 310, 4500 then moves to block 4514 and executes and stores the executed transaction message in the database 216. The facilitator system 210, 310, 4500 will then perform the functions within blocks 4516, 4518, 4520 and 4522. At block 4534, if the respondent does not accept the transaction message, the facilitator system 210, 310, 4500 then moves to block 4506 to determine if the respondent is requesting the facilitator system 210, 310, 4500 to create another counterproposal.

Returning to block 4528, if the facilitator system 210, 310, 4500 receives a request from the originator that they do not want to send a counterproposal, then the facilitator system 210, 310, 4500 moves to block 4536. At block 4536, if the facilitator system 210, 310, 4500 receives a request from the originator that they want to kill the transaction message, then the facilitator system 210, 310, 4500 moves to block 4522 and the process ends. At block 4536, if the respondent does not take any further action and the transaction message timer expires, then the facilitator system 210, 310, 4500 moves to block 4538, to block 4540, and then onto block 4522, and the process ends. Returning to block 4530, if the facilitator system 210, 310, 4500 determines that the originator has requested the facilitator system 210, 310, 4500 to make the counterproposal an indicative transaction message, then the facilitator system 210, 310, 4500 moves to block 4542, and communicates the counterproposal indicative transaction message to the respondent and then moves to block 4506.

Returning to block 4506, if the facilitator system 210, 310, 4500 receives a request from the respondent that they do not want to send a counterproposal, then the facilitator system 210, 310, 4500 moves to block 4544. At block 4544, if the facilitator system 210, 310, 4500 receives a request from the respondent that they want to kill the transaction message, then the facilitator system 210, 310, 4500 moves to block 4546 and the facilitator system 210, 310, 4500 kills the transaction message. The facilitator system 210, 310, 4500 then moves to block 4522 and the process ends.

FIG. 45a is an indicative/RFP (request for proposal) transaction message flow diagram or flowchart of one alternative more preferred embodiment of the commodity resource private trading market facilitator 310 of FIG. 3 described herein, shown as blocks within FIG. 45a, which can be considered the facilitator application or system 210, 310, 4500a as well or in the alternative. The facilitator application or system 210, 310, 4500a of FIG. 45a can receive a counter-offer response for more than one of each of a plurality of sub-offers within a deal that includes a plurality of sub-offers, independent from each other of the plurality of sub-offers. Likewise, the facilitator application or system 210, 310, 4500a of FIG. 45a can also receive an acceptance response for more than one of each of a plurality of sub-offers within a deal that includes a plurality of sub-offers, independent from each other of the plurality of sub-offers, as will be explained in greater detail below. In block 4502a, the facilitator system 210, 310, 4500a receives information from a user or originator through a client device to create an indicative transaction message. Once the originator selects to send the transaction message to one or more respondents, the facilitator system 210, 310, 4500a moves to block 4504a. In block 4504a, facilitator system 210, 310, 4500a communicates the indicative transaction/offer message to the respondent or respondents that were set up to receive the transaction message by the originator, such as within the respondents' messages Inbox shown in FIGS. 5, 45b, and 45c. The facilitator system 210, 310, 4500a then moves to block 4506a. At block 4506a, the facilitator system 210, 310, 4500a determines whether, or receives an indication from the respondent that, the respondent is going to send a counterproposal/offer. If the facilitator system 210, 310, 4500a determines a counterproposal/offer is to be sent to the originator, the facilitator system 210, 310, 4500a then moves to block 4526a. At block 4526a, the facilitator system 210, 310, 4500a sends a counterproposal/offer to the originator, and then can move to block 4560a.

Referring to FIGS. 45b and 45c, two types of transaction management/message management interface screens of a preferred customer administration application are shown, which each display multiple sub-offers for the same transaction or deal. For example, in FIG. 45b, two executable sub-offers 4502b, 4504b (shown by offer identifiers “3040” and “3039”, respectively) are shown for a deal 4506b (shown by deal identifier “1764”). In FIG. 45c, two executable sub-offers 4502c, 4504c (generally shown) are shown for a deal 4506c (shown by deal description). Thus, alternatively to moving to block 4560a within FIG. 45a, after a counterproposal/offer is received and sent for one or more of the sub-offers 4502b, 4502c, 4504b, 4504c, the facilitator system 210, 310, 4500a can move back to block 4506a along path 4507a to receive a selection to send and send additional counterproposals/offers for other of the sub-offers 4502b, 4502c, 4504b, 4504c. This process can be repeated for each sub-offer. Referring back to FIG. 45a, at block 4560a, the facilitator system 210, 310, 4500a then begins the process of the originator evaluating the counterproposal/offer, and moves to block 4508a.

The facilitator system 210, 310, 4500a then moves to block 4508a to determine whether the counterproposal is an executable transaction message or not. If the facilitator system 210, 310, 4500a determines that the counterproposal is executable, the facilitator system 210, 310, 4500a moves to block 4512a. At block 4512a, the facilitator system 210, 310, 4500a determines if and how the originator responds to the received executable counterproposal transaction message. If the originator requests the facilitator system 210, 310, 4500a to accept the transaction message, the facilitator system 210, 310, 450a then moves to block 4514a and executes and stores the executed transaction message in the database 216. The facilitator system 210, 310, 4500a then moves to block 4520a and communicates a confirmation notification to executing counterparties confirming that the transaction message has been executed along with the deal details. The facilitator system 210, 310, 4500a can then optionally kill all remaining deal active messages related to that executed transaction message, and/or move back to block 4560a. As mentioned above herein, in one or more embodiments, as shown in FIGS. 45b and 45c, information received from a user or originator through a client device to create an indicative transaction message, can include deal information which has a plurality of sub-offers therein. In such an embodiment, the facilitator system 210, 310, 4500a moves back to block 4560a through path 4521a in order for the originator to evaluate other counterproposals for other of the sub-offers 4502b, 4502c, 4504b, 4504c (shown in FIGS. 45b and 45c) not already acted on within a deal. As described, the facilitator system 210, 310, 4500a then moves back to block 4508a to determine whether the counterproposal for the particular sub-offer is an executable or not. If the facilitator system 210, 310, 4500a determines that the counterproposal is for the particular sub-offer is executable, the facilitator system 210, 310, 4500a moves back to block 4512a. As provided herein above, at block 4512a, the facilitator system 210, 310, 4500a determines if and how the originator responds to the received executable counterproposal transaction message for the particular sub-offer. If the originator requests the facilitator system 210, 310, 4500a to accept the transaction message for the particular sub-offer, the facilitator system 210, 310, 450a then moves to block 4514a and executes and stores the executed transaction message for the particular sub-offer in the database 216. The process described herein above then continues for reach particular sub-offer within the deal, which can be repeated for each particular sub-offer.

Returning to blocks 4508a and 4512a, if the counterproposal is not executable or if the originator does not accept the counterproposal from the respondent, then the facilitator system 210, 310, 4500a moves to block 4562a. At block 4562a, the facilitator system 210, 310, 4500a determines whether the originator wishes to send a counterproposal back to the respondent. If the facilitator system 210, 310, 4500a receives an indication from the originator or determines that the originator wishes to send a counterproposal back to the respondent, then the facilitator system 210, 310, 4500a moves to block 4564a. At block 4564a, the facilitator system 210, 310, 4500a sends the counterproposal to the respondent, and then moves to block 4566a. At block 4566a, the facilitator system 210, 310, 4500a begins the process of the respondent evaluating the counterproposal/offer, and moves to block 4568a.

The facilitator system 210, 310, 4500a then moves to block 4568a to determine whether the counterproposal is an executable transaction message or not. If the facilitator system 210, 310, 4500a determines that the counterproposal is executable, the facilitator system 210, 310, 4500a moves to block 4570a. At block 4570a, the facilitator system 210, 310, 4500a determines if and how the respondent responds to the received executable counterproposal transaction message. If the respondent requests the facilitator system 210, 310, 4500a to accept the transaction message, the facilitator system 210, 310, 450a then moves to block 4514a and executes and stores the executed transaction message in the database 216.

Returning to blocks 4568a and 4570a, if the counterproposal is not executable or if the respondent does not accept the counterproposal from the originator, then the facilitator system 210, 310, 4500a moves to block 4572a. At block 4572a, the facilitator system 210, 310, 4500a determines whether the respondent wishes to send a counterproposal back to the originator. If the facilitator system 210, 310, 4500a receives an indication from the respondent or determines that the respondent wishes to send a counterproposal back to the originator, then the facilitator system 210, 310, 4500a moves back to block 4526a. If the facilitator system 210, 310, 4500a receives an indication from the respondent or determines that the respondent does not wish to send a counterproposal back to the originator, then the facilitator system 210, 310, 4500a moves block 4544a. At block 4544a, if the facilitator system 210, 310, 4500a receives a request from the originator they want to kill the transaction message, then the facilitator system 210, 310, 4500a moves to block 4546a and the facilitator system 210, 310, 4500a kills the transaction message. The facilitator system 210, 310, 4500a then moves to block 4522a and the process ends.

At block 4544a, if the facilitator system 210, 310, 4500a receives a request from the originator they do not want to kill the transaction message, then the facilitator system 210, 310, 4500a moves to block 4538a. At block 4538a, if the respondent does not take any further action and the transaction message timer expires, then the facilitator system 210, 310, 4500a moves to block 4522a, and the process ends.

Returning to block 4562a, if the facilitator system 210, 310, 4500a determines that the originator does not wish send a counterproposal to the respondent, the facilitator system 210, 310, 4500a then moves to block 4574a. At block 4574a, if the facilitator system 210, 310, 4500a receives a request from the respondent they want to kill the transaction message, then the facilitator system 210, 310, 4500a moves to block 4546a and the facilitator system 210, 310, 4500a kills the transaction message. The facilitator system 210, 310, 4500a then moves to block 4522a and the process ends. At block 4574a, if the facilitator system 210, 310, 4500a receives a request from the respondent they do not want to kill the transaction message, then the facilitator system 210, 310, 4500a moves to block 4538a. At block 4538a, if the respondent does not take any further action and the transaction message timer expires, then the facilitator system 210, 310, 4500a moves to block 4522a, and the process ends.

Returning to block 4506a, if the facilitator system 210, 310, 4500a receives a request from the respondent that they do not want to send a counterproposal, then the facilitator system 210, 310, 4500a moves to block 4576a. At block 4576a, if the facilitator system 210, 310, 4500a receives a request from the originator that they want to kill the transaction message, then the facilitator system 210, 310, 4500a moves to block 4546a and the facilitator system 210, 310, 4500a kills the transaction message. The facilitator system 210, 310, 4500 then moves to block 4522a and the process ends. At block 4576a, if the facilitator system 210, 310, 4500a receives a request from the originator that they do not want to kill the transaction message, then the facilitator system 210, 310, 4500a moves to block 4538a. At block 4538a, if the originator does not take any further action and the transaction message timer expires, then the facilitator system 210, 310, 4500a moves to block 4522a, and the process ends.

### Break Transaction Message Flow

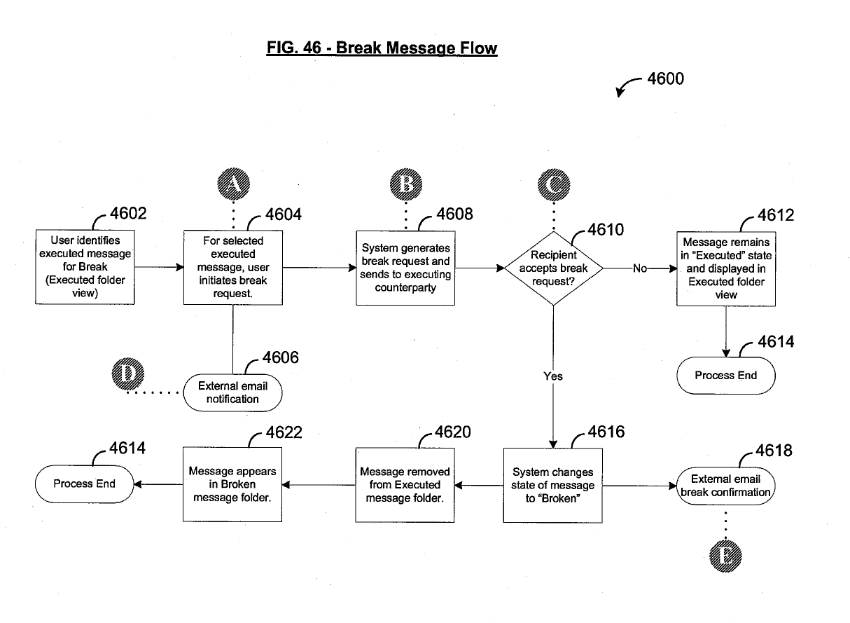

FIG. 46 is a break transaction message flow diagram or flowchart of one preferred embodiment of the commodity resource private trading market facilitator 310 of FIG. 3 described herein, shown as blocks within FIG. 46, which can be considered the facilitator application or system 210, 310, 4600 as well or in the alternative. Once a transaction message has been executed within the facilitator application or system 210, 310, 4600, an originator or counterparty can attempt to break an executed transaction message by initiating a break request transaction message. A break request transaction message can be initiated by an originator or counterparty from several locations/interface screens within the facilitator system 210, 310, 4600. Specifically, in one embodiment, a break transaction request message can be initiated from least the executed message interface screen 2300 and the context menu (which is made available by “right clicking” on the executed transaction that is to be broken and then selecting the break message selector).

In block 4602, the facilitator system 210, 310, 4600 receives an identification of an executed transaction message, such as from the executed messages interface screen 2300 (folder view). Once the facilitator system 210, 310, 4600 receives an identification of an executed transaction message to break, the facilitator system 210, 310, 4600 moves to block 4604. At block 4604, the facilitator system 210, 310, 4600 receives a break request for the selected executed transaction message, and moves to block 4606. At block 4606, the facilitator system 210, 310, 4600 transmits an external email notification to the executing counterparty addressed in the transaction message. Included in the email notification are the identity of the originator of the break request transaction message and a link to the transaction client application/system login screen. The facilitator system 210, 310, 4600 also then moves to block 4608. At block 4608, the facilitator system 210, 310, 4600 generates and transmits a break request transaction message request to the counterparty that had previously entered into the executed transaction with the requesting party, such as to the counterparty's main messages/inbox interface screen 500. The facilitator system 210, 310, 4600 then moves to block 4610. At block 4610, the facilitator system 210, 310, 4600 determines whether the counterparty has requested the facilitator system 210, 310, 4600 to accept the break transaction message request, If the facilitator system 210, 310, 4600 determines that the counterparty has not accepted the break transaction message request, the facilitator system 210, 310, 4600 moves to block 4612. At block 4612, the facilitator system 210, 310, 4600 keeps the executed transaction message in question listed within the executed message interface screens 2300 of the respective party and counterparty and does not break the executed transaction message. The facilitator system 210, 310, 4600 then moves to block 4614, and the process ends.

Returning to block 4610, if the facilitator system 210, 310, 4600 determines that the counterparty has accepted the break request transaction message, the facilitator system 210, 310, 4600 moves to block 4616. At block 4616, the facilitator system 210, 310, 4600 changes the state of the executed transaction message in question to “broken” in the central database 216, and moves to blocks 4618 and 4620. At block 4618, facilitator system 210, 310, 4600 generates and transmits an external email break confirmation communication to each of the original executing counterparties. At block 4620, the facilitator system 210, 310, 4600 removes the executed transaction message from executed message interface screen 2300 of the both the party and the counterparty. The facilitator system 210, 310, 4600 then moves to block 4622. At block 4622, the facilitator system 210, 310, 4600 then transmits and displays the broken transaction message within the main messages/broken messages interface screen view (not shown) to the client device. As mentioned, each broken message/transaction is highlighted, such as being displayed in red italics. The facilitator system 210, 310, 4600 then moves to block 4614 where the process ends.

Any process descriptions or blocks in the figures, such as FIGS. 4A-4C and 44-46, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

### Appendix

The following tables provide field/parameter definitions for the possible combinations of “Deal Type” and “Deal Sub-Type” values, which are referenced from time to time within the present specification.

To complete a Financial/Basis Swap message, use the field definitions below to complete the Deal Details tab of a new transaction message with the following “Deal Type” and “Deal Sub-Type” values.

### Deal Type: Financial/Deal Sub-Type: Basis Swap

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is |
| | filtered based on your “Deal Type” selection. |
| Buy/Sell | Whether the transaction is a buy or a sell, from your |
| | (the originator's) point of view. |
| Fee Structure | How the fee for executing this transaction is to be paid. |
| | Select either 50/50 (buyer and seller split the fee |
| | payment), Buyer Pays, or Seller Pays. |

\textcircled{2} Parameters Sub-Tab
Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Differential | The price above or below the index price that will be paid for the |
| | commodity. This value can be positive, negative, or zero. |
| Index | The provider whose index you wish to use to price the deal (e.g. IFERC, |
| | Gas Daily, etc.). |
| Location | The location for the provider selected above on whose index you wish the |
| | price the deal. |
| Settlement | The settlement type for the index provider selected above. |
| Index 2 | The second provider whose index you wish to use to price the deal. This |
| | allows you to create a differential between the first index selected and this |
| | one. |
| Location 2 | The location for the second provider selected above on whose index you |
| | wish the price the deal. |
| Settlement 2 | The settlement type for the second index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the |
| | transaction message. This information persists as part of the message's |
| | audit trail and is included as special terms in any confirmation emails. For |
| | example, special terms might include “seller pays transportation fees” or |
| | “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in |
| | the month. The values displayed in this column cannot be edited on this |
| | screen. |
| Volume | The volume terms for the specific day or month of the transaction. Click |
| | anywhere in a daily row to amend the value. |
| Differential Price | The differential pricing terms for the specific day of the transaction. Click |
| | anywhere in a daily row to amend the value. |

To complete a Financial/Call Option message, use the field definitions below to complete the Deal Details tab of a new transaction message with the following “Deal Type” and “Deal Sub-Type” values.

### Deal Type: Financial/Deal Sub-Type: Call Option

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point of |
| | view. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Call Strike | The daily call strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Call Strike | The call strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Financial/Collar message, use the field definitions below to complete the Deal Details tab of a new transaction message with the following “Deal Type” and “Deal Sub-Type” values.

### Deal Type: Financial/Deal Sub-Type: Collar

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Put Strike | The daily put strike price of the transaction. |
| Call Strike | The daily call strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Call Strike | The call strike pricing terms for the specific day of the transaction. Click |
| | anywhere in a daily row to amend the value. |
| Put Strike | The put strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Financial/Put Option message, use the field definitions below to complete the Deal Details tab of a new transaction message with the following “Deal Type” and “Deal Sub-Type” values.

### Deal Type: Financial/Deal Sub-Type: Put Option

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Put Strike | The daily put strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Put Strike | The put strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Financial/Swing Swap message, use the field definitions below to complete the Deal Details tab of a new transaction message with the following “Deal Type” and “Deal Sub-Type” values.

### Deal Type: Financial/Deal Sub-Type: Swing Swap

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point of |
| | view. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Price | The daily price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Price | The pricing terms for the specific day of the transaction. Click anywhere in a |
| | daily row to amend the value. |

To complete a Physical/Basis message, use the field definitions below to complete the Deal Details tab of a new transaction message with the following “Deal Type” and “Deal Sub-Type” values.

### Deal Type: Physical/Deal Sub-Type: Basis

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point |
| | of view. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Differential | The price above or below the index price that will be paid for the |
| | commodity. This value can be positive, negative, or zero. |
| Index | The provider whose index you wish to use to price the deal (e.g. IFERC, |
| | Gas Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the |
| | transaction message. This information persists as part of the message's |
| | audit trail and is included as special terms in any confirmation emails. For |
| | example, special terms might include “seller pays transportation fees” or |
| | “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in |
| | the month. The values displayed in this column cannot be edited on this |
| | screen. |
| Volume | The volume terms for the specific day or month of the transaction. Click |
| | anywhere in a daily row to amend the value. |
| Differential Price | The differential pricing terms for the specific day of the transaction. Click |
| | anywhere in a daily row to amend the value. |

To complete a Physical/Call Option message, use the field definitions below to complete the Deal Details tab of a new transaction message with the following “Deal Type” and “Deal Sub-Type” values.

### Deal Type: Physical/Deal Sub-Type: Call Option

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point of |
| | view. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Call Strike | The daily call strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Call Strike | The call strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Physical/Collar message, use the field definitions below to complete the Deal Details tab of a new transaction message with the following “Deal Type” and “Deal Sub-Type” values.

### Deal Type: Physical/Deal Sub-Type: Collar

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Put Strike | The daily put strike price of the transaction. |
| Call Strike | The daily call strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Call Strike | The call strike pricing terms for the specific day of the transaction. Click |
| | anywhere in a daily row to amend the value. |
| Put Strike | The put strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Physical/Fixed Forward message, use the field definitions below to complete the Deal Details tab of a new transaction message with the following “Deal Type” and “Deal Sub-Type” values.

### Deal Type: Physical/Deal Sub-Type: Fixed Forward

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point of |
| | view. |
| Fee Structure | How the fee for executing this transaction is to be paid. Select either 50/50 |
| | (buyer and seller split the fee payment), Buyer Pays, or Seller Pays. |

\textcircled{2} Parameters sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Price | The daily price of the transaction. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Price | The pricing terms for the specific day of the transaction. Click anywhere in a |
| | daily row to amend the value. |

To complete a Physical/Index Forward message, use the field definitions below to complete the Deal Details tab of a new transaction message with the following “Deal Type” and “Deal Sub-Type” values.

### Deal Type: Physical/Deal Sub-Type: Index Forward

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point |
| | of view. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Differential | The price above or below the index price that will be paid for the |
| | commodity. This value can be positive, negative, or zero. |
| Index | The provider whose index you wish to use to price the deal (e.g. IFERC, |
| | Gas Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the |
| | transaction message. This information persists as part of the message's |
| | audit trail and is included as special terms in any confirmation emails. For |
| | example, special terms might include “seller pays transportation fees” or |
| | “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in |
| | the month. The values displayed in this column cannot be edited on this |
| | screen. |
| Volume | The volume terms for the specific day or month of the transaction. Click |
| | anywhere in a daily row to amend the value. |
| Differential Price | The differential pricing terms for the specific day of the transaction. Click |
| | anywhere in a daily row to amend the value. |

To complete a Physical/Put Option message, use the field definitions below to complete the Deal Details tab of a new transaction message with the following “Deal Type” and “Deal Sub-Type” values.

### Deal Type: Physical/Deal Sub-Type: Put Option

\textcircled{1} Structure sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on your |
| | “Deal Type” selection. |
| Buy/Sell | Whether the transaction is a buy or a sell, from your (the originator's) point of |
| | view. |
| Premium Type | Indicates the payment terms for the premium associated with this option. Pre- |
| | pay indicates a lump sum payment, and Amortizing indicates payments over |
| | time. |
| Fee Structure | How the fee for executing this transaction is to be paid. Select either 50/50 |
| | (buyer and seller split the fee payment), Buyer Pays, or Seller Pays. |

\textcircled{2} Parameters Sub-Tab
Delivery Location

| | |
|---|---|
| Region | The geographic region of the market point to which you want delivery. |
| Pipeline | The unique market point to which you want delivery. |
| Description | A user-defined free-form text description of the delivery location. Use this |
| | field to further define the exact delivery location, if necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If Yes is |
| | selected, the recipients of the transaction message will have the option to |
| | propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If Yes is |
| | selected, the recipients of the transaction message will have the option to |
| | propose amended pricing terms. |
| Currency | The currency that the pricing terms of the transaction are expressed in. |
| Put Strike | The daily put strike price of the transaction. |
| Premium | The daily premium price of the transaction. |
| Index | The provider whose index you wish to use to price the deal (e.g. IFERC, Gas |
| | Daily, etc.). |
| Location | The location for the provider selected above on whose index you wish the |
| | price the deal. |
| Settlement | The settlement type for the index provider selected above. |
| Comments | Any additional free-form comments you wish to append to the transaction |
| | message. This information persists as part of the message's audit trail but is |
| | not included in any confirmation emails. Use this field to communicate any |
| | additional details that will help your counterparties better understand your |
| | deal. |
| Special Terms | Any additional free-form special terms you wish to append to the transaction |
| | message. This information persists as part of the message's audit trail and is |
| | included as special terms in any confirmation emails. For example, special |
| | terms might include “seller pays transportation fees” or “75% load factor.” |

\textcircled{3} Grid Sub-Tab

| | |
|---|---|
| Time Period | The specific day or month of the transaction. For monthly transactions, you |
| | can click the plus symbol [symbol] to the left of the month to display all days in the |
| | month. The values displayed in this column cannot be edited on this screen. |
| Volume | The volume terms for the specific day or month of the transaction. Click |
| | anywhere in a daily row to amend the value. |
| Put Strike | The put strike pricing terms for the specific day of the transaction. Click |
| | anywhere in a daily row to amend the value. |
| Premium | The premium pricing terms for the specific day of the transaction. Click |
| | anywhere in a daily row to amend the value. |

To complete a Physical/Trigger message, use the field definitions below to complete the Deal Details tab of a new transaction message with the following “Deal Type” and “Deal Sub-Type” values.

### Deal Type: Physical/Deal Sub-Type: Trigger

\textcircled{1} Structure Sub-Tab

| | |
|---|---|
| Commodity | The type of commodity you wish to transact in. |
| Contract Type | Whether this is a daily or a monthly transaction. |
| Deal Type | Whether the transaction is financial or physical in nature. |
| Deal Sub-Type | The specific deal type of the transaction. This list is filtered based on |
| | your “Deal Type” selection. |
| Buy/Sell | Whether the transaction is a buy or a sell, from your (the originator's) |
| | point of view. |
| Fee Structure | How the fee for executing this transaction is to be paid. Select either |
| | 50/50 (buyer and seller split the fee payment), Buyer Pays, or Seller |
| | Pays. |

\textcircled{2} Parameters Sub-Tab
Delivery Location

| | |
|---|---|
| Region | The geographic region of the market point to which you want |
| | delivery. |
| Pipeline | The unique market point to which you want delivery. |
| Description | A user-defined free-form text description of the delivery location. |
| | Use this field to further define the exact delivery location, if |
| | necessary. |

Term

| | |
|---|---|
| Start Date | The start date of the deal or transaction. |
| End Date | The end date of the deal or transaction. |

Volume

| | |
|---|---|
| Negotiable | Whether or not the volume terms of the transaction are negotiable. If |
| | Yes is selected, the recipients of the transaction message will have the |
| | option to propose amended volume terms. |
| Quantity | The number of units of the commodity you wish to transact in per day. |
| Units | The type of unit of the commodity you wish to transact in. |

Price

| | |
|---|---|
| Negotiable | Whether or not the pricing terms of the transaction are negotiable. If |
| | Yes is selected, the recipients of the transaction message will have the |
| | option to propose amended pricing terms. |
| Currency | The currency that the pricing terms of the transaction are expressed in. |
| Differential | The price above or below the index price that will be paid for the |
| | commodity. This value can be positive, negative, or zero. |
| Index | The provider whose index you wish to use to price the deal (e.g. |
| | IFERC, Gas Daily, etc.). |
| Location | The location for the provider selected above on whose index you wish |
| | the price the deal. |
| Settlement | The settlement type for the index provider selected above. |
| Comments | Any additional free-form comments you wish to append to the |
| | transaction message. This information persists as part of the |
| | message's audit trail but is not included in any confirmation emails. |
| | Use this field to communicate any additional details that will help |
| | your counterparties better understand your deal. |
| Special Terms | Any additional free-form special terms you wish to append to the |
| | transaction message. This information persists as part of the |
| | message's audit trail and is included as special terms in any |
| | confirmation emails. For example, special terms might include “seller |
| | pays transportation fees” or “75% load factor.” |
| | Note: Enter your trigger terms here. |

\textcircled{3} Grid Sub-Tab

| | |
|---|---|
| Time Period | The specific day or month of the transaction. For monthly |
| | transactions, you can click the plus symbol [symbol] to the left of the month |
| | to display all days in the month. The values displayed in this column |
| | cannot be edited on this screen. |
| Volume | The volume terms for the specific day or month of the transaction. |
| | Click anywhere in a daily row to amend the value. |
| Differential Price | The differential pricing terms for the specific day of the transaction. |
| | Click anywhere in a daily row to amend the value. |

What is claimed is:

1. A computer readable medium for facilitating a private commodity resource transaction, comprising:
a first code segment for a communicating to a remote computer a plurality of user sign-in prompts for receiving sign-in responses;
a second code segment for receiving the sign-in responses from the remote computer;
a third code segment for determining whether a user is associated with the sign-in responses;
a fourth code segment for verifying whether the user associated with the sign-in responses should be granted access to a plurality of market establishment prompts for establishing a market for the private commodity resource transaction;
a fifth code segment for communicating the plurality of market establishment prompts to the remote computer;
a sixth code segment for establishing a market for the private commodity resource transaction;
a seventh code segment for receiving market establishment offer information comprising a selected subset of potential respondents selected from a predetermined set of potential respondents, for offering to the selected subset of potential respondents the private commodity resource transaction within the market established by an originator for the private commodity resource transaction, in response to communicating the plurality of market establishment prompts to the remote computer;
an eighth code segment for determining which potential respondents of the predetermined set of potential respondents to communicate the market establishment offer information to based on the selected subset of potential respondents;
a ninth code segment for privately communicating the market establishment offer information to the potential respondents within the selected subset of potential respondents;
a tenth code segment for receiving an acceptance response from at least one the potential respondents within the selected subset of potential respondents;
an eleventh code segment for determining a first complete acceptance from the acceptance response from the potential respondents within the selected subset of potential respondents;
a twelfth code segment for identifying which of the potential respondents of the subset of potential respondents is associated with the first complete acceptance for establishing an identified respondent;
a thirteenth code segment for privately communicating to the identified respondent an execution communication for informing the identified respondent that the identified respondent's acceptance response has been accepted; and,
a fourteenth code segment for closing the market for the private commodity resource transaction in response to receipt of the first complete acceptance response.

2. The computer readable medium of claim 1 further comprising:
a fifteenth code segment for privately communicating to the potential respondents of the subset of potential respondents which are not the identified respondent that the market is closed for the private commodity resource transaction.

3. The computer readable medium of claim 2 wherein the first complete acceptance includes information which indicates that the acceptance response accepts all terms provided within the market establishment offer information without modifying any terms in the market establishment offer information and/or without providing a counter-offer to the market establishment offer information, and wherein the first complete acceptance is the first acceptance response received which accepts all of the terms provided within the market establishment offer information without modifying any terms in the market establishment offer information and/or without providing a counter-offer to the market establishment offer information.

4. The computer readable medium of claim 1 further comprising:
a fifteenth code segment for a communicating to a remote computer a plurality of user account information request prompts for establishing a user account and for assigning system access-level and entitlements.

5. The computer readable medium of claim 4 further comprising:
a sixteenth code segment for communicating a user account verification request to a remote server for verifying at least one item of user account information;
a seventeenth code segment for receiving verification information about the at least one item of user account information;
an eighteenth code segment for verifying the at least one item of user account information against the verification information; and,
a nineteenth segment for communicating a user verification message to the remote computer for informing the market maker that the at least one item of user account information has been accepted.

6. The computer readable medium of claim 1 wherein the market establishment offer information further comprises at least one of commodity type, trade type (physical or financial), trade type sub-type (collar, put option, etc.), volume, price, delivery location, start date, end date, period price information, timer, comments, special terms, and/or linked trade.

7. The computer readable medium of claim 1 further comprising:
a fifteenth code segment for communicating modification prompts to the selected subset of potential respondents for allowing the selected subset of potential respondents to modify the market establishment offer information, wherein the logic for receiving the acceptance response from at least one the potential respondents within the selected subset of potential respondents includes logic for receiving a counter-offer from the at least one of the potential respondents;
a sixteenth code segment for determining that the counter-offer has been received from the at least one of the potential respondents;
a seventeenth code segment for identifying which of the potential respondents of the subset of potential respondents is associated with the counter-offer;
an eighteenth code segment for receiving a counter-offer acceptance from the originator for the counter-offer and for establishing an identified respondent;
a nineteenth code segment for privately communicating to the identified respondent associated with the counter-offer an execution confirmation communication for informing the identified respondent that the identified respondent's counter-offer has been accepted; and,
a twentieth code segment for closing the market for the private commodity resource transaction in response to receiving the first complete acceptance response.

8. The computer readable medium of claim 1 further comprising:
a fifteenth code segment for tracking and storing in memory each of the originator and respondent actions within the transaction process within a transaction history; and,
a sixteenth code segment for recalling from memory the transaction history.

9. The computer readable medium of claim 8 further comprising:
a seventeenth code segment for compiling summary information about the originator and respondent actions; and,
an eighteenth code segment for communicating the summary information about the originator and respondent.

10. The computer readable medium of claim 1 further comprising:
a fifteenth code segment for preventing an identity of each of the potential respondents of the predetermined set of potential respondents from being determined by other of the potential respondents of the predetermined set of potential respondents.

11. The computer readable medium of claim 1 further comprising:
a fifteenth code segment for preventing the originator from identifying the identity of the identified respondent prior to acceptance of the acceptance response.

12. The computer readable medium of claim 1 further comprising:
a fifteenth code segment for preventing the originator from withdrawing the market and from withdrawing the market establishment offer information after acceptance of the acceptance response.

13. The computer readable medium of claim 1, wherein the market establishment offer information comprises a plurality of sub-offers, further comprising:
a fifteenth code segment for receiving a counter-offer response for more than one of each of the plurality of sub-offers independent from each other of the plurality of sub-offers.

14. The computer readable medium of claim 1, wherein the market establishment offer information comprises a plurality of sub-offers, further comprising:
a fifteenth code segment for receiving acceptance responses for more than one of each of the plurality of sub-offers independent from each other of the plurality of sub-offers.

15. A method for facilitating a private commodity resource transaction, comprising the steps of:
communicating to a remote computer a plurality of user sign-in prompts for receiving sign-in responses;
receiving the sign-in responses from the remote computer;
determining whether a user is associated with the sign-in responses;
verifying whether the user associated with the sign-in responses should be granted access to a plurality of market establishment prompts for establishing a market for the private commodity resource transaction;
communicating the plurality of market establishment prompts to the remote computer;
establishing a market for the private commodity resource transaction;
receiving market establishment offer information comprising a selected subset of potential respondents selected from a predetermined set of potential respondents, for offering to the selected subset of potential respondents the private commodity resource transaction within the market established by the originator for the private commodity resource transaction, in response to communicating the plurality of market establishment prompts to the remote computer;
determining which potential respondents of the predetermined set of potential respondents to communicate the market establishment offer information to based on the selected subset of potential respondents;
privately communicating the market establishment offer information to the potential respondents within the selected subset of potential respondents;
receiving an acceptance response from at least one of the potential respondents within the selected subset of potential respondents;
determining a first complete acceptance from the acceptance response from the potential respondents within the selected subset of potential respondents;
identifying which of the potential respondents of the subset of potential respondents is associated with the first complete acceptance for establishing an identified respondent;
privately communicating to the identified respondent an execution communication for informing the identified respondent that the identified respondent's acceptance response has been accepted; and,
closing the market for the private commodity resource transaction in response to receiving the first complete acceptance response.

16. The method of claim 15 further comprising the step of:
communicating to the potential respondents of the subset of potential respondents which are not the identified respondent that the market is closed for the private commodity resource transaction.

17. The method of 16 wherein first complete acceptance includes information which indicates that the acceptance response accepts all terms provided within the market establishment offer information without modifying any terms in the market establishment offer information and/or without providing a counter-offer to the market establishment offer information, and wherein the first complete acceptance is the first acceptance response received which accepts all of the terms provided within the market establishment offer information without modifying any terms in the market establishment offer information and/or without providing a counter-offer to the market establishment offer information.

18. The method of claim 15 further comprising the steps of:
communicating to a remote computer a plurality of user account information request prompts for establishing a user account;
receiving originator account information for establishing the user account; and, establishing the user account.

19. The method of claim 18 further comprising the steps of:
communicating a user account verification request to a remote server for verifying at least one item of user account information;
receiving verification information about at least one item of user account information;
verifying the at least one item of user account information against the verification information; and,
communicating a user verification message to the remote computer for informing the market maker that the at least one item of user account information has been accepted.

20. The method of claim 15, wherein the market establishment offer information comprises a plurality of sub-offers, further comprising the step of
receiving a counter-offer response for more than one of each of the plurality of sub-offers independent from each other of the plurality of sub-offers.

21. The method of claim 15, wherein the market establishment offer information comprises a plurality of sub-offers, further comprising the step of:
receiving acceptance responses for more than one of each of the plurality of sub-offers independent from each other of the plurality of sub-offers.

22. A computer readable medium for facilitating a private commodity resource transaction, comprising:
a first code segment for establishing a market for the private commodity resource transaction;
a second code segment for communicating a plurality of market establishment prompts to a remote computer;
a third code segment for establishing a market for the private commodity resource transaction;
a fourth code segment for receiving market establishment offer information comprising a selected subset of potential respondents;
a fifth code segment for offering to the selected subset of potential respondents the private commodity resource transaction;
a sixth code segment for determining which potential respondents to communicate the market establishment offer information to;
a seventh code segment for privately communicating the market establishment offer information to the potential respondents;
an eighth code segment for receiving an acceptance response from at least one the potential respondents;
a ninth first code segment for identifying which of the potential respondents is associated with a first complete acceptance;
a tenth code segment for privately communicating to the identified respondent a execution communication; and,
an eleventh code segment for closing the market.
